(19) United States
(12) Patent Application Publication
(10) Pub. No.: US 2026/0269287 A1
(43) Pub. Date: Sep. 10, 2026

(54) ALL-NONAQUEOUS MEMBRANE-FREE FLOW BATTERIES

(71) Applicant: University of Cincinnati, Cincinnati, OH (US)

(72) Inventors: Jianbing Jiang, Mason, OH (US); Rajeev K. Gautam, Cincinnati, OH (US)

(21) Appl. No.: 19/469,085

(22) PCT Filed: Mar. 28, 2024
(86) PCT No.: PCT/US2024/021896

§ 371 Date: Sep. 25, 2025

Related U.S. Application Data
(60) Provisional application No. 63/492,515, filed on Mar. 28, 2023.
(60) Provisional application No. 63/496,987, filed on Apr. 19, 2023.

(51) Int. Cl. H01M 8/04186; H01M 4/86; H01M 8/18

(52) U.S. Cl. CPC H01M 8/04186; H01M 4/86; H01M 8/188

(57) ABSTRACT

A biphasic membrane-free battery and a triphasic membrane-free battery are provided. The biphasic membrane-free battery includes a housing structure housing: a catholyte phase having a cathode, and an anolyte phase having an anode, the catholyte phase contacting the anolyte phase along an interface. The triphasic membrane-free battery includes a housing structure housing: a catholyte phase having a cathode, and an anolyte phase having an anode, and an electrolyte phase between the catholyte phase and the anolyte phase.

### CROSS-REFERENCE TO RELATED APPLICATIONS

This application is an international patent application that claims priority to, and benefit of the filing date of, U.S. Provisional Patent Application No. 63/496,987 filed Apr. 19, 2023, which is hereby incorporated by reference in its entirety. This application also claims priority to, and the benefit of the filing date of, U.S. Provisional Patent Application No. 63/492,515 filed Mar. 28, 2023, which is hereby incorporated by reference in its entirety.

### GOVERNMENT LICENSE RIGHTS

This invention was made with government support under Contract No. CBET-2112798 awarded by the National Science Foundation. The government has certain rights in the invention.

### FIELD OF THE INVENTION

The present invention generally relates to batteries. More specifically, the present invention relates to nonaqueous, membrane-free flow batteries.

### BACKGROUND

Lithium-metal-based nonaqueous redox flow batteries (LRFBs) are attracting significant attention as alternatives to conventional aqueous redox flow batteries (RFBs) because of their high operating voltage and large theoretical energy density. However, the large-scale applicability of LRFBs is limited by the poor availability and high cost of the critically important ion-selective membranes. Therefore, membrane-free batteries stand out as promising alternatives. Herein, we report an ultra-high-voltage membrane-free LRFBs based on uniquely designed all-organic biphasic system that uses an ionic liquid as the anolyte and fluoroethylene carbonate as the catholyte. The Li metal anode was paired with Tri-TEMPO, C3-PTZ, and CP cathodes, which enable biphasic batteries with theoretical cell voltages of 3.53, 3.49, and 4.09 V, respectively. Under static conditions, the Li|Tri-TEMPO, Li|C3-PTZ, and Li|CP batteries containing 0.5 M redox-active material delivers capacity retention rates of 98%, 98%, and 92%, respectively, for 100 cycles over ~55 days. In addition, the representative Li|Tri-TEMPO (0.5 M) flow battery can retain 81% of capacity for 100 cycles over −45 days along with average Coulombic efficiency of 96% and energy efficiency of 82%. Thus, the present disclosure reports significant advances in biphasic systems for membrane-free batteries, achieving both high voltage and high energy density (~33 Wh/L) under flow conditions.

Large-scale electrical energy storage (EES) systems are vital for the efficient utilization of widely available intermittent renewable energy sources such as solar and wind energy to mitigate the mismatch between the generation and consumption of electrical energy. Batteries are the first choice for building advanced EES systems owing to their high efficiency and flexible installation. Among the various battery technologies being explored, redox-flow batteries (RFBs) have attracted particular attention as promising EES systems because of their unique feature of the decoupling of the energy density and power. Based on the electrolyte used, RFBs can generally be classified into two types: aqueous and nonaqueous RFBs. Aqueous RFBs use water as the solvent for the anolyte and catholyte, as this offers several advantages, including fast reaction kinetics, low cost, nonflammability, and high conductivity. Remarkable progress has been made with regards to aqueous RFBs, and they have been commercialized. However, aqueous RFBs suffer from two major problems: limited cell voltage owing to the narrow electrochemical window of water (1.23 V) and low energy density (20-50 Wh/L). In contrast, nonaqueous RFBs (NRFBs) exhibit a wider electrochemical window (up to 6 V) and potentially higher energy density. Moreover, the fact that one can employ widely available solvents and supporting electrolytes allows for the use of a range of redox-active compounds. However, the development of NRFBs has been hindered by the limited availability of critically important ion-selective membranes, the low ionic conductivity of nonaqueous electrolytes, and the high costs of these materials. Specifically, the limited availability of appropriate ion-selective membranes and their high cost (approaching 40% of the total battery cost) are the key challenges. To address these limitations, inexpensive size-exclusive separators have been used in NRFBs as alternatives to ion-selective membranes. These porous-separator-based batteries can exhibit high current densities; however, this strategy has several downsides, including low rates of active material utilization, low Coulombic efficiency, and self-discharging.

Thus, several membrane-free batteries have been proposed and developed. Initially, classical fluid dynamics engineering based on the laminar flow of electrolytes through parallel microchannels was exploited to develop membrane-free batteries. However, these microfluidic batteries can only be realized at the microscale and are difficult to scale up and thus not suitable for large-scale energy storage. Recently, immiscible-electrolyte-based liquid-liquid biphasic systems have received significant attention for the construction of membrane-free batteries. The liquid-liquid interface of these biphasic systems separates the catholyte and anolyte and functions as a natural barrier, thus eliminating the need for a membrane. Unlike the case for laminar-flow batteries, the biphasic membrane-free approach allows for the design of flow batteries with higher power and capacity. Recently, several aqueous biphasic systems (ABSs) (aqueous/nonaqueous phases) were reported by us as well as other research groups. However, most of the reported membrane-free ABSs were investigated under static conditions and showed limited scalability. Membrane-free batteries have rarely been investigated under actual flow conditions because of the convective-mass-transport-induced disturbances at the liquid-liquid interface under flow conditions, which results in self-discharging and active material crossover. Moreover, ABS batteries typically show low energy density owing to their limited cell voltage. Therefore, membrane-free batteries based on nonaqueous electrolytes have been developed to increase the energy density. However, the development of flow batteries based on a nonaqueous biphasic system (NBS) has been significantly hindered by the lack of immiscible organic solvents and redox-active materials that exhibit suitable solubilities in each phase to prevent active material crossover in the self-stratified biphasic system. Liu et al. demonstrated a static membrane-free battery-based all-organic NBS using Li metal in nonafluoro-1,1,2,2-tetrahydrohexyl-trimethoxysilane (NFTOS) as the anolyte and 2-ethylanthraquinone (2-EAQ) and benzo[1,2-b:4,5-bKLdithiophene-4,8-dione (BDTD) tetraethylene glycol dimethyl ether paired together as the catholyte. Both catholyte materials (i.e., 2-EAQ and BDTD) exhibit low solubilities in the anolyte, that is, NFTOS, thus allowing for the study of the charge/discharge cycling characteristics. However, this battery suffers from (1) low charge/discharge current density (50 μA/cm), (2) relatively low nominal cell voltage (−2.2 V) for both cathodic materials, and (3) a lack of information regarding its capacity retention rate and cycling characteristics under flow conditions. Hence, there is an urgent need to develop membrane-free batteries that use flowable nonaqueous electrolytes with high voltage and energy density.

It is disclosed herein an all-nonaqueous biphasic membrane-free battery that shows high voltage and energy density under both static and flow conditions. The NBS-based battery employs Li metal in an ionic liquid (IL) as the anolyte (top phase) and a metal-free organic compound (TEMPO derivative Tri-TEMPO (FIG. 1), phenothiazine derivative C3-PTZ, or cyclopropenium derivative CP) in fluoroethylene carbonate (FEC) as the catholyte (bottom phase). The Li|Tri-TEMPO, Li|C3-PTZ, and Li|CP biphasic batteries exhibited theoretical cell voltages of 3.53, 3.49, and 4.09 V, respectively. The developed biphasic system was investigated under both static and flow conditions using the catholyte in different concentrations (0.1, 0.2, and 0.5 M). The static Li|Tri-TEMPO, Li|C3-PTZ, and Li|CP batteries with 0.5 M catholyte displayed capacity retention rates of 98%, 98%, and 92% respectively, after 100 cycles over ~55 days. Moreover, under flow conditions, the prolonged cycling of the 0.5 M Li|Tri-TEMPO battery resulted in a capacity retention rate of 81% after 100 cycles over −45 days, with the Coulombic efficiency (CE), voltage efficiency (VE), and energy efficiency (EE) being 96%, 85%, and 82%,

### SUMMARY

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

Aspects of the present invention overcome and/or reduce the drawbacks described above by providing a method and system for all non-aqueous membrane-free flow batteries.

One aspect of the invention is directed to a biphasic membrane-free battery including a housing structure housing a catholyte phase and an anolyte phase, the catholyte phase contacting the anolyte phase along an interface. A cathode is present in the catholyte phase and an anode present in the anolyte phase.

In a related embodiment, the anolyte phase comprises a solvent selected from the group consisting of ethyl-3-methylimidazolium bis(trifluoromethylsulfonyl)imide (EMI-TFSI), N-propyl-N-methylpyrrolidinium bis(trifluoromethanesulfonyl)imide (PMP-TFSI), 1-ethyl-3-methyl imidazolium tetrafluoroborate (EMI-BF4), 1-butyl-1-methylpyrrolidinium bis(trifluoromethylsulfonyl)imide (BMP-TFSI), nonafluoro-1,1,2,2-tetrahydrohexyl-trimethoxysilane (NFTTS), and combinations thereof.

In a related embodiment, the catholyte phase comprises a solvent selected from the group consisting of tetrahydrofuran (THF), tetraethylene glycol dimethyl ether (TEGDME), fluoroethylene carbonate (FEC), diethylene carbonate (DEC), propylene carbonate (PC), benzotrifluoride (BTF), and combinations thereof.

In a related embodiment, the anode comprises lithium metal.

In a related embodiment, the cathode comprises a material selected from the group consisting of 2,4,6-tri-(1-cyclohex-yloxy-4-imino-2,2,6,6-tetramethylpiperidine)-1,3,5-triazine (Tri-TEMPO), N-propyl phenothiazine (C3-PTZ), tris(dialkylamino)cyclo-propenium (CP), and combinations thereof.

In a related embodiment, the catholyte phase is configured to be static during operation of the biphasic membrane-free battery.

In a related embodiment, the anolyte phase is configured to be static during operation of the biphasic membrane-free battery.

In a related embodiment, the catholyte phase is configured to flow into the biphasic membrane-free battery and out of the biphasic membrane-free battery during operation of the biphasic membrane-free battery.

In a related embodiment, the anolyte phase is configured to flow into the biphasic membrane-free battery and out of the biphasic membrane-free battery during operation of the biphasic membrane-free battery.

In a related embodiment, the cathode comprises graphite felt (GF).

Furthermore, a triphasic membrane-free battery is provided. The triphasic membrane-free battery includes a housing structure housing a catholyte phase, an electrolyte phase, and an anolyte phase. The catholyte phase contacts the electrolyte phase along a first interface and the electrolyte phase contacts the anolyte phase along a second interface. A cathode is present in the catholyte phase, and an anode is present in the anolyte phase.

In a related embodiment, the anolyte phase comprises a solvent selected from the group consisting of ethyl-3-methylimidazolium bis(trifluoromethylsulfonyl)imide (EMI-TFSI), N-propyl-N-methylpyrrolidinium bis(trifluoromethanesulfonyl)imide (PMP-TFSI), 1-ethyl-3-methyl imidazolium tetrafluoroborate (EMI-BF4), 1-butyl-1-methylpyrrolidinium bis(trifluoromethylsulfonyl)imide (BMP-TFSI), nonafluoro-1,1,2,2-tetrahydrohexyl-trimethoxysilane (NFTTS), tetraethylene glycol dimethyl ether (TEGDME), fluoroethylene carbonate (FEC), and combinations thereof.

In a related embodiment, the catholyte phase is a solvent selected from the group consisting of tetrahydrofuran (THF), tetraethylene glycol dimethyl ether (TEGDME), fluoroethylene carbonate (FEC), diethylene carbonate (DEC), propylene carbonate (PC), benzotrifluoride (BTF), nonafluoro-1,1,2,2-tetrahydrohexyl-trimethoxysilane (NFTTS), and combinations thereof.

In a related embodiment, the anode comprises lithium metal.

In a related embodiment, the cathode comprises a material selected from the group consisting of 2,4,6-tri-(1-cyclohex-yloxy-4-imino-2,2,6,6-tetramethylpiperidine)-1,3,5-triazine (Tri-TEMPO), N-propyl phenothiazine (C3-PTZ), tris(dialkylamino)cyclo-propenium (CP), graphite felt (GP), phenothiazine derivative (C18-PTZ), and combinations thereof.

In a related embodiment, the catholyte phase is configured to be static during operation of the triphasic membrane-free battery.

In a related embodiment, the anolyte phase is configured to be static during operation of the triphasic membrane-free battery.

In a related embodiment, the catholyte phase is configured to flow into the triphasic membrane-free battery and out of the triphasic membrane-free battery during operation of the triphasic membrane-free battery.

In a related embodiment, the anolyte phase is configured to flow into the triphasic membrane-free battery and out of the triphasic membrane-free battery during operation of the triphasic membrane-free battery.

In a related embodiment, the electrolyte phase comprises a material selected from the group consisting of tetraethylene glycol dimethyl ether (TEGDME), nonafluoro-1,1,2,2-tetrahydrohexyl-trimethoxysilane (NFTTS), fluoroethylene carbonate (FEC), and combinations thereof.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is the chemical structures of Tri-TEMPO, C3-PTZ, and CP.

FIG. 2 are (A) cyclic voltammograms of Li metal in ionic liquids with 0.1 M LiTFSI and 5 mM Tri-TEMPO, C3-PTZ, or CP in 0.1 M LiClO₄/FEC solution at a scan rate of 50 mV/s. Cycling stabilities of (B) Tri TEMPO, (C) C3-PTZ, and (D) CP in 0.1 M LiClO₄/FEC solution at a scan rate of 200 mV/s.

FIG. 3 are charge/discharge performances of Li|Tri-TEMPO nonaqueous biphasic static batteries (NBSBs). FIG. 3 includes (A) discharge capacities of 0.1, 0.2, and 0.5 M Li|Tri-TEMPO NBSBs, (B) coulombic efficiency voltage efficiency, and energy efficiency of 0.5 M NBSB, (C) 20th, 50th, and 100th charge/discharge profiles of 0.5 M NBSB, and (D) CV curves of 0.5 M NBSB before and after 100 charge/discharge cycles (catholyte).

FIG. 4 are charge/discharge performances of C3-PTZ- and CP-based biphasic static batteries. Charge/discharge profiles of biphasic batteries with (A) 0.5 M C3-PTZ and (B) 0.5 M CP after 20th, 50th, and 100th cycles. Coulombic efficiency, voltage efficiency, and energy efficiency values of (C) 0.5 M C3-PTZ and (D) 0.5 M CP batteries. Discharge capacities of batteries with (E) 0.5 M C3-PTZ and (F) 0.5 M CP. Cyclic voltammograms of (G) 0.5 M C3-PTZ and (H) 0.5 M CP 0.5 M batteries before and after 100 charge/discharge cycles (catholyte).

FIG. 5 are charge/discharge profiles of (A) 0.5M Tri-TEMPO, (B) 0.5M C3-PTZ, and (C) 0.5 M CP batteries at different operating current densities. Coulombic efficiency, voltage efficiency, and energy efficiency values of (D) 0.5M Tri-TEMPO, (E) 0.5M C3-PTZ, and (F) 0.5M CP batteries at different operating currents densities.

FIG. 6 shows performance of 0.5 M Li|Tri-TEMPO battery under flow conditions. (A) Capacity retention rate, Coulombic efficiency, voltage efficiency, and energy efficiency. (B) Charge/discharge profile after 20th, 50th, and 100th cycles. (C) Cyclic voltammograms of 3 catholyte before and after cycling. (D) UV-visible spectra of catholyte before and after cycling. (E) Potential of fully charged battery over time. (F) Charge/discharge profiles at different current densities. (G) Charge-rate performance.

FIG. 7 is a TOC graphic. The use of immiscible nonaqueous electrolytes as a generic strategy allows for the realization of high-voltage, high-energy-density membrane-free nonaqueous flow batteries.

FIG. 8 is a table showing the development of nonaqueous biphasic systems.

FIG. 9 is a table showing screening of cathode materials for FEC/BMP-TFSI biphasic system and the chemical structures of redox-active materials.

FIG. 10 are photographs of (A) nonaqueous biphasic systems and nonaqueous biphasic system with (B) Tri-TEMPO, (C) C3-PTZ, and (D) CP redox active materials dissolved in the catholyte.

FIG. 11 are the UV-visible spectra of the catholyte and anolyte of the biphasic system with (A) 0.5 M Tri-TEMPO, (B) 0.5 M C3-PTZ, and (C) 0.5 M CP on day 1 and day 15.

FIG. 12 are cyclic voltammograms of the catholyte and anolyte of the biphasic system with (A) 0.5 M Tri-TEMPO, (B) 0.5 M C3-PTZ, and (C) 0.5 M CP on day 1 and day 15.

FIG. 13 are cyclic voltammograms of (A) 5 mM Tri-TEMPO, (B) 5 mM C3-PTZ, and (C) 5 mM CP in 0.1 M LiClO₄/FEC solution at a scan rate of 5 mV/s.

FIG. 14 are cyclic voltammograms of (A) 5 mM Tri-TEMPO, (B) 5 mM C3-PTZ, and (C) 5 mM CP in 0.1 M LiClO₄/FEC solution at scan rates ranging from 50-200 mV/s.

FIG. 15 are the i_{pc}/iₚₐ curve of (A) 5 mM Tri-TEMPO, (B) 5 mM C3-PTZ, and (C) 5 mM CP in 0.1 M LiClO₄/FEC solution at scan rates ranging from 50-200 mV/s.

FIG. 16 are current vs square root curve of scan rates curves of (A) 5 mM Tri-TEMPO, (B) 5 mM C3-PTZ, and (C) 5 mM CP in 0.1 M LiClO₄/FEC solution at scan rates ranging from 50-200 mV/s.

FIG. 17 are cyclic voltammograms of (A) 0.1 M Li|Tri-TEMPO and (B) 0.2 M Li|Tri-TEMPO battery catholytes before and after 100 charge/discharge cycles.

FIG. 18 are coulombic efficiency, voltage efficiency, and energy efficiency of (A) 0.1 M Li|Tri-TEMPO and (B) 0.2 M Li|Tri-TEMPO nonaqueous biphasic static battery.

FIG. 19 are (A) the UV-visible spectra and (B) cyclic voltammograms (anolyte) of the 0.5M Li|Tri-TEMPO static battery electrolytes before and after 100 charge/discharge cycles. The current range on Y axis in (B) is kept the same as that in FIG. 3D to facilitate comparison.

FIG. 20A are (A) cyclic voltammograms (anolyte), (B) UV-visible spectra, and (C) Stacked ¹H NMR spectra collected for a pure BMP-TFSI (bottom), pure C3-PTZ with BMP-TFSI (2^{nd} spectrum from the bottom), BMP-TFSI anolyte collected before (2^{nd} spectrum from the top) and after (top) 100 charge/discharge cycles. All NMR samples contain 1 M LiTF SI electrolytes. The current range on Y-axis in (B) is kept the same as that in FIG. 4G to facilitate comparison.

FIG. 20B are (A) cyclic voltammograms (anolyte), (B) UV-visible spectra, and (C) Stacked ¹H NMR spectra collected for a pure BMP-TF SI (bottom), pure CP with BMP-TF SI (2nd spectrum from the bottom), BMP-TF SI anolyte collected before (2nd spectrum from the top) and after (top) 100 charge/discharge cycles. All NMR samples contain 1 M LiTFSI electrolytes. The current range on Y-axis in (B) is kept the same as that in FIG. 4H to facilitate comparison.

FIG. 21 is a schematic of a biphasic membrane-free battery with flowing catholyte.

FIG. 22 is a table of performance comparisons of liquid/liquid biphasic membrane-free batteries.

FIG. 23 is a table of unit price cost calculations for Tri-TEMPO, C3-PTZ, and CP.

FIG. 24 is a table of per unit capital cost of biphasic batteries.

FIG. 25 are the chemical structures of redox active materials, specifically showing the electrochemical reaction of Tri-TEMPO, C3-PTZ, and CP.

FIG. 26 are (a) cyclic voltammograms of Li metal in BMP-TFSI/0.1 M LiTFSI and 5 mM Tri-TEMPO, C3-PTZ, or CP in 0.1 M FEC/LiClO₄ solutions. (b), (c), (d) cyclic voltammetry stability of Tri-TEMPO, C3-PTZ, and CP in 0.1 M FEC/LiClO₄ solutions. All at scan rate of 50 mV/s.

FIG. 27 are schematics and plots showing performances of Li|Tri-TEMPO based nonaqueous biphasic static batteries (NBSBs). (a) schematic of NBSB used in this study. (b) Discharge capacities of 0.1, 0.2, and 0.5 M Li|Tri-TEMPO NBSBs. (c) 20th, 50th, and 100th charge/discharge profiles of 0.5 M NBSB. (d) Coulombic efficiency, voltage efficiency, and energy efficiency of 0.5 M NBSB. (e) Cyclic voltammograms of 0.5 M NBSB before and after 100 charge/discharge cycles (catholyte).

FIG. 28 are charge/discharge performance plots of 0.5 M Li|C3-PTZ and 0.5 M Li|CP based nonaqueous biphasic static batteries (NBSBs). (a)(b) Charge/discharge profiles of 0.5 M C3-PTZ and 0.5 M CP NBSBs after 20th, 50th, and 100th cycles. (c)(d) coulombic efficiency, voltage efficiency, and energy efficiency values of 0.5 M C3-PTZ and 0.5 M CP NBSBs. (e)(f) Discharge capacities of 0.5 M C3-PTZ and 0.5 M CP NBSBs. (g)(h) Cyclic voltammograms of 0.5 M C3-PTZ and 0.5 M CP NBSBs before and after 100 charge/discharge cycles (catholyte).

FIG. 29 are plots showing performance of Tri-TEMPO, C3-PTZ, and CP based nonaqueous biphasic static batteries (NBSBs) at different current densities. (a)(b)(c) charge/discharge profiles of 0.5 M Li|Tri-TEMPO, 0.5 M Li|C3-PTZ, and 0.5 M Li|CP NBSBs at different operating current densities. (d)(e)(f) variation in coulombic efficiency, voltage efficiency, and energy efficiency of 0.5 M Li|Tri-TEMPO, 0.5 M Li|C3-PTZ, and 0.5 M Li|CP NBSBs at different operating currents densities.

FIG. 30 are plots showing performances of 0.5 M Li|Tri-TEMPO based membrane-free nonaqueous biphasic flow batteries (NBFBs). (a) Schematic of membrane-free NBFB used in this study. (b) Capacity retention rate, Coulombic efficiency, voltage efficiency, and energy efficiency of NBFB. (c) Charge/discharge profile after 20th, 50th, and 100th cycles of NBFB. (d) Cyclic voltammograms of catholyte of NBFB before and after 100 charge/discharge cycles. (e) UV-visible spectra of catholyte of NBFB before and after 100 charge/discharge cycles. (f) Voltage change in of fully charged NBFB over time. (g) Charge/discharge profiles at different current densities. (h) Charge-rate performance of NBFB.

FIG. 31 is a radar chart comparing the performance of our demonstrated batteries with the performance of other biphasic battery systems: MV/TEMPO, Zn/TEMPO, DMF_{c}, All-iron, pBQ/TEMPO, pBQ/OH-TEMPO, Zn/PTZ, Zn/PTZ, Li/2-EAQ.

FIG. 32 is a table tabulating the development of nonaqueous biphasic systems.

FIG. 33 is a table tabulating screening of cathode materials for FEC/BMP-TFSI biphasic systems.

FIG. 34 are photographs of the (a) nonaqueous biphasic systems and nonaqueous biphasic system with (b) Tri-TEMPO, (c) C3-PTZ, and (d) CP redox active materials dissolved in the catholyte.

FIG. 35 are photographs of ignition tests of glass fibers with electrolytes: Top phase (BMP-TFSI/LiTF SI) (a) before and (b) after test. Bottom phase (FEC/LiCl04) (c) before and (d) after test.

FIG. 36 are Nyquist plots, Nyquist fitting curves and schematic diagram of the test setup of the (a) FEC/LiClO₄, (b) BMP-TFSI/LiTFSI, and (c) bi-phase system.

FIG. 37 are the UV-visible spectra of the catholyte and anolyte of the biphasic system with (a) 0.5 M Tri-TEMPO, (b) 0.5 M C3-PTZ, and (c) 0.5 M CP on day 1 and day 15.

FIG. 38 are cyclic voltammograms of the catholyte and anolyte of the biphasic system with (a) 0.5 M Tri-TEMPO, (b) 0.5 M C3-PTZ, and (c) 0.5 M CP on day 1 and day 15.

FIG. 39 are cyclic voltammograms of 5 mM (a) Tri-TEMPO, (b) C3-PTZ, and (c) CP in 0.1 M FEC/LiClO₄ solution at a scan rate of 5 mV/s.

FIG. 40 are cyclic voltammograms of 5 mM (a) Tri-TEMPO, (b) C3-PTZ, and (c) CP in 0.1 M FEC/LiClO₄ solution at scan rates ranging from 50-200 mV/s.

FIG. 41 are i_{pc}/iₚₐ curve of 5 mM (a) Tri-TEMPO, (a) C3-PTZ, and (C) CP in 0.1 M FEC/LiClO₄ solution at scan rates ranging from 50-200 mV/s.

FIG. 42 are current vs. square root curves of scan rates curves of 5 mM (a) Tri-TEMPO, (b) C3-PTZ, and (c) CP in 0.1 M FEC/LiClO₄ solution at scan rates ranging from 50-200 mV/s.

FIG. 43 are RDE studies of Tri-TEMPO using electrolyte solutions containing 0.5 mM redox material in 0.1 M FEC/LiClO₄.

FIG. 44 are RDE studies of C3-PTZ using electrolyte solutions containing 0.5 mM redox material in 0.1 M FEC/LiClO₄.

FIG. 45 are RDE studies of CP using electrolyte solutions containing 0.5 mM redox material in 0.1 M FEC/LiClO₄.

FIG. 46 are 1H NMR spectra of C3-PTZ at (a) 25° C. and (b) 60° C.

FIG. 47 are ¹H NMR spectra of CP at (a) 25° C. and (b) 60° C.

FIG. 48 are cyclic voltammograms of (a) 0.1 M and (b) 0.2 M Li|Tri-TEMPO battery catholytes before and after 100 charge/discharge cycles.

FIG. 49 are coulombic efficiency, voltage efficiency, and energy efficiency of (a) 0.1 M and (b) 0.2 M Li|Tri-TEMPO static battery.

FIG. 50 are (a) The UV-visible spectra and (b) cyclic voltammograms (anolyte) of the 0.5 M Li|Tri-TEMPO static battery electrolytes before and after 100 charge/discharge cycles. The current range on Y-axis in (b) is kept the same as that in FIG. 27(d) to facilitate comparison.

FIG. 51 are (a) Cyclic voltammograms (anolyte), (b) UV-visible spectra, and (c) Stacked 1H NMR spectra collected for a pure BMP-TFSI (bottom), pure C3-PTZ with BMP-TFSI (2nd spectrum from the bottom), BMP-TFSI anolyte collected before (2nd spectrum from the top) and after (top) 100 charge/discharge cycles. All NMR samples contain 1 M LiTFSI electrolytes. The current range on Y-axis in (b a) is kept the same as that in FIG. 28(g) to facilitate comparison.

FIG. 52 are (a) Cyclic voltammograms (anolyte), (b) UV-visible spectra, and (c) Stacked ¹H NMR spectra collected for a pure BMP-TFSI (bottom), pure CP with BMP-TFSI (2^{nd} spectrum from the bottom), BMP-TFSI anolyte collected before (2^{nd} spectrum from the top) and after (top) 100 charge/discharge cycles. All NMR samples contain 1 M LiTFSI electrolytes. The current range on Y-axis in (b a) is kept the same as that in FIG. 28(h) to facilitate comparison.

FIG. 53 are polarization curves at different states-of-charge (SOC) of (a) 0.5 M Li|Tri-TEMPO, (b) 0.5 M Li|C3-PTZ, (c) 0.5 M Li|CP batteries under static conditions, and (d) 0.5 M Li|Tri-TEMPO battery under flow conditions.

FIG. 54 are area specific resistance (ASR) plots at different operating current densities of (a) 0.5 M Li|Tri-TEMPO, (b) 0.5 M Li|C3-PTZ, (c) 0.5 M Li|CP battery under static conditions, and (d) 0.5 M Li|Tri-TEMPO battery under flow conditions.

FIG. 55 is a photograph of the setup of membrane-free nonaqueous biphasic flow battery.

FIG. 56 are (a and b) CV calibration curves and (c and d) UV-visible calibration curve to measure the crossover of redox materials across the interface in the 0.5 M Li|Tri-TEMPO flow battery.

FIG. 57 is a table tabulating performance comparison of liquid/liquid biphasic membrane-free batteries.

FIG. 58 is a table tabulating unit price cost of materials components used in this study.

FIG. 59 shows the schematic representation of all organic nonaqueous tri-phasic system in which the top layer act as the anolyte, the middle layer act as the interface, and the bottom layer act as the catholyte.

FIG. 60 shows the fabrication of static membrane-free battery lithium static battery based on the tri-phasic system described in FIG. 60. Lithium metal was used as the anode, C18-PTZ was used as the cathode, and graphite felt was used as the cathode electrode.

FIG. 61 shows the membrane-free tri-phasic lithium battery under flowing catholyte.

FIG. 62 shows the cyclic voltammograms of 5 mM C18-PTZ in 0.1 M LiClO₄/FEC solution at a scan rate of 50 mV/s.

FIG. 63 shows the charge-discharge performance of 0.1 M Li|C18-PTZ battery under static conditions for 100 charge/discharge cycles. The tri-phasic static battery displayed a capacity retention of ~100%, Coulombic efficiency of ~100, voltage efficiency of ~92, and energy efficiency of ~92, respectively.

FIG. 64 shows the charge/discharge profile of 0.1 M Li|C18-PTZ static tri-phasic battery.

FIG. 65 shows the cyclic voltammetry of 0.1 M Li|C18-PTZ static tri-phasic battery before and after 100 charge/discharge cycles. No obvious change in anodic and cathodic current densities of the cyclic voltammetry curves before and after 100 battery cycles confirms no crossover of active materials.

FIG. 66 shows high-voltage membrane-free redox flow battery based on nonaqueous liquid/liquid triphasic system with nearly 100% Coulombic efficiency.

FIG. 67 shows (A) Schematic of triphasic system (design-I and design-II). (B) Chemical reaction of C18-PTZ. (C) Cyclic voltammograms 5 mM C18-PTZ in 0.1 M FEC/LiTFSI on a glassy carbon electrode at scan rates 50 mV/s. (D) the ratio of the oxidation and reduction peak currents to scan rate. (E) Cycling voltammetry stability of C18-PTZ in 0.1 M FEC/LiTFSI solution at a scan rate of 50 mV/s.

FIG. 68 shows RDE studies of C18-PTZ using electrolyte solutions containing 1.0 mM C18-PTZ in 1.0 M FEC/LiTFSI. (A) LSV curves at a scan rate of 5 mV s⁻¹ with rotation rates from 100 to 1600 rpm. (B) fitted linear Levich plots of the limiting current (iL) versus the square root of rotation rates (ω^{1/2}). (C) linearly fitted Koutecky-Levich plots of i⁻¹ with respect to ω^{-1/2}. (D) linearly fitted plots of log iₖ as a function of the overpotential (η).

FIG. 69 shows charge/discharge performances of 0.5 M Li|C18-PTZ triphasic battery cells based on design-I and design-II under static. Capacity retention, Coulombic efficiency (CE), voltage efficiency (VE), and energy efficiency (EE) values of 0.5 M Li|C18-PTZ static cells based on design-I (A) and design-II (B). Cyclic voltammograms of pre- and post-cycled catholytes of 0.5 M Li|C18-PTZ static cells based on design-I (C) and design-II (D). Charge/discharge profiles at different operating current densities of 0.5 M Li|C18-PTZ static cells based on design-I (E) and design-II (F). CE, VE, and EE values at different operating currents densities of 0.5 M Li|C18-PTZ static cells based on design-I (G) and design-II (H).

FIG. 70 shows charge/discharge performances of 0.5 M Li|C18-PTZ triphasic battery cells based on design-I and design-II under flow condition. Capacity retention, Coulombic efficiency (CE), voltage efficiency (VE), and energy efficiency (EE) values of 0.5 M Li|C18-PTZ flow cells based on design-I (A) and design-II (B). Cyclic voltammograms of pre- and post-cycled catholytes of 0.5 M Li|C18-PTZ flow cells based on design-I (C) and design-II (D). Charge/discharge profiles at different operating current densities of 0.5 M Li|C18-PTZ flow cells based on design-I (E) and design-II (F). CE, VE, and EE values at different operating currents densities of 0.5 M Li|C18-PTZ flow cells based on design-I (G) and design-II (H).

FIG. 71 shows a current vs square root of scan rate plot.

FIG. 72 shows triphasic membrane-free static cells based on design-I (A) and design-II (B). NFTT act as ion-exchange electrolyte layer.

FIG. 73 shows a triphasic membrane-free flow cells based on design-I (A) and design-II (B). NFTT act as ion-exchange electrolyte layer.

FIG. 74 shows a plot of change in open circuit voltage (OCV) over time of fully charged triphasic static cell based on design-I and design-II.

FIG. 75 shows a plot of optimization of flow rate for triphasic systems under flowing catholyte.

FIG. 76 shows a plot of a change in open circuit voltage (OCV) over time of fully charged triphasic flow cell based on design-I and design-II.

FIG. 77 shows a cell stack configuration for membrane-free biphasic battery. (A) Battery stack configuration and (B) single cell configuration.

FIG. 78 shows a cell stack configuration for membrane-free triphasic battery for design-I. (A) Battery stack configuration and (B) single cell configuration.

FIG. 79 a cell stack configuration for membrane-free triphasic battery for design-II. (A) Battery stack configuration and (B) single cell configuration.

FIG. 80 shows a schematic of an all-nonaqueous triphasic high-voltage membrane-free redox flow batteries with nearly 100% Coulombic efficiency.

FIG. 81 shows (A) Schematic of the triphasic systems (Design-I and -II). (B) Redox reactions of C18-PTZ. (C) Cyclic voltammograms were measured by repeated potential sweeping of 5 mM C18-PTZ in FEC/LiTFSI (0.1 M) on a glassy carbon electrode at a scan rate of 50 mV/s. (D) Cycling voltammetry stability of C18-PTZ in a FEC/LiTFSI (0.1 M) solution at different scan rates in the range of 50-250 mV/s. (E) The ratio of the reduction and oxidation peak currents as a function of scan rate.

FIG. 82 shows RDE studies of electrolyte solutions containing C18-PTZ (1 mM) in FEC/LiTFSI (0.1 M). (A) LSV curves at a scan rate of 5 mV/s with rotation rates from 100 to 1600 rpm. (B) Fitted linear Lévich plots of the limiting current (iL) versus the square root of rotation rates (ω^{1/2}). (C) Linearly fitted Koutecký-Lévich plots of i⁻¹ vs. ω-1/2. (D) Linearly fitted plots of log iₖ as a function of overpotential.

FIG. 83 shows charge/discharge performances of Li∥C18-PTZ (0.5 M) triphasic battery cells under static conditions. Capacity retention, Coulombic efficiency (CE), voltage efficiency (VE), and energy efficiency (EE) values of Li∥C18-PTZ (0.5 M) static cells based on (A) Design-I and (B) Design-II. Cyclic voltammograms of the pre- and post-cycled catholytes of (C) Design-I and (D) Design-II. Charge/discharge profiles at different operating current densities based on (E) Design-I and (F) Design-II. Coulombic efficiency (CE), voltage efficiency (VE), and energy efficiency (EE) at different current densities for (G) Design-I and (H) Design-II.

FIG. 84 shows charge/discharge performances of the Li|C18-PTZ (0.5 M) triphasic battery cells based on Design-I and -II under flow conditions. Capacity retention, Coulombic efficiency (CE), voltage efficiency (VE), and energy efficiency (EE) values of the Li∥C18-PTZ (0.5 M) flow cells based on (A) Design-I and (B) Design-II. Cyclic voltammograms of the pre- and post-cycled catholytes of the Li∥C18-PTZ (0.5 M) flow cells based on (C) Design-I and (D) Design-II. Charge/discharge profiles of the Li∥C18 -PTZ (0.5 M) flow cells based on (E) Design-I and (F) Design-II at different operating current densities. CE, VE, and EE values of the Li∥C18-PTZ (0.5 M) flow cells based on (G) Design-I and (H) Design-II at different operating current densities.

FIG. 85 are photographs of the TEGDME (top)/NFTTS (bottom) liquid-liquid system with varying concentrations of LiTFSI.

FIG. 86 are photographs of the development of TEGDME/NFTTS/FEC liquid/liquid triphasic system through salt-out strategy.

FIG. 87 are photographs of the TEGDME/NFTTS/FEC liquid/liquid triphasic system with (A) Design-I (with and without redox materials for visible clarity) and (B) Design-II (with and without redox materials for visible clarity).

FIG. 88 is a table tabulating screening of cathode materials for triphasic system and chemical structures of redox-active materials.

FIG. 89 are UV-visible spectra (A) and cyclic voltammograms (B) of the catholyte and anolyte of the triphasic system with C18-PTZ (0.5 M) on day 0 and day 10.

FIG. 90 is a plot of current vs. square root of scan rate. (Peak current values for cathodic and anodic current were measured from data shown in FIG. 81).

FIG. 91 is a schematic of triphasic membrane-free flow cells based on (A) Design-I and (B) Design-II. NFTTS acts as an ion-exchange electrolyte layer.

FIG. 92 are plots showing change in open circuit voltage (OCV) over time of fully charged triphasic static cell based on (A) Design-I and (B) Design-II.

FIG. 93 are plots of polarization curve and ASR of triphasic battery based on (A, C) Design-I and (B, D) Design-II at different states-of-charge (SOC) under static conditions.

FIG. 94 are plots of charge/discharge performance of Li∥C18-PTZ triphasic batteries based on Design-I and Design-II, both featuring a cathode-to-anode capacity ratio of 1:0.9.

FIG. 95 are plots of CV analysis of catholyte and anolyte of pre- and post-cycled batteries based on (A) Design-I and (B) Design-II.

FIG. 96 are photographs of digital photographs of lithium metal anode (A) before cycling and (B) after cycling of Design-I batteries. (C) Before cycling and (D) after cycling of Design-II batteries.

FIG. 97 are plots of optimization of flow rate for the triphasic system based on (A) Design-I and (B) Design-II at the current density of 1 mA/cm².

FIG. 98 are plots of open circuit voltage (OCV) over time of fully charged triphasic flow cell based on Design-I (A) and Design-II (B).

FIG. 99 are plots of polarization curve and ASR of triphasic battery based on (A, C) Design-I and (B, D) Design-II at different states-of-charge (SOC) under flow conditions.

FIG. 100 is a table tabulating performance comparison of membrane-free batteries.

FIG. 101 is a table tabulating the development of nonaqueous biphasic systems.

FIG. 102 is a table tabulating screening of cathode materials for FEC/BMP-TFSI biphasic systems.

FIG. 103 is a table tabulating equivalent circuit fitting data and the corresponding fitting error for EIS.

FIG. 104 is a schematic of a cell stack configuration for membrane-free biphasic battery. (A) Battery stack configuration and (B) single cell configuration.

FIG. 105 is a schematic of a cell stack configuration for membrane-free triphasic battery for design-I. (A) Battery stack configuration and (B) single cell configuration.

FIG. 106 is a schematic of a cell stack configuration for membrane-free triphasic battery for design-II. (A) Battery stack configuration and (B) single cell configuration.

### DETAILED DESCRIPTION

The patent or application file contains at least one drawing executed in color. Copies of this patent or patent application publication with color drawings will be provided by the Office upon request and payment of the necessary fee.

### Part A

Developing an all organic NBS with suitable catholyte and anolyte materials is highly challenging owing to the interplay between the solubility of the active material and its crossover. Li metal was selected as the anode material because of its high energy density and theoretical capacity (~3,860 mAh/g) and low electrochemical potential (−3.04 V vs. SHE). On the other hand, graphite felt (GF) was selected as the cathode material because of its high specific surface area, highly porous structure, high electrical conductivity, and chemical inertness in nonaqueous electrolytes. The unique structure of GF and the presence of a large number of surface catalytic sites result in fast redox reaction kinetics and hence improved battery performance. The successful fabrication of an NBS for high-performance membrane-free LRFBs requires that (1) the two nonaqueous electrolytes must be immiscible, show high ionic conductivities, and a wide electrochemical stability window and (2) the redox-active cathode material should have high solubility in the catholyte and extremely low solubility in the anolyte in both the charging and discharging states to prevent the self-discharging of the battery because of crossover. Both requirements are discussed below.

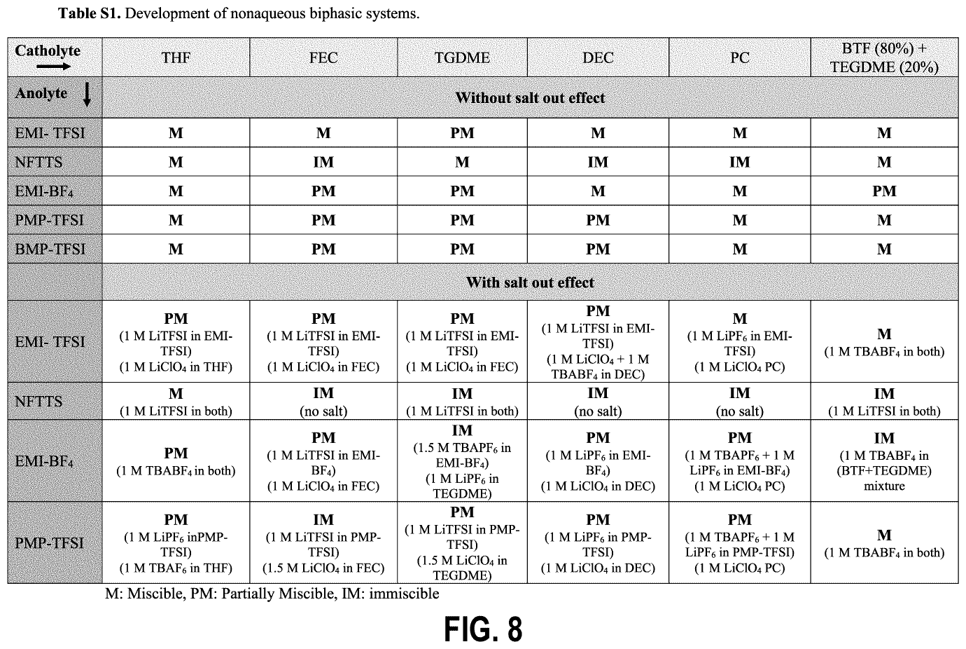

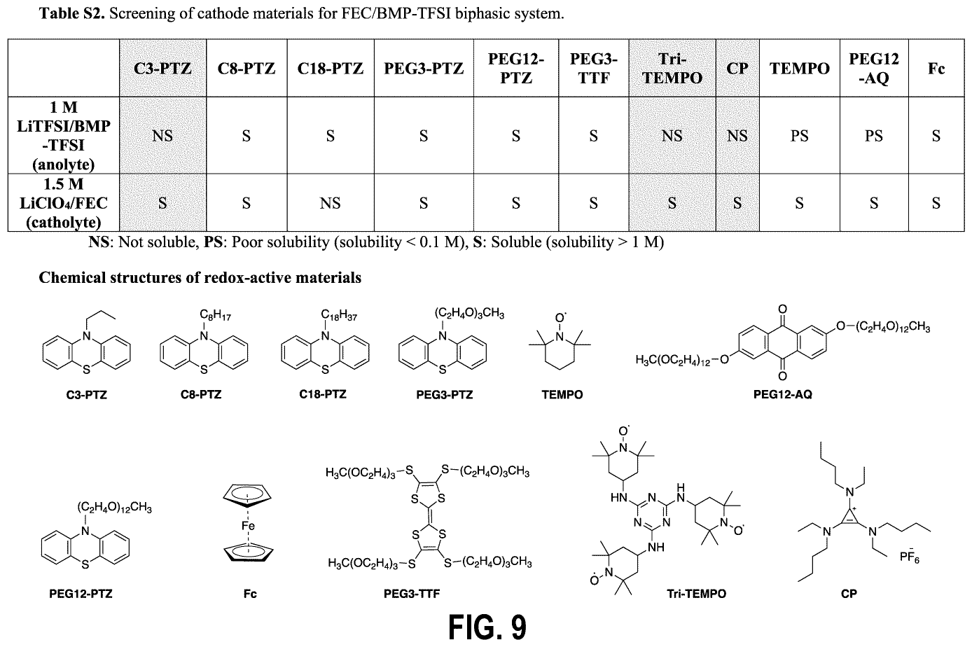

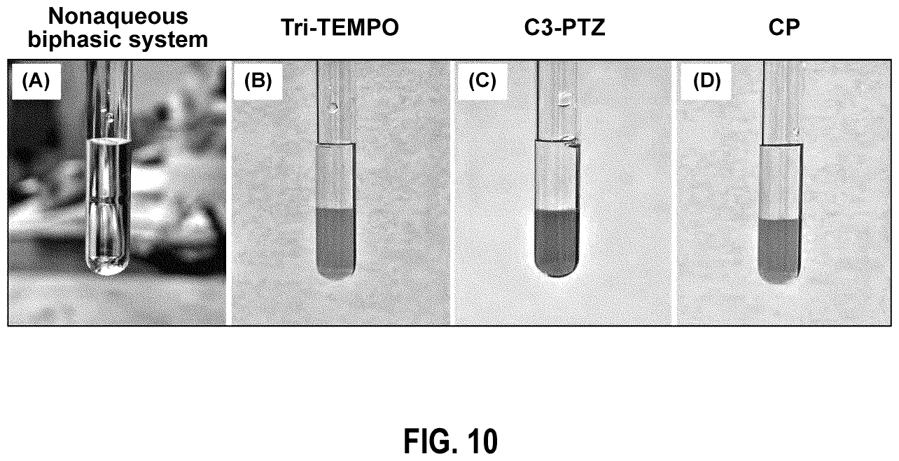

To explore electrolytes with the above-mentioned properties, eleven nonaqueous solvents (including four ILs and seven nonionic organic solvents) were screened to construct the NBS (FIG. 8). ILs have been explored widely for use in Li-ion batteries as compatible anolytes for Li metal, as they not only allow for a wider electrochemical window (~6 V) but also suppress the growth of Li dendrites during longer battery operations. Here, four ILs, namely, ethyl-3-methylimidazolium bis(trifluoromethylsulfonyl)imide (EMI-TFSI), N-propyl-N-methylpyrrolidinium bis(trifluoromethanesulfonyl)imide (PMP-TFSI), 1-ethyl-3-methyl imidazolium tetrafluoroborate (EMI-BF4), and 1-butyl-1-methylpyrrolidinium bis(trifluoromethylsulfonyl)imide (BMP-TFSI), along with nonafluoro-1,1,2,2-tetrahydrohexyl-trimethoxysilane (NFTTS) were selected as the anolyte solvents, and six organic solvents, namely, tetrahydrofuran (THF), tetraethylene glycol dimethyl ether (TEGDME), fluoroethylene carbonate (FEC), diethylene carbonate (DEC), propylene carbonate (PC), and benzotrifluoride (BTF), were explored for use as the catholyte. A few pairs of the anolyte and catholyte solvents were intrinsically immiscible in their neat forms (FIG. 8). The other electrolytes that were either miscible or partially immiscible in their neat forms could be rendered immiscible using salt-out strategies (FIG. 8). The most effective salt-out strategy involves the use of salts that have high solubility in one organic phase and low (or no) solubility in the another organic phase to facilitate the formation of a biphasic system. To screen the electrolyte salts with the abovementioned properties, five salts, namely, lithium bis(trifluoromethanesulfonyl)imide (LiTFSI), lithium perchlorate (LiClO₄), tetrabutylammonium hexafluorophosphate (TBAPF₆), tetrabutylammonium tetrafluoroborate (TBABF₄), and lithium hexafluorophosphate (LiPF₆), were selected for solubility analyses (see FIG. 8). After the analyses, three NBSs, namely, FEC (1.5 M LiClO₄)/BMP-TFSI (1 M LiTFSI), TEGDME/NFTTS with 1 M LiTFSI, and BTF-TEGDME/EMI-BF4, with 1 M TBABF₄, were formed. Since both phases of the NBS should have the same exchange ions to facilitate the charging/discharging of the membrane-free battery, Li⁺ ions were used as the exchange ions for FEC/BPM-TFSI and TEGDME/NFTTS biphasic systems and BF₄ ions for BTF-TEGDME/EMI-BF₄ biphasic. Of the three, NBSs, FEC/BPM-TFSI (FIG. 10a) was selected for the subsequent electrochemical analyses and battery performance studies due to following reasons. The high solubilizing ability of FEC allowed catholytes (FIG. 9) with different redox potentials to be evaluated. Plus, FEC exhibits higher ionic conductivity compared with those of BTF and NFTTS.

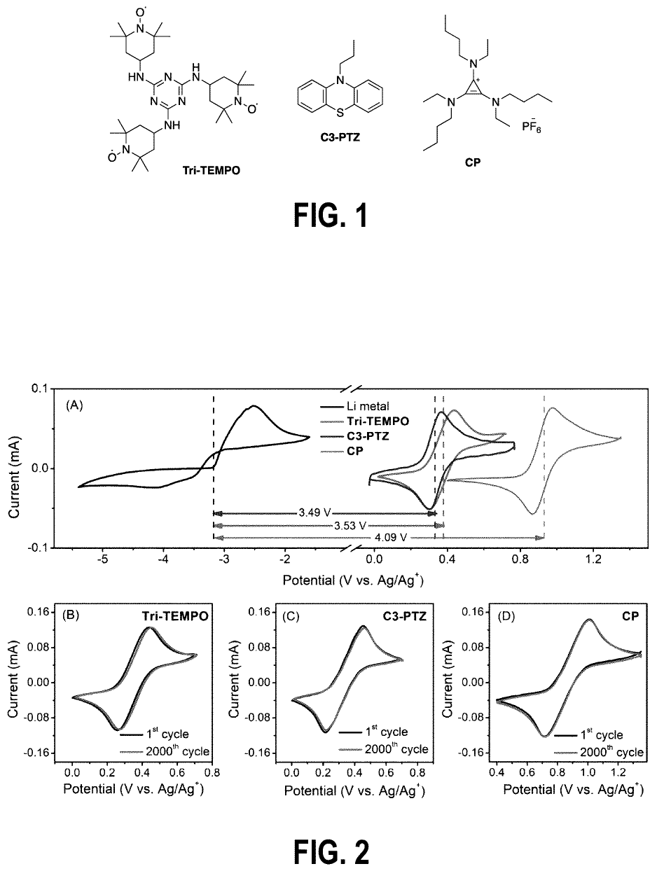

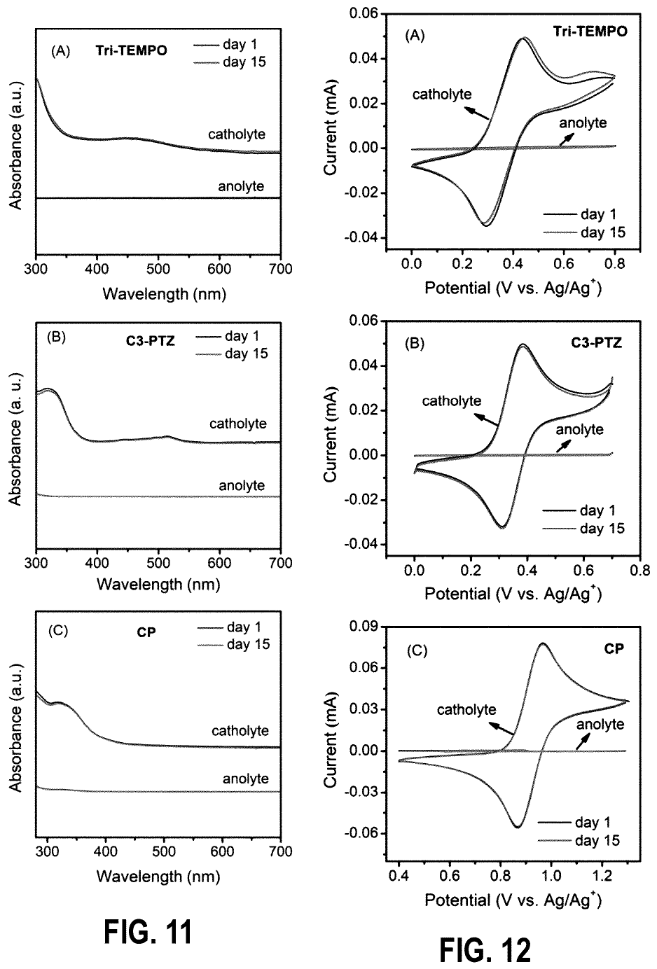

A catholyte with high solubility with respect to the anolyte solvent would ensure high energy density while one with low (ideally zero) solubility would prevent crossover. To explore catholyte materials that meet these solubility requirements, eleven organic compounds were selected, and their solubilities in both phases of the NBS were tested. These materials included derivatives of phenothiazine, cyclopropenium, 2,2,6,6-tetramethylpiperidinyloxy (TEMPO), anthraquinone (AQ), and ferrocene (FIG. 9). Among the catholyte materials, Tri-TEMPO, C3-PTZ, and CP (FIG. 1) showed high solubilities in FEC and extremely poor affinity towards the anolyte (FIG. 10). The solubilities of Tri-TEMPO, C3-PTZ, and CP in 1.5 M LiClO₄/FEC were ~1.2 M, ~1 M, and 1.8 M, respectively (See FIG. 8 for the details of the solubility tests). Negligible crossover occurred under static conditions over 15 days, as confirmed by ultraviolet (UV)-visible spectroscopy (FIG. 11) and cyclic voltammetry (CV) (FIG. 12). Hence, Tri-TEMPO, C3-PTZ, and CP were selected as the cathode materials for the subsequent experiments.

A liquid/liquid biphasic system for electrochemical energy storage is achieved by selecting any two nonaqueous solvent systems, wherein one exhibits higher solubility than the other for a specific electrolyte salt. The formation of this biphasic system is optimized at a particular salt concentration, facilitating its utilization in electrochemical energy storage systems.

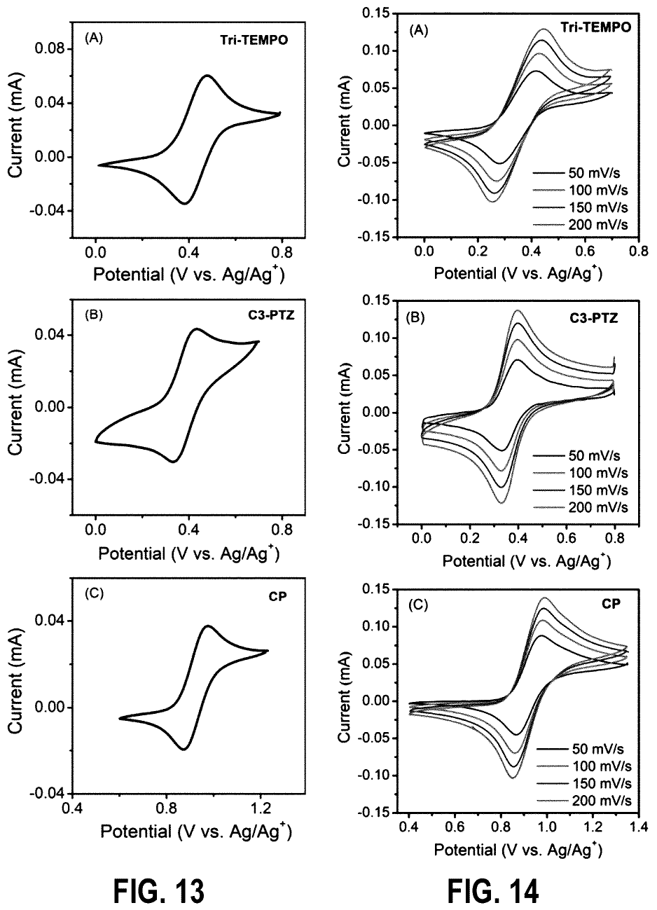

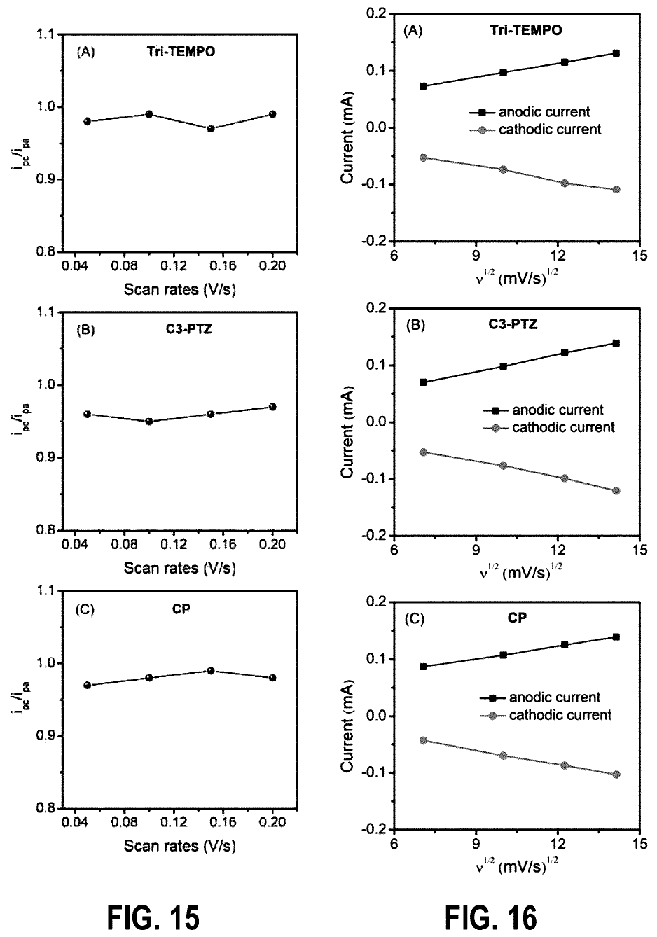

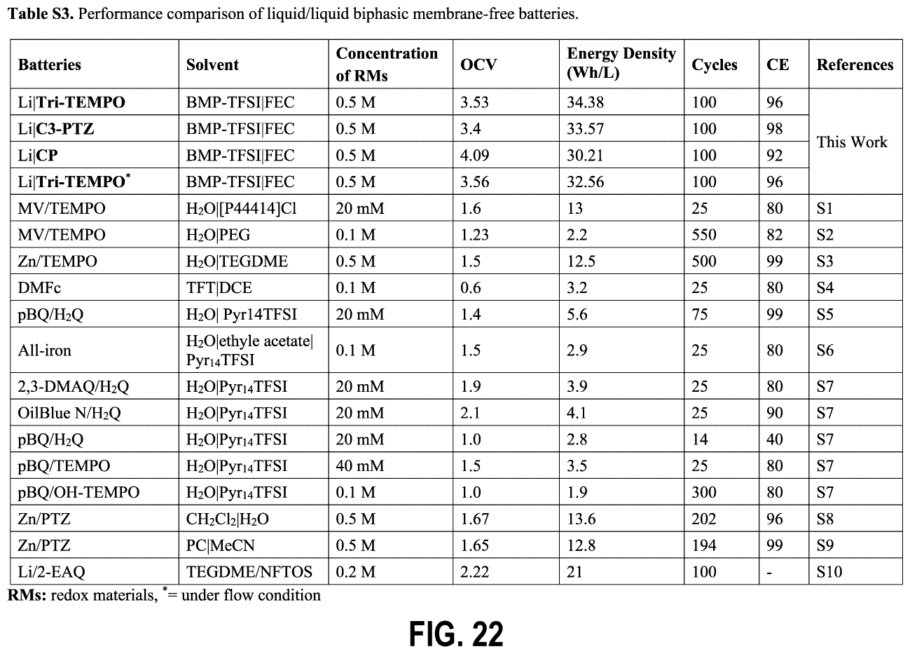

Electrochemical Characterization. CV was performed to determine the electrochemical compatibility of the Li metal anode in the ILs as well as the reversibility of the redox-active cathode materials (Tri-TEMPO, C3-PTZ, and CP) in FEC. Tri-TEMPO, C3-PTZ, and CP exhibit a reversible redox couple at 0.37, 0.33, and 0.93 V vs. Ag/Ag⁺ in 0.1 M LiClO₄/FEC (FIG. 2A). The pairs of the Li-metal anode and the three cathode materials (i.e., Li|Tri-TEMPO, Li|C3-PTZ, and Li|CP) exhibited theoretical cell voltages of 3.53, 3.49, and 4.09 V, respectively (FIG. 2A); these are significantly higher than those of previously reported biphasic membrane-free batteries (FIG. 22). The peak potential separations of Tri-TEMPO, C3-PTZ, and CP at a scan rate of 5 mV/s were ~74, ~69, and ~76 mV, respectively (FIG. 13) and indicative of a one-electron redox process as per the Nernst equation. Next, CV measurements were performed at scan rates of 50-200 mV/s (FIG. 14) to study the electrochemical kinetics of the catholyte compounds. The ratios of the cathodic peak current (i_{pc}) and anodic peak current (iₚₐ) for Tri-TEMPO, C3-PTZ, and CP at the investigated scan rates (50-200 mV/s) were close to 1 (FIG. 15), suggesting that the compounds exhibited excellent electrochemical reversibility in FEC. Further, the peak currents (anodic and cathodic) exhibit a linear relationship with the square root of the scan rate (v^{1/2}) for all three cathode materials (FIG. 16), indicating that the redox process is diffusion-controlled. Tri-TEMPO, C3-PTZ, and CP were also subjected to long-term cycling CV measurements at a scan rate of 200 mV/s to evaluate their stability in FEC (FIGS. 2B, 2C, and 2D). That the voltammograms of the compounds obtained after the 1st and 2000th cycles were almost completely superimposable confirmed their high cycling stability.

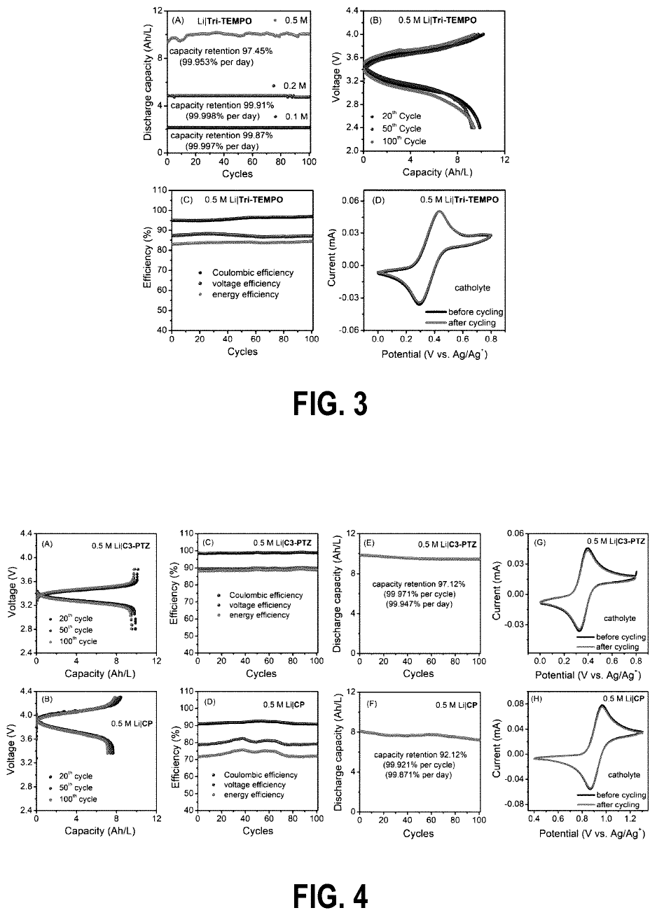

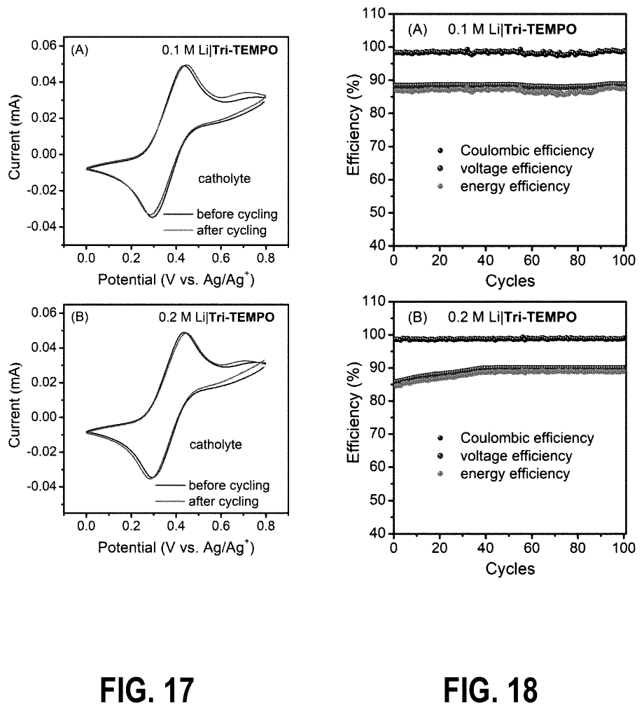

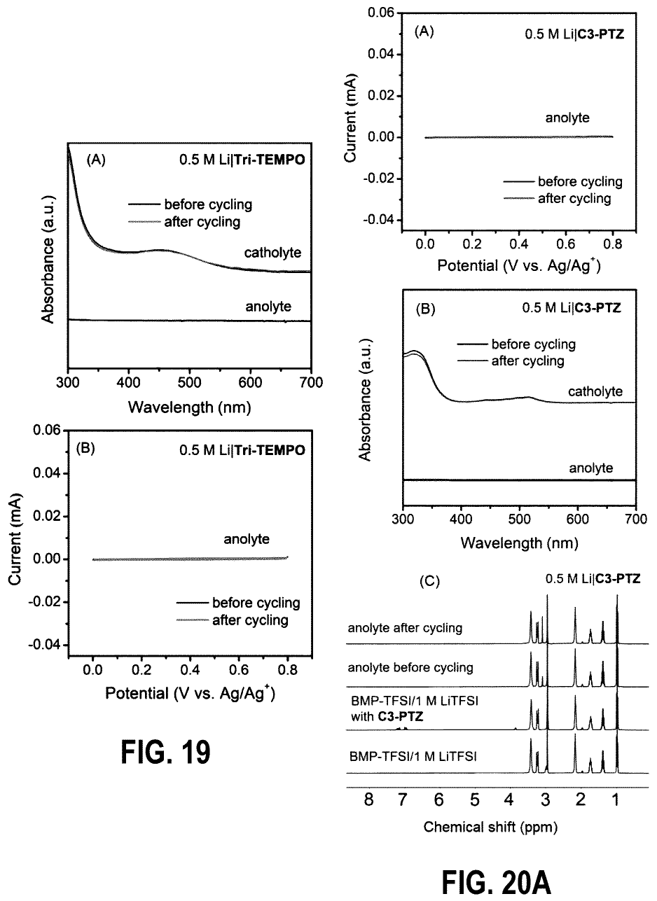

Charge/discharge performance of biphasic membrane-free batteries. Under static conditions: the viability of the developed biphasic system as a membrane-free battery was initially evaluated under static conditions. As a starting point, two nonaqueous biphasic static batteries (NBSBs) were assembled by pairing a Li-metal anode with 0.1 or 0.2 M Tri-TEMPO, and the batteries were subjected to charging/discharging for 100 cycles (~13 days for 0.1 M Tri-TEMPO and ~22 days for 0.2 M Tri-TEMPO) at a current density of 1 mA/cm², as shown in FIG. 3. While the current density could be increased further, the operational current density was significantly higher than that reported previously for aqueous and nonaqueous biphasic membrane-free systems. The 0.1 M and 0.2 M Li|Tri-TEMPO NBSBs (FIG. 3A) both showed excellent cycling performances, exhibiting capacity retention rates of 99.87% (99.998% per cycle, 99.997% per day) and 99.91% (99.998% per cycle, 99.998% per day), respectively. This confirmed that the redox-active materials, supporting electrolytes, and solvent exhibited high stability under actual battery operation conditions. Moreover, both NBSBs exhibited high CE (over 99% for both) and EE values (86% for 0.1 M and 84% for 0.2 M). A CE value as high as ~99% suggests extremely low self-discharging and thus negligible active material crossover. Moreover, there was no obvious change in the peak current densities of the 0.1 M and 0.2 M Li|Tri-TEMPO catholytes (FIG. 17) post cycling, which further confirmed that the Tri-TEMPO redox molecules remained confined within the catholyte (FEC phase) during the prolonged cycling process. Based on these results, we built an NBSB containing the catholyte in a higher concentration. Specifically, a 0.5 M Li|Tri-TEMPO NBSB was assembled and subjected to long-term charging/discharging (100 cycles, ~55 days), as shown in FIG. 3A. The 0.5 M Li|Tri-TEMPO battery exhibited a capacity retention rate of 97.5% (99.97% per cycle, 99.95% per day) (FIG. 3A). Its cycling profile suggests a discharging voltage of 3.48 V with no significant change in the overpotential over the course of the cycling process (FIG. 3B). The 0.5 M Li|Tri-TEMPO NBSB exhibited CE, VE, and EE values of 96%, 87%, and 83% (FIG. 3C), respectively, which are significantly higher than those of previously reported membrane-free systems (FIG. 22). However, these values were slightly lower than those of the 0.1 M and 0.2 M NBSBs (FIG. 18), presumably owing to self-discharging at the interface during the prolonged charging/discharging process (~55 days). Moreover, a higher catholyte concentration would mean a relatively high flow resistance, resulting in lower ionic conductivity and greater transport losses and hence a lower VE value. However, the 0.5 M Tri-TEMPO NBSB had a discharge volumetric energy density of 28 Wh/L which is significantly higher than those of most state-of-the-art biphasic membrane free static and flow batteries (FIG. 22). The electrolytes were analyzed both before and after cycling using UV visible spectroscopy (FIG. 19A) and CV (FIGS. 3D and 19B). The analyses indicated that Tri-TEMPO was not present in the post cycling anolyte. Hence, the high cycling stability of the Li|Tri-TEMPO biphasic batteries with different Tri-TEMPO concentrations (0.1, 0.2, and 0.5 M) suggested that they are highly suited for practical use. It also confirmed the high compatibility of Li metal with the anolyte and that of GF with the catholyte.

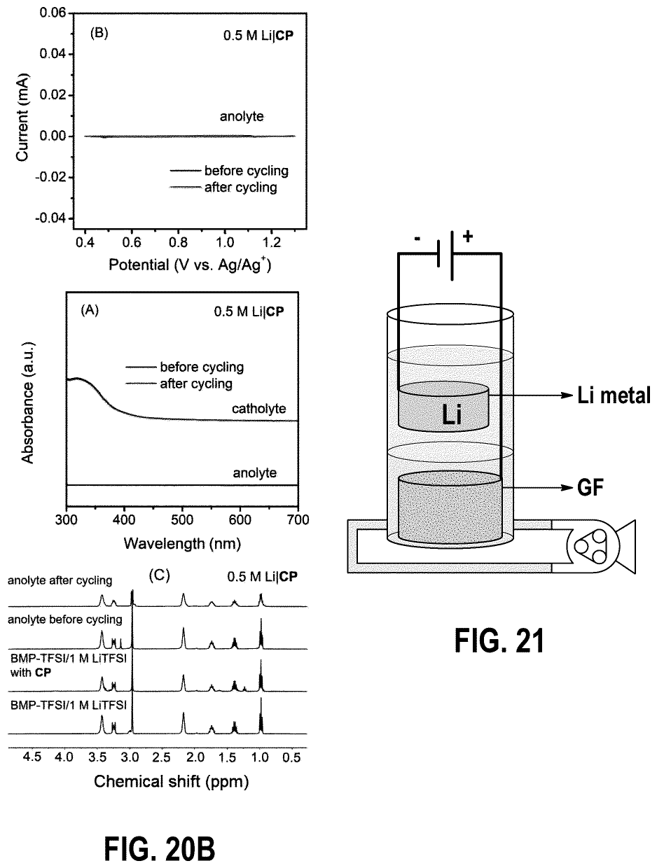

To evaluate the versatility of the developed NBS, the other two selected catholyte materials (C3-PTZ and CP) were studied under the same conditions as those used for the Li|Tri-TEMPO battery (FIG. 4). The long-term performances of both NBSBs were investigated through extended charging/discharging tests performed at 1 mA/cm² for 100 cycles. The 0.5 M Li|C3-PTZ battery was charged/discharged within the voltage range of 2.8-3.8 V (FIG. 4A, whereas the 0.5 M Li|CP battery was cycled in the 3.3-4.3 V range (FIG. 4B). The 0.5 M Li|C3-PTZ and 0.5 M Li|CP NBSBs exhibited distinct stable plateaus and discharging voltages of 3.42 and 3.94 V, respectively, which are significantly higher than those reported for most aqueous and nonaqueous membrane-free flow battery systems (FIG. 22). The 0.5 M Li|C3-PTZ (FIG. 4C) battery also showed stable CE, VE, and EE values of 98%, 90%, and 88%, respectively, throughout the cycling process, whereas the 0.5 M Li|CP (FIG. 4D) battery exhibited CE, VE, and EE values of 91%, 79%, and 72% respectively. That the CE values of both batteries were greater than 90% indicated that negligible self-discharging had occurred in the batteries Furthermore, the 0.5 M Li|C3-PTZ (FIG. 4E) and 0.5 M Li|CP (FIG. 4F) batteries showed excellent cycling stability, with their capacity retention rates being 97.12% (99.971% per cycle, 99.949 per day) and 92.12% (99.921 per cycle, 99.856 per day), respectively. The electrolytes of the 0.5 M Li|C3-PTZ (FIGS. 4G and 20) and 0.5 M Li|CP (FIGS. 4H and 21) batteries were subjected to CV measurements, UV-visible spectroscopy, and proton nuclear magnetic resonance (¹H NMR) spectroscopy both before and after cycling. The quantitative CV analysis of the catholytes and anolytes of the 0.5 M Li|C3-PTZ (FIGS. 4G and 20A) and 0.5 M Li|CP (FIGS. 4H and 21A) batteries did not indicate significant changes in their current densities even after 100 charge/discharge cycles. Moreover, the post-cycling UV-visible spectra of the 0.5 M Li|C3-PTZ and 0.5 M Li|CP anolytes confirmed the absence of crossover (FIGS. 20B and 21B). Finally, that the NMR spectra of the pre- and post-cycled anolytes of both batteries (FIGS. 20C and 21C) were nearly identical confirmed that C3-PTZ and CP remained in the catholyte phases and did not cross over.

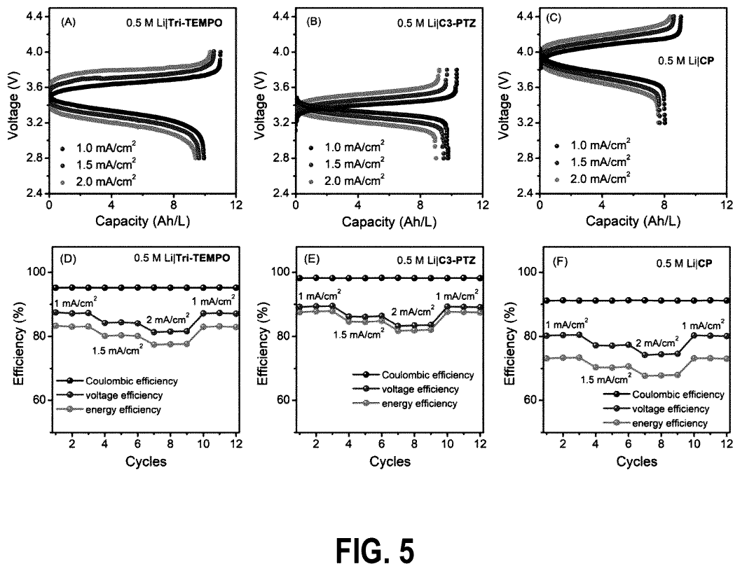

To elucidate the effect of the high current density of the NBSBs on their performance, the charge/discharge behaviors of the 0.5 M Li|Tri-TEMPO, 0.5 M Li|C3-PTZ, and 0.5 M Li|CP batteries were studied at current densities of 1, 1.5, and 2 mA/cm², and their average CE, VE, and EE values were measured for 3 cycles. The 0.5 M Li|Tri-TEMPO (FIG. 5A), 0.5 M Li|C3-PTZ (FIG. 5B), and 0.5 M Li|CP (FIG. 5C) NBSBs exhibited ohmic dropsode ~80, ~50, and ~60 mV, respectively, at 1.5 mA/cm² and ~130, ~98, and ~110 mV, respectively, at 2 mA/cm². The increase in the ohmic loss at the higher current density can be ascribed to limitations related to mass diffusion. The Li|Tri-TEMPO (FIG. 5D), Li|C3-PTZ (FIG. 5E), and Li|CP (FIG. 5F) batteries showed CE values of 96%, 98%, and 92%, respectively, at all the operating current densities, indicating that fast charging/discharging did not induce noticeable side reactions. However, the EE values of the Li|Tri-TEMPO, Li|C3-PTZ, and Li|CP batteries were reduced from 83%, 88%, and 72%, respectively, to 78%, 80%, and 70%, respectively, when the applied current density was increased 1 to 2 mA/cm². This was owing to an increase in the overpotential because of mass transport losses. It should be noted that all three batteries regained their original efficiencies when they were cycled back at 1 mA/cm², thus confirming their superior charge rate performance.

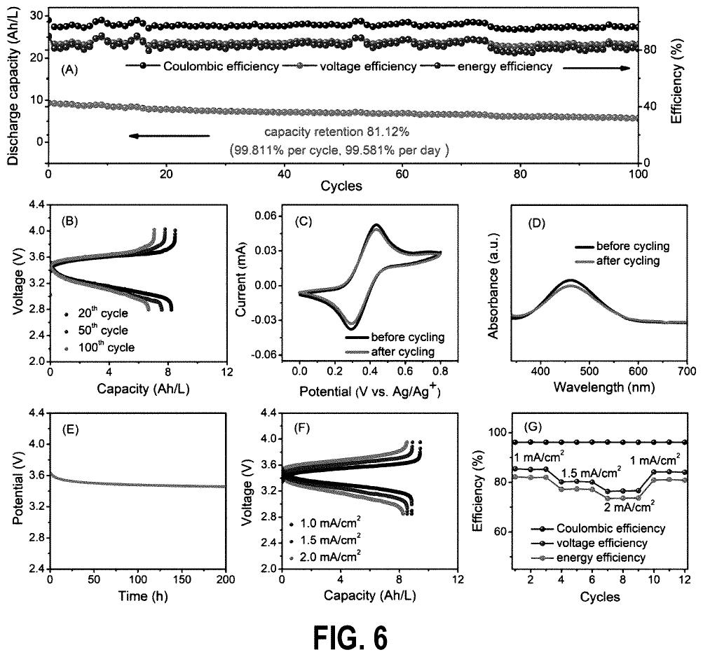

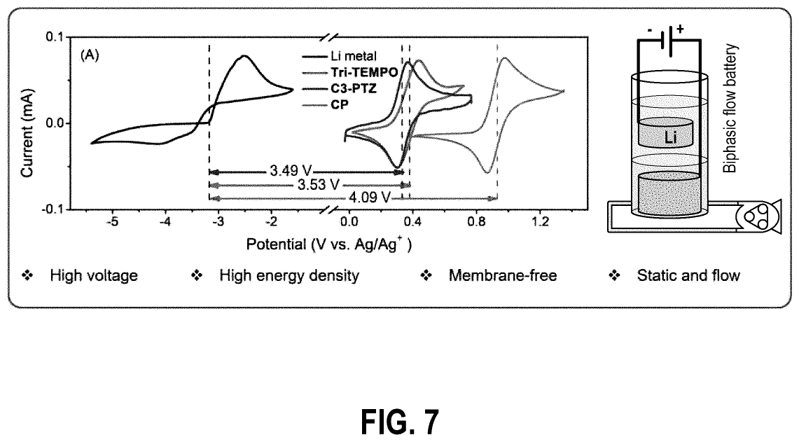

Under flow conditions: While the performances of the batteries under static conditions were compelling, their energy and power were not decoupled. Thus, the capacity of the batteries was not scalable, as is necessary under flow conditions. Hence, a Li-based nonaqueous biphasic flow battery based on 0.5 M Tri-TEMPO was assembled, and its long-term cycling performance was evaluated (FIG. 21). Under flow conditions (1.5 mL/min), after 100 charge/discharge cycles, the 0.5 M Li|Tri-TEMPO battery showed a capacity retention rate of 81.12% (99.811 per cycle, 99.581 per day) along with a CE of ~96%, VE of ~85%, and EE of ~82% (FIGS. 6A and 6B). To elucidate the mechanism responsible for its capacity fading, its electrolytes were analyzed both before and after cycling using CV (FIG. 6C) and UV-visible spectroscopy (FIG. 6D). The reduction in the CV peak current and absorbance of the post-cycling catholyte were indicative of the slight crossing over of the Tri-TEMPO molecules because of the convective diffusion of the flowing catholyte during prolonged battery cycling. To clarify the effect of the flowing catholyte on the self-discharging of the battery, its open-circuit voltage (OCV) in the fully charged state was monitored over 200 hours (FIG. 6E). The OCV of the battery displayed a sharp decrease during the first 10 hours after the charging process owing to ohmic polarization (i_{R} drop), followed by a voltage loss of 0.63 mV/h in the next 190 hours, which corresponded to a total drop of 120 mV over 190 hours. However, the per-hour voltage loss of this battery was smaller than that of previously reported aqueous/nonaqueous biphasic membrane-free batteries.

The charge-rate performance of the 0.5 M Li|Tri-TEMPO flow battery was evaluated at current densities of 1, 1.5, and 2 mA/cm², and the corresponding cycling profiles (FIG. 6F) as well as the CE, VE, and EE (FIG. 6G) values were measured for an average of three cycles. When operated at a current density of 2 mA/cm², the battery exhibited a discharge overpotential of 132 mV, which is nearly twice that when it was operated at a current density of 1 mA/cm². The increase in the overpotential and the corresponding reduction in the VE at the higher current density can be attributed to mass transport limitations. However, the battery was able to regain its original performance when cycled again at the applied current density of 1 mA/cm², suggesting that the biphasic battery showed excellent rate cyclability under flow conditions.

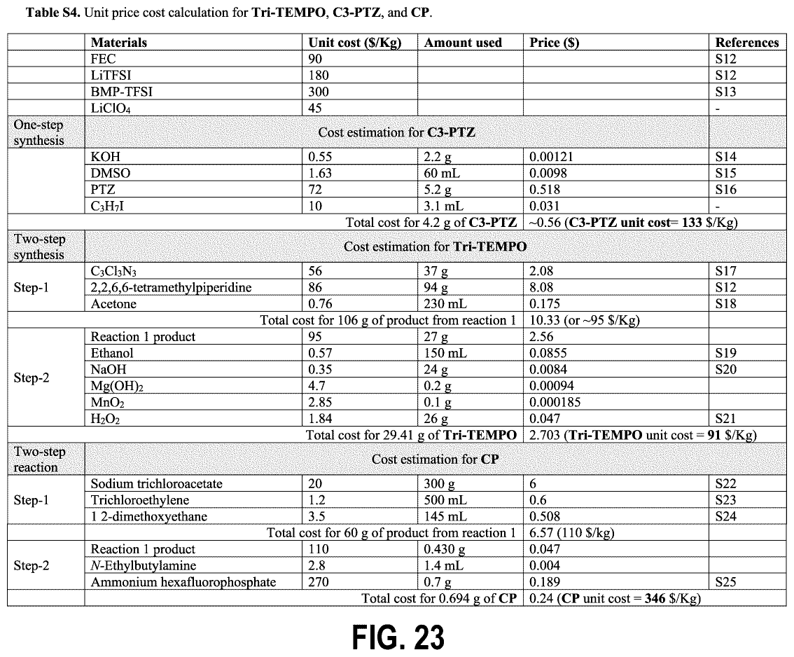

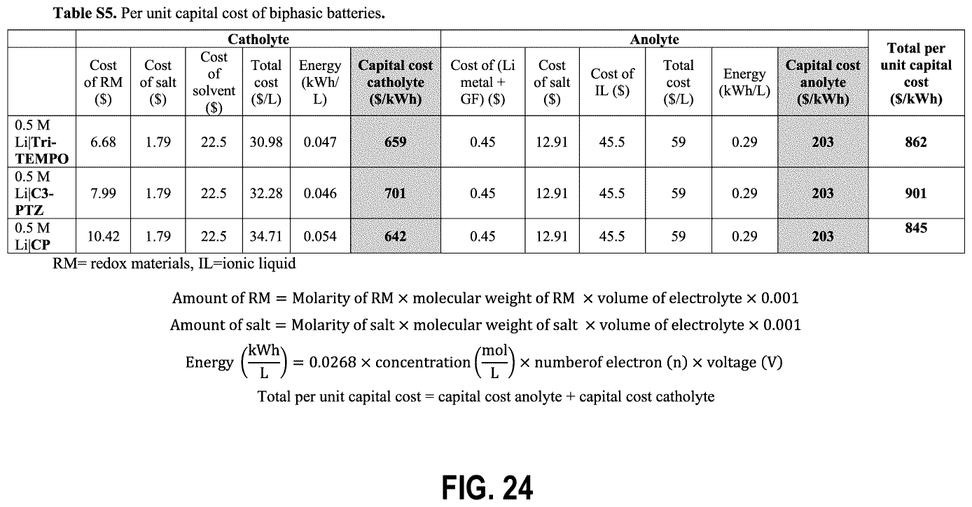

Techno-economic analysis. The cost of the Tri-TEMPO, C3-PTZ, and CP nonaqueous membrane-free batteries is primarily related to the cost of the components used in the catholyte layer (i.e., the redox-active materials, FEC, LiClO₄, and GF) and anolyte layer (i.e., BMP-TFSI, LiTFSI, and Li metal). Based on the estimated price of each component, shown in FIG. 23, the per unit capacity costs of the 0.5 M Li|Tri-TEMPO, 0.5 M Li|C3-PTZ, and 0.5 M Li|CP nonaqueous membrane-free batteries are $862, $901, and $845 per kWh, respectively (FIGS. 23 and 24); these values are 2.92-, 2.8-, 3-fold lower than that of a benchmark nonaqueous Li redox flow battery (Li/TEMPO in FEC, EC, and EMC; $2525 per kWh) and pretty much comparable to that of vanadium redox flow battery ($740/kWh). The major cost of nonaqueous Li redox flow batteries comes from its typical components including bipolar plate (~18%), GF (~28%), membrane (~35%), and current collector plate (~3%). While the costs of the ILs used in this study and the compounds synthesized in this study are higher than that of the benchmark system, the fact that several components (membrane separator, bipolar plates, current collector plate, and end plate) are not used in the developed system dramatically reduces its overall cost. Hence, the cost-effectiveness of the proposed batteries makes them highly suited for use as efficient EES systems.

In summary, we report a nonaqueous biphasic membrane-free Li-based redox flow battery with high voltage and energy density. A nonaqueous biphasic system was developed using an IL and organic carbonate as the electrolytes based on the salt-out effect. Three redox-active cathode materials, namely, Tri-TEMPO, C3-PTZ, and CP, were selected after analyzing 11 organic redox-active compounds. Initially, the 0.1 M and 0.2 M Li|Tri-TEMPO static biphasic membrane-free batteries were subjected to 100 charge/discharge cycles and showed capacity retention rates of 99.87% and 99.91%, respectively. The 0.1 M and 0.2 M Li|Tri-TEMPO biphasic batteries exhibit energy densities of ~7.2 and 16.6 Wh/L, respectively. To increase the energy density, a 0.5 M Li|Tri-TEMPO membrane-free static battery was assembled and subjected to 100 cycles. It exhibited a capacity retention rate of ~98%, CE of 96%, and energy density of 34.5 Wh/L. To confirm the versatility of the proposed biphasic system, two more redox-active materials, namely, C3-PTZ and CP, were tested in a membrane-free battery under static conditions. The 0.5 M Li|C3-PTZ and 0.5 M Li|CP biphasic static batteries exhibited discharge voltages of 3.42 and 3.94 V, respectively, which were significantly higher than those of previously reported biphasic membrane-free battery systems. The Li|C3-PTZ and Li|CP biphasic static batteries containing the redox-active materials in a 0.5 M concentration displayed capacity retention rates of 98%, and 92%, respectively, after 100 cycles over ~55 days. Post-cycling analyses indicated that there were no signs of material degradation or crossover even after prolonged battery operation for any of the membrane-free static batteries. This confirmed the versatility of the nonaqueous biphasic system. To ensure the decoupling of the energy and power, the developed membrane-free batteries were also studied under flow conditions. The representative Li|Tri-TEMPO (0.5 M) flow battery exhibited a capacity retention rate of 81% after 100 cycles over ~45 days, with its CE and EE values being 96% and 82%, respectively. The flow biphasic battery displayed higher energy density (32.6 Wh/L) than those of the earlier reported membrane-free batteries. The high voltage, long cycling lifespan, and easy fabrication process of the proposed membrane-free battery makes it highly suited for use as a sustainable EES system. This study is a significant advance in the development of biphasic systems for membrane-free batteries that show both high voltage and high energy density under static as well as flow conditions.

Methods. Materials: Lithium hexafluorophosphate (LiPF₆, 99.99%) was purchased from Sigma Aldrich. The ILs used, namely, EMI-TFSI, PMP-TFSI, EMI-BF₄, and BMP-TFSI, were purchased from TCI Chemicals. Lithium perchlorate (LiClO₄, 98%), LiTFSI (99.94%), FEC, DEC, PC, NFTTS, BTF, THF, and TEGDME were purchased from Fisher Scientific and used without further purification. TBAPF₆ was recrystallized in anhydrous ethanol and dried under vacuum at 60° C. for 24 h. The other compounds used in this study, such as Tri-TEMPO, C3-PTZ, CP, C8-PTZ, C18-PTZ, PEG3-PTZ, PEG12-PTZ, PEG3-TTF, and PEG12-AQ were prepared as per the reported procedures.

Characterization. Characterization: The UV-visible absorption spectra were recorded using a UV-visible spectrophotometer (Cary 8454 UV-Vis, Agilent Technologies). The CV measurements were performed using a Bio-Logic potentiostat. The charge/discharge performances were evaluated using Land and Bio-Logic potentiostats. ¹H NMo spectra were recorded on a Bruker AV400 spectrometer (400 MHz). Chemical shifts are reported in ppm.

Electrochemical characterization. CV measurements were performed to evaluate the electrochemical properties of the redox-active materials (Tri-TEMPO, C3-PTZ, and CP) as well as the crossover of the redox-active materials before and after long-term battery cycling. For the CV measurements, 5 mM Tri-TEMPO, 5 mM C3-PTZ, and 5 mM CP solutions were prepared in 0.1 M LiClO₄/FEC electrolyte. A 3-mm glassy carbon disk was used as the working electrode and was polished with 5-nm Al₂O₃ before the measurements. A piece of Pt wire (0.5 mm) was used as the counter electrode while a Ag/Ag⁺ electrode was used as the reference electrode.

Battery performance measurements. The biphasic system containing FEC (1.5 M LiClO₄) as catholyte and BMP-TFSI (1.0 M LiTFSI) as anolyte was utilized to assemble membrane-free static and flow batteries. The charge/discharge performances of the Li|Tri-TEMPO (0.1 M, 0.2 M, and 0.5 M), Li|C3-PTZ (0.5 M), and Li|CP (0.5 M) batteries were evaluated in the voltage ranges of 2.6-4.0, 2.8-3.8, and 3.3-4.3 V, respectively. The membrane-free batteries were tested in a cylindrical tube. For the static analyses, 0.25 mL of the catholyte and 0.25 mL of the anolyte were used. For the flow analyses, 0.6 mL of the catholyte and 0.6 mL of the anolyte were used; the catholyte was circulated through the cell at a flow rate of 1 mL/min using a peristaltic pump. The rate performances of the static and flow batteries were tested at current densities of 1, 1.5, and 2 mA/cm². Three charge/discharge cycles were performed for each current density. The self-discharging performance of the 0.5 M Li/Tri-TEMPO membrane-free flow battery was tested by recording the OCV over time using a fully charged battery. All the electrochemical measurements were performed in a glove box filled with Ar.

Solubility test. A solution of 1.5 M LiClO₄/FEC was used for the solubility measurements. The solution was gradually added to a vial containing known amounts of the organic compounds used as the catholytes (Tri-TEMPO, C3-PTZ, and CP). Once a clear solution was obtained, the volume of the electrolyte was determined using an analytical pipette. The solubilities of the organic compounds were calculated from the ratio of the molar amount to the electrolyte volume. These steps were repeated twice, and the average values are presented.

### Part B

Lithium-metal-based nonaqueous redox flow batteries (LRFBs) are attracting significant attention as alternatives to conventional aqueous redox flow batteries (RFBs) because of their high operating voltage and large theoretical energy density. However, the large-scale applicability of LRFBs is limited by the poor availability and high cost of the critically important ion-selective membranes. Therefore, membrane-free batteries stand out as promising alternatives. Herein, we report an ultra-high-voltage membrane-free LRFBs based on uniquely designed all-organic biphasic system that uses an ionic liquid as the anolyte and fluoroethylene carbonate as the catholyte. The Li metal anode was paired with Tri-TEMPO, C3-PTZ, and CP cathodes, which enable biphasic batteries with theoretical cell voltages of 3.53, 3.49, and 4.09 V, respectively. Under static conditions, the Li|Tri-TEMPO, Li|C3-PTZ, and Li|CP batteries containing 0.5 M redox-active material delivers capacity retention rates of 98%, 98%, and 92%, respectively, for 100 cycles over ~55 days. In addition, the representative Li|Tri-TEMPO (0.5 M) flow battery can retain 81% of capacity for 100 cycles over −45 days along with average Coulombic efficiency of 96% and energy efficiency of 82%. Thus, this study reports significant advances in biphasic systems for membrane-free batteries, achieving both high voltage and high energy density (~33 Wh/L) under flow conditions.

Large-scale electrical energy storage (EES) systems are vital for the efficient utilization of widely available intermittent renewable energy sources such as solar and wind energy to mitigate the mismatch between the generation and consumption of electrical energy. Batteries are the first choice for building advanced EES systems owing to their high efficiency and flexible installation. Among the various battery technologies being explored, redox-flow batteries (RFBs) have attracted particular attention as promising EES systems because of their unique feature of the decoupling of the energy density and power. Based on the electrolyte used, RFBs can generally be classified into two types: aqueous and nonaqueous RFBs. Aqueous RFBs use water as the solvent for the anolyte and catholyte, as this offers several advantages, including fast reaction kinetics, low cost, nonflammability, and high conductivity. Remarkable progress has been made with regards to aqueous RFBs, and they have been commercialized. However, aqueous RFBs suffer from two major problems: limited cell voltage owing to the narrow electrochemical window of water (1.23 V) and low energy density (20-50 Wh/L). In contrast, nonaqueous RFBs (NRFBs) exhibit a wider electrochemical window (up to 6 V) and potentially higher energy density. Moreover, the fact that one can employ widely available solvents and supporting electrolytes allows for the use of a range of redox-active compounds. However, the development of NRFBs has been hindered by the limited availability of critically important ion-selective membranes, the low ionic conductivity of nonaqueous electrolytes, and the high costs of these materials. Specifically, the limited availability of appropriate ion-selective membranes and their high cost (approaching 40% of the total battery cost) are the key challenges. To address these limitations, inexpensive size-exclusive separators have been used in NRFBs as alternatives to ion-selective membranes. These porous-separator-based batteries can exhibit high current densities; however, this strategy has several downsides, including low rates of active material utilization, low Coulombic efficiency, and self-discharging.

Thus, several membrane-free batteries have been proposed and developed. Initially, classical fluid dynamics engineering based on the laminar flow of electrolytes through parallel microchannels was exploited to develop membrane-free batteries. However, these microfluidic batteries can only be realized at the microscale and thus are not suitable for large-scale energy storage. Recently, immiscible-electrolyte-based liquid-liquid biphasic systems have received significant attention for the construction of membrane-free batteries. The liquid-liquid interface of these biphasic systems separates the catholyte and anolyte and functions as a natural barrier, thus eliminating the need for a membrane. Unlike the case for laminar-flow batteries, the biphasic membrane-free approach allows for the design of flow batteries with higher power and capacity. Recently, several aqueous biphasic systems (ABSs) (aqueous/nonaqueous phases) were reported by us as well as other research groups. However, most of the reported membrane-free ABSs were investigated under static conditions and showed limited scalability. Membrane-free batteries have rarely been investigated under actual flow conditions because of the convective-mass-transport-induced disturbances at the liquid-liquid interface under flow conditions, which results in self-discharging and active material crossover. Moreover, ABS batteries typically show low energy density owing to their limited cell voltage. Therefore, membrane-free batteries based on nonaqueous electrolytes have been developed to increase the energy density. However, the development of flow batteries based on a nonaqueous biphasic system (NBS) has been significantly hindered by the lack of immiscible organic solvents and redox-active materials that exhibit suitable solubilities in each phase to prevent active material crossover in the self-stratified biphasic system. Liu et al. demonstrated a static membrane-free battery-based all-organic NBS using Li metal in nonafluoro-1,1,2,2-tetrahydrohexyl-trimethoxysilane (NFTOS) as the anolyte and 2-ethylanthraquinone (2-EAQ) and benzo[1,2-b:4,5-b′]dithiophene-4,8-dione (BDTD) tetraethylene glycol dimethyl ether paired together as the catholyte. Both catholyte materials (i.e., 2-EAQ and BDTD) exhibit low solubilities in the anolyte (NFTOS), thus allowing for the study of the charge/discharge cycling characteristics. However, this battery suffers from (1) low charge/discharge current density (50 μA/cm), (2) relatively low nominal cell voltage (~2.2 V) for both cathodic materials, and (3) a lack of information regarding its capacity retention rate and cycling characteristics under flow conditions. Hence, there is an urgent need to develop membrane-free batteries that use flowable nonaqueous electrolytes with high voltage and energy density.

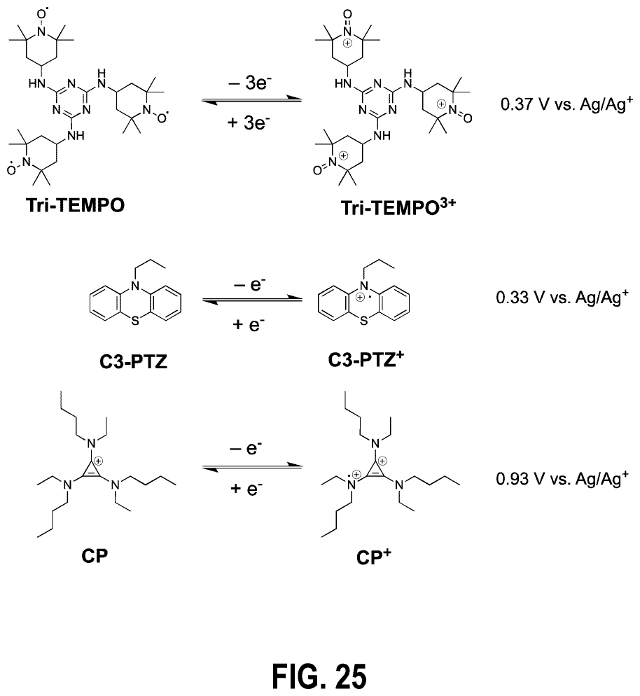

In this work, we report an all-nonaqueous biphasic membrane-free battery that shows high voltage and energy density under both static and flow conditions. The NBS-based battery employs Li metal in an ionic liquid (IL) as the anolyte (top phase) and a set of metal-free organic compounds (FIG. 25) (TEMPO derivative Tri-TEMPO, phenothiazine derivative C3-PTZ, or cyclopropenium derivative CP) in fluoroethylene carbonate (FEC) as the catholyte (bottom phase). The Li|Tri-TEMPO, Li|C3-PTZ, and Li|CP biphasic batteries exhibited theoretical cell voltages of 3.53, 3.49, and 4.09 V, respectively. The developed biphasic system was investigated under both static and flow conditions using the catholyte in different concentrations (0.1, 0.2, and 0.5 M). The static Li|Tri-TEMPO, Li|C3-PTZ, and Li|CP batteries with 0.5 M catholyte displayed capacity retention rates of 98%, 98%, and 92% respectively, after 100 cycles over ~55 days. Moreover, under flow conditions, the prolonged cycling of the 0.5 M Li|Tri-TEMPO battery resulted in a capacity retention rate of 81% after 100 cycles over ~45 days, with the Coulombic efficiency (CE), voltage efficiency (VE), and energy efficiency (EE) being 96%, 85%, and 82%, respectively. Pre- and post-cycling battery analysis confirmed the absence of crossover of the active materials. Thus, this study reports significant advances in biphasic systems for use in membrane-free batteries that show both high voltage and energy density.

Results and Discussion. Developing an all-organic NBS with suitable catholyte and anolyte materials is highly challenging owing to the interplay between the solubility of the active material and its crossover. Li metal was selected as the anode material because of its high energy density and theoretical capacity (~3,860 mAh/g) and low electrochemical potential (−3.04 V vs. SHE). On the other hand, graphite felt (GF) was selected as the cathode material because of its high specific surface area, highly porous structure, high electrical conductivity, and chemical inertness in nonaqueous electrolytes. The unique structure of GF and the presence of a large number of surface catalytic sites result in fast redox-reaction kinetics and hence improved battery performance. The successful fabrication of an NBS for high-performance membrane-free LRFBs requires that (1) the two nonaqueous electrolytes must be immiscible, show high ionic conductivities, and a wide electrochemical stability window and (2) the redox-active cathode material should have high solubility in the catholyte and extremely low solubility in the anolyte in both the charging and discharging states to prevent the self-discharging of the battery because of crossover. Both requirements are discussed below.

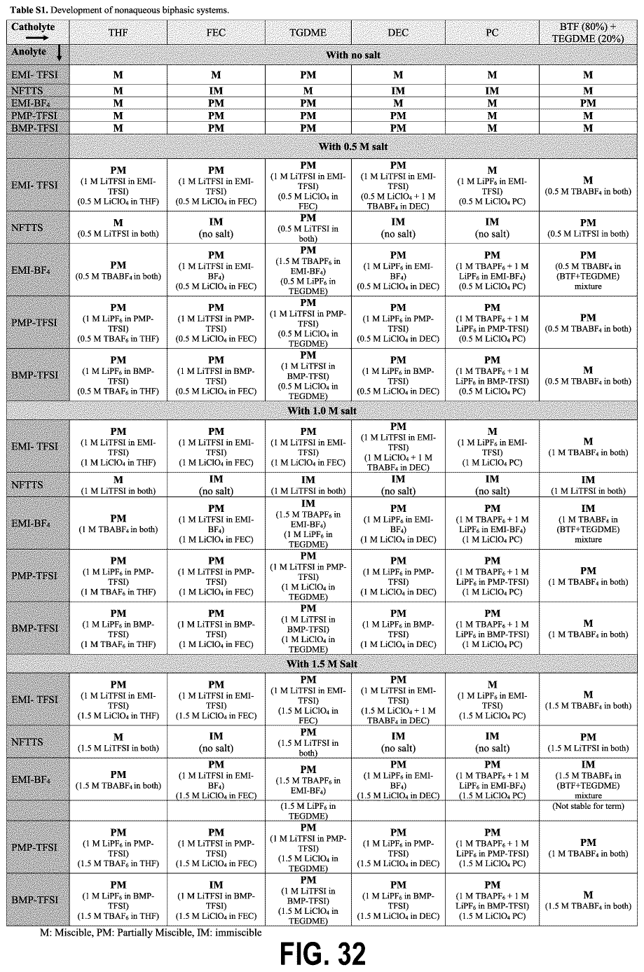

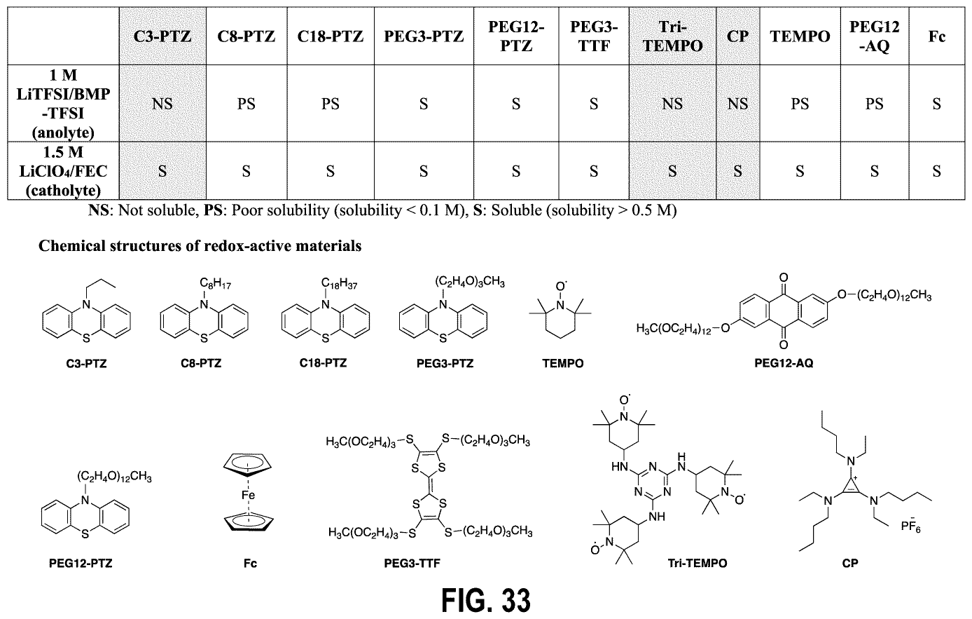

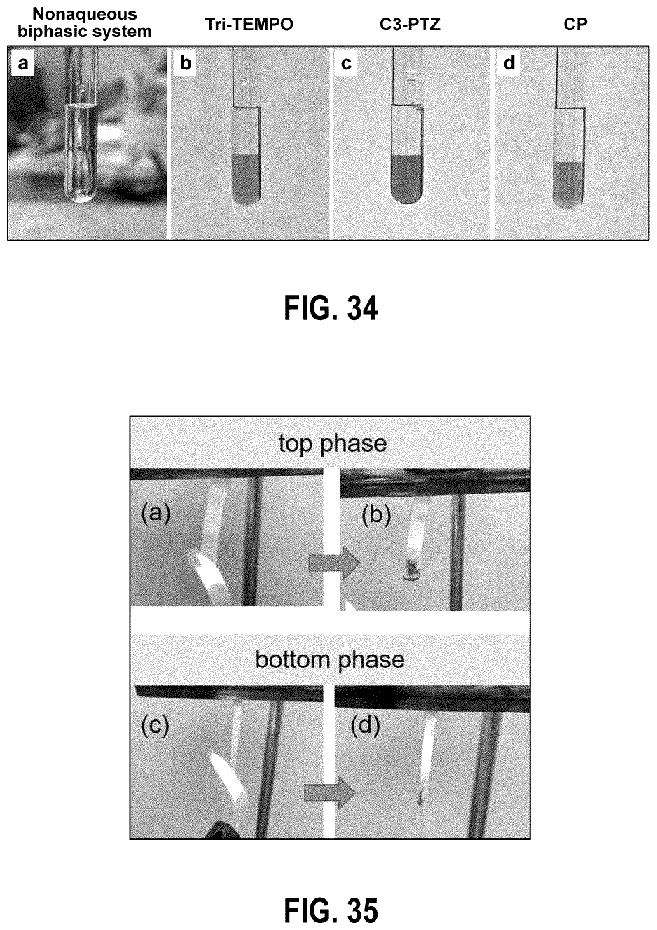

To explore electrolytes with the above-mentioned properties, eleven nonaqueous solvents (including four ILs and seven nonionic organic solvents) were screened to construct the NBS (FIG. 32). ILs have been explored widely for use in Li-ion batteries as compatible anolytes for Li metal, as they not only allow for a wider electrochemical window (−6 V) but also suppress the growth of Li dendrites during longer battery operations34-36. Here, four ILs, namely, ethyl-3-methylimidazolium bis(trifluoromethylsulfonyl)imide (EMI-TFSI), N-propyl-N-methylpyrrolidinium bis(trifluoromethanesulfonyl)imide (PMP-TFSI), 1-ethyl-3-methyl imidazolium tetrafluoroborate (EMI-BF4), and 1-butyl-1-methylpyrrolidinium bis(trifluoromethylsulfonyl)imide (BMP-TFSI), along with nonafluoro-1,1,2,2-tetrahydrohexyl-trimethoxysilane (NFTTS) were selected as the anolyte solvents, and six organic solvents, namely, tetrahydrofuran (THF), tetraethylene glycol dimethyl ether (TEGDME), fluoroethylene carbonate (FEC), diethylene carbonate (DEC), propylene carbonate (PC), and benzotrifluoride (BTF), were explored for use as the catholyte. A few pairs of the anolyte and catholyte solvents were intrinsically immiscible in their neat forms (FIG. 32). The other electrolytes that were either miscible or partially immiscible in their neat forms could be rendered immiscible using salt-out strategies (FIG. 32). The most effective salt-out strategy involves the use of salts that have high solubility in one organic phase and low (or no) solubility in the another organic phase to facilitate the formation of a biphasic system. To screen the electrolyte salts with the above mentioned properties, five salts, namely, lithium bis(trifluoromethanesulfonyl)imide (LiTFSI), lithium perchlorate (LiClO₄), tetrabutylammonium hexafluorophosphate (TBAPF₆), tetrabutylammonium tetrafluoroborate (TBABF₄), and lithium hexafluorophosphate (LiPF₆), were selected for solubility analyses. The concentration of various salts was adjusted within the range of 0.5 M to 1.5 M to achieve the separation of two organic solvents, as shown in FIG. 32. However, the selective solubility of organic salts in different solvents resulted in only a few pairs forming a stable biphasic system, while others remained miscible or partially miscible. Following the analyses, three NBSs were formed: FEC (1.5 M LiClO₄)/BMP-TFSI (1 M LiTFSI), TEGDME/NFTTS with 1 M LiTFSI, and BTF-TEGDME/EM I-BF₄ with 1 M TBABF₄. Since both phases of the NBS should have the same exchange ions to facilitate the charging/discharging of the membrane-free battery, Li⁺ ions were used as the exchange ions for FEC/BMP-TFSI and TEGDME/NFTTS biphasic systems and BF₄⁻ ions for BTF-TEGDME/EM I-BF₄ biphasic. Of the three NBSs, FEC/BMP-TFSI (FIG. 34(a)) was selected for the subsequent electrochemical analyses and battery performance studies due to following reasons. The high solubilizing ability of FEC solvent (bottom phase) allowed catholytes (FIG. 33) with different redox potentials to be evaluated. Plus, FEC exhibits higher ionic conductivity compared with those of BTF and NFTTS. Meanwhile, BMP-TFSI solvent (top phase) facilitates superior compatibility as anolyte electrolyte for Li metal anode. Additionally, the organic solvents utilized in this study as the anolyte and catholyte solvents possess high flash points of approximately 210° C. and 115° C., respectively. For clarification, we have conducted an ignition test on both the top (BMP-TFSI/LiTFSI) and bottom (FEC/LiClO₄) phases of the biphasic system. As illustrated in FIG. 35, both phases were determined to have high flame resistance.

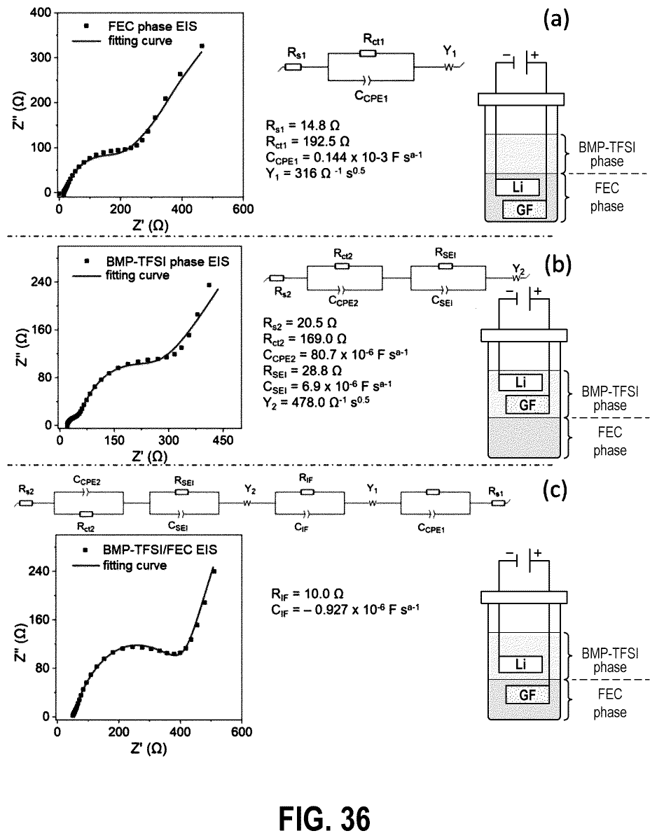

Moreover, to investigate the ion transport kinetics in different phases as well as at the liquid-liquid interface, we performed the electrochemical impedance spectroscopy for the FEC electrolyte, BMP-TFSI electrolyte, and the BMP-TFSI/FEC (liquid/liquid) system, which included the liquid/liquid interface. The equivalent circuit of BMP-TFSI/FEC system is composed of bulk impedance (solution and wire), FEC capacitance, BMP-TFSI capacitance (including SEI layer) and liquid-liquid interface resistance, and diffusion impedance. By separately measuring the impedance of the FEC and the BMP-TFSI electrolytes (FIGS. 36(a) and 36(b)), and fixing the main parameters of these two parts during the fitting process, the liquid-liquid interface impedance was calculated to be approximately 10.0 LI (FIG. 36(c)). It should be noted that a negative CIF capacitance was obtained, as observed in other similar systems, presumably due to the delayed-current phenomenon. However, compared to Ret of over 100 LI, an interfacial impedance of 10.0 LI is not considered to be a limiting factor.

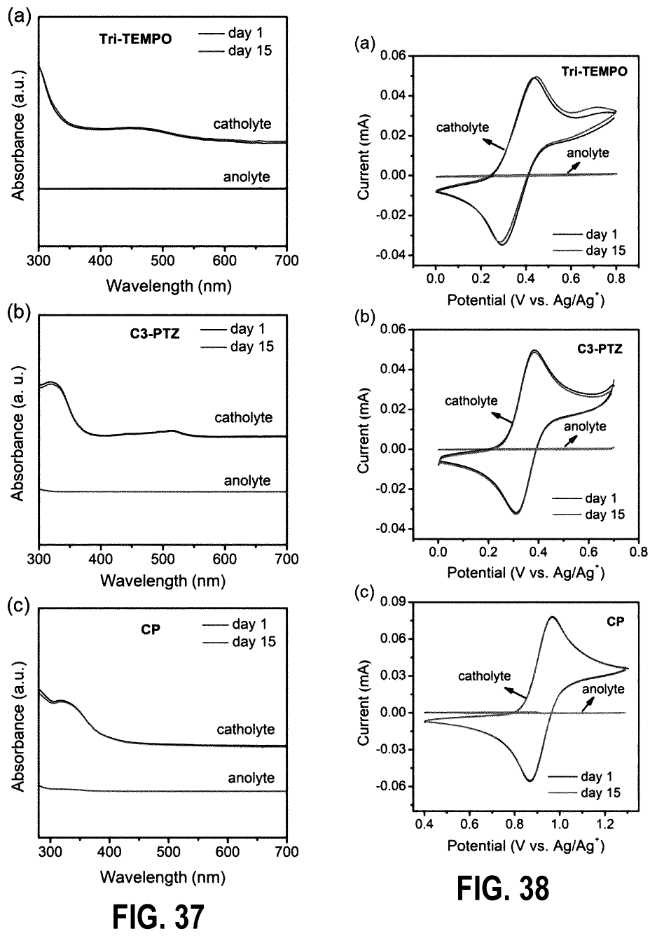

A catholyte with high solubility with respect to the anolyte solvent would ensure high energy density while one with low (ideally zero) solubility would prevent crossover. To explore catholyte materials that meet these solubility requirements, eleven organic compounds were selected, and their solubilities in both phases of the NBS were tested. These materials included derivatives of phenothiazine, cyclopropenium 2,2,6,6-tetramethylpiperidinyloxy (TEMPO), anthraquinone (AQ), and ferrocene (FIG. 33). Among the catholyte materials, Tri-TEMPO, C3-PTZ, and CP showed high solubilities in FEC and extremely poor affinity towards the anolyte (FIG. 34). The solubilities of Tri-TEMPO, C3-PTZ, and CP in 1.5 M FEC/LiClO₄ were ~1.2 M, ~1 M, and 1.8 M, respectively. Negligible crossover occurred under static conditions over 15 days, as confirmed by ultraviolet (UV)-visible spectroscopy (FIG. 37) and cyclic voltammetry (CV) (FIG. 38). Hence, Tri-TEMPO, C3-PTZ, and CP were selected as the cathode materials for the subsequent experiments.

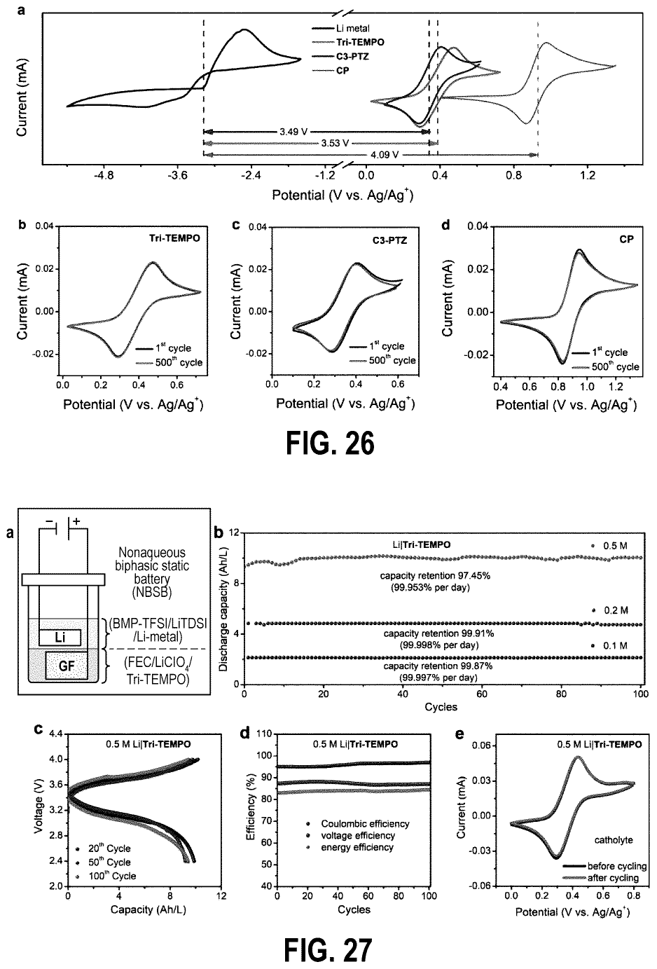

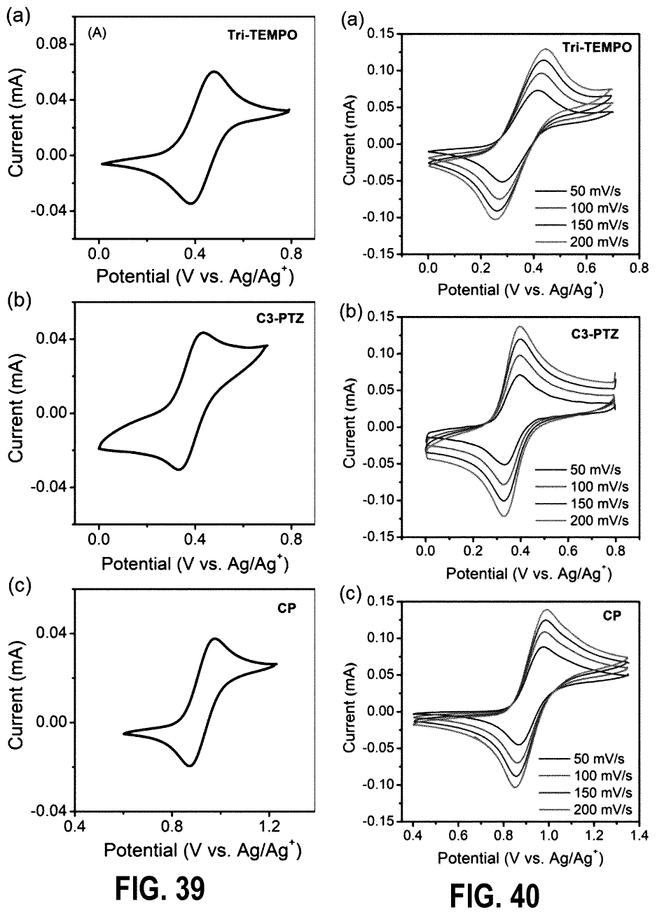

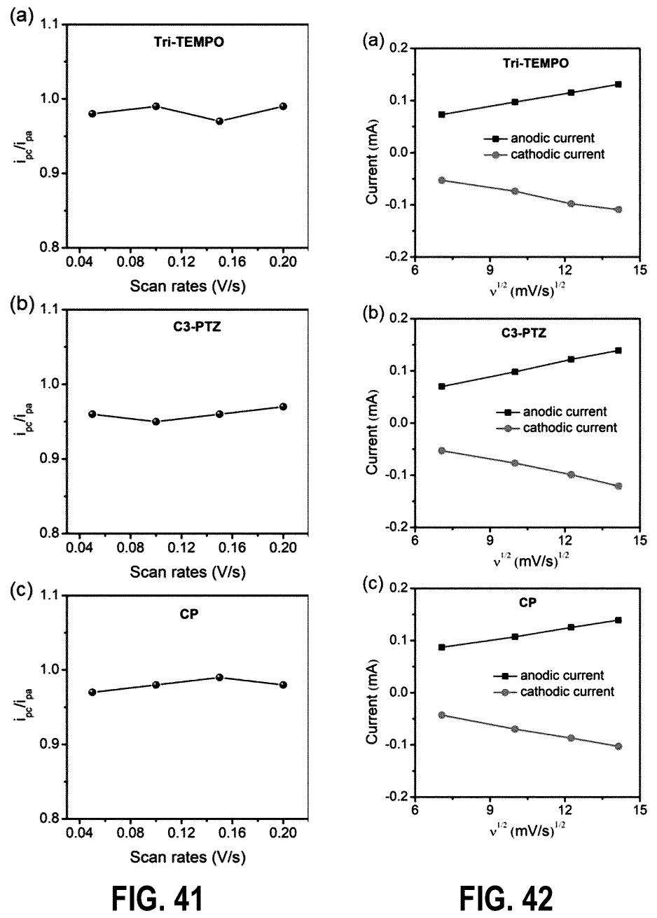

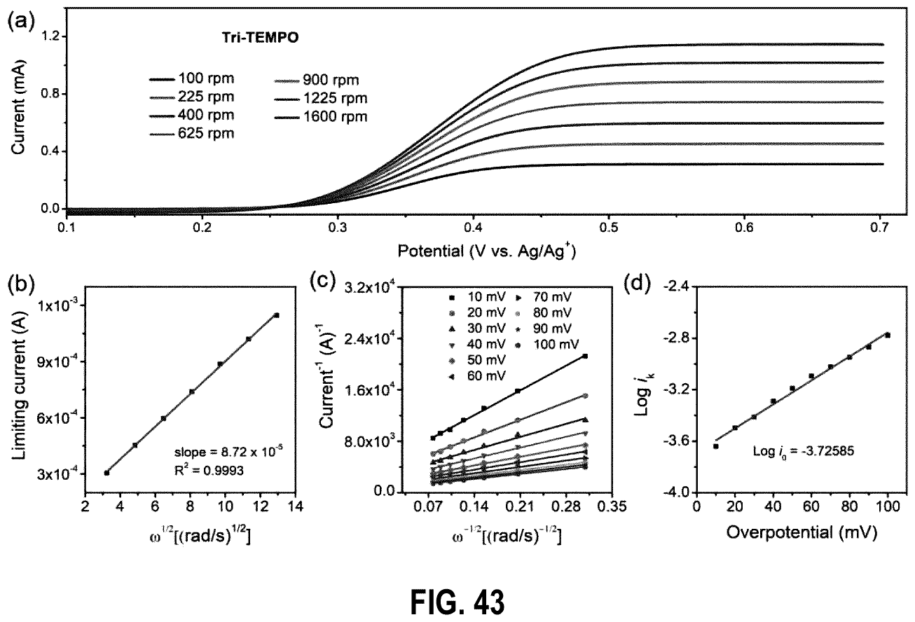

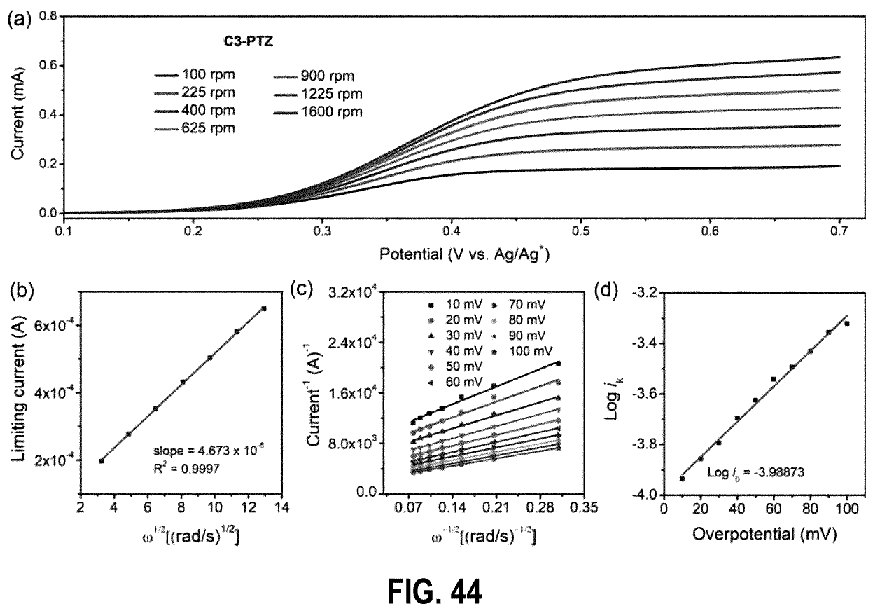

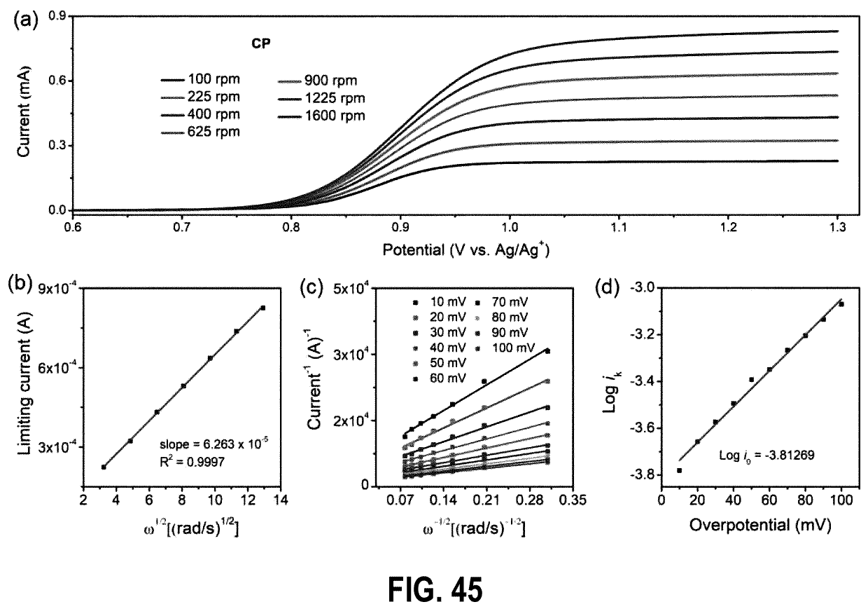

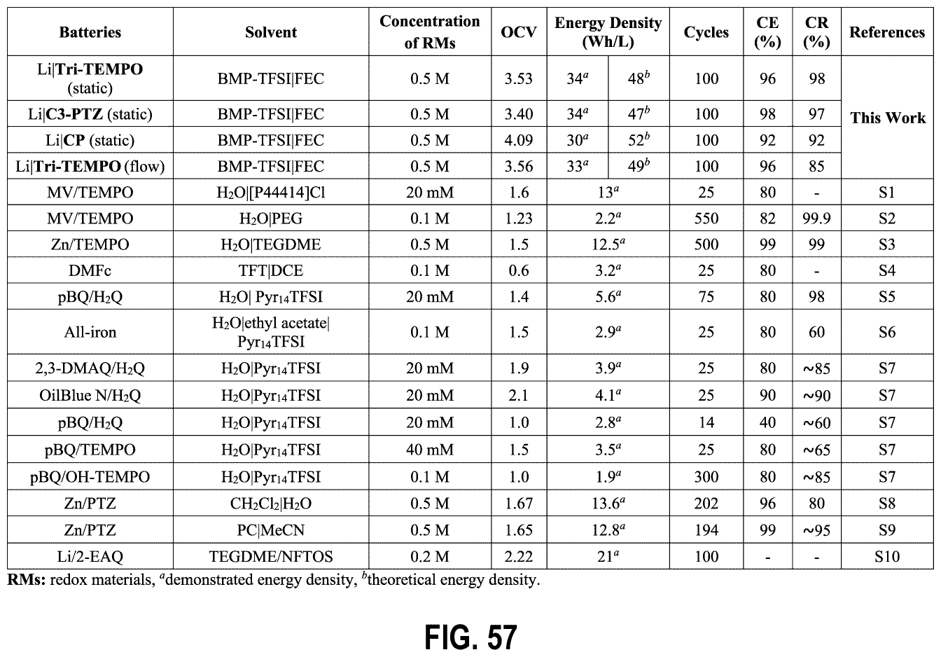

Electrochemical characteristics. CV was performed to determine the electrochemical compatibility of the Li metal anode in the ILs as well as the reversibility of the redox-active cathode materials (Tri-TEMPO, C3-PTZ, and CP) in FEC. Tri-TEMPO, C3-PTZ, and CP exhibit a reversible redox couple at 0.37, 0.33, and 0.93 V vs. Ag/Ag⁺ in 0.1 M LiClO₄/FEC (FIG. 26(a)). The pairs of the Li-metal anode and the three cathode materials (i.e., Li/Tri-TEMPO, Li/C3-PTZ, and Li/CP) exhibited theoretical cell voltages of 3.53, 3.49, and 4.09 V, respectively; these are significantly higher than those of previously reported biphasic membrane-free batteries (FIG. 57). The peak potential separations of Tri-TEMPO, C3-PTZ, and CP at a scan rate of 5 mV/s were ~74, ~69, and ~76 mV, respectively (FIG. 39) and indicative of a one-electron redox process as per the Nernst equation. Next, CV measurements were performed at scan rates of 50-200 mV/s (FIG. 40) to study the electrochemical kinetics of the catholyte compounds. The ratios of the cathodic peak current (i_{pc}) and anodic peak current (iₚₐ) for Tri-TEMPO, C3-PTZ, and CP at the investigated scan rates (50-200 mV/s) were close to 1 (FIG. 41), suggesting that the compounds exhibited excellent electrochemical reversibility in FEC. Further, the peak currents (anodic and cathodic) exhibit a linear relationship with the square root of the scan rate (v^{1/2}) for all three cathode materials (FIG. 42), indicating that the redox process is diffusion-controlled. Additionally, linear sweep voltammetry (LSV) was also performed using the rotating disk electrode (RDE) experiments (FIGS. 43-45) to study the electrochemical kinetics of redox molecules used in this work. The Koutecky-Levich curves (Equation 1) were used to measure the diffusion coefficients (D) of the redox materials at varying rotating rates.

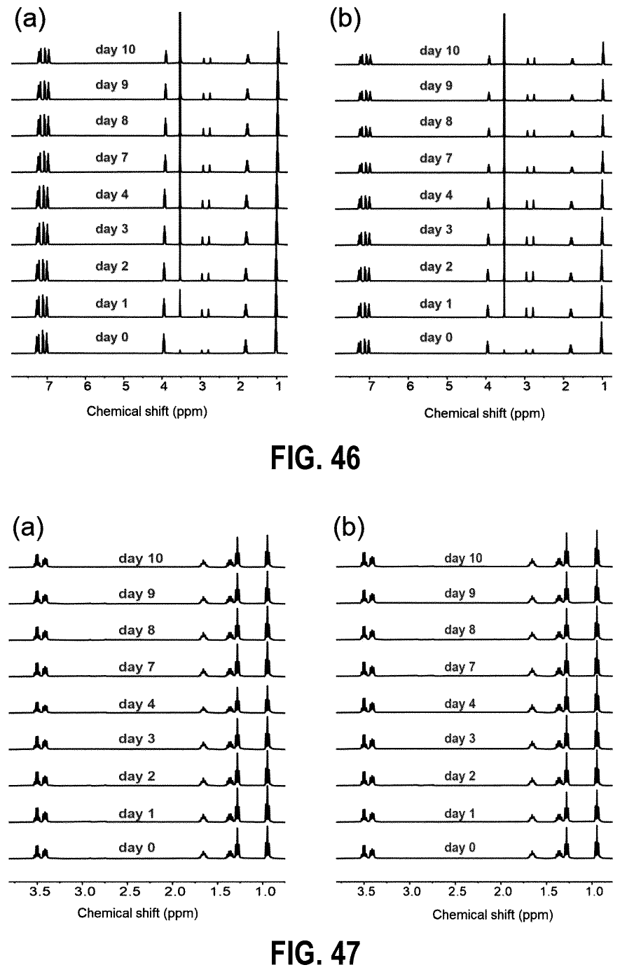

The diffusion coefficients of Tri-TEMPO, C3-PTZ, and CP are in the range of 10⁻⁶-10⁻⁵ cm² s⁻¹. Furthermore, the kinetic rate constants (k₀) of all three redox compounds were determined by fitting the Butler-Volmer equation (Equation 2) and were found to be in the range of 10⁻⁴-10⁻² cm s⁻¹. Notably, the diffusion coefficients and rate constants of these compounds are comparable to those of certain redox-active organic materials employed in aqueous flow batteries. The fast electrode kinetics of Tri-TEMPO, C3-PTZ, and CP are anticipated to result in low activation polarization loss, which is beneficial for flow battery applications. The electrochemical and chemical stability of organic redox materials were evaluated using CV and proton nuclear magnetic resonance (¹H NMR) spectroscopy. The CV cycling results showed superior electrochemical stability, as evidenced by the nearly superimposable voltammograms (FIG. 26(b)(c)(d)). Additionally, the ¹H NMR spectra of C3-PTZ and CP demonstrated superior thermostability over 10 days at 25° C. and 60° C. (FIGS. 46 and 47).

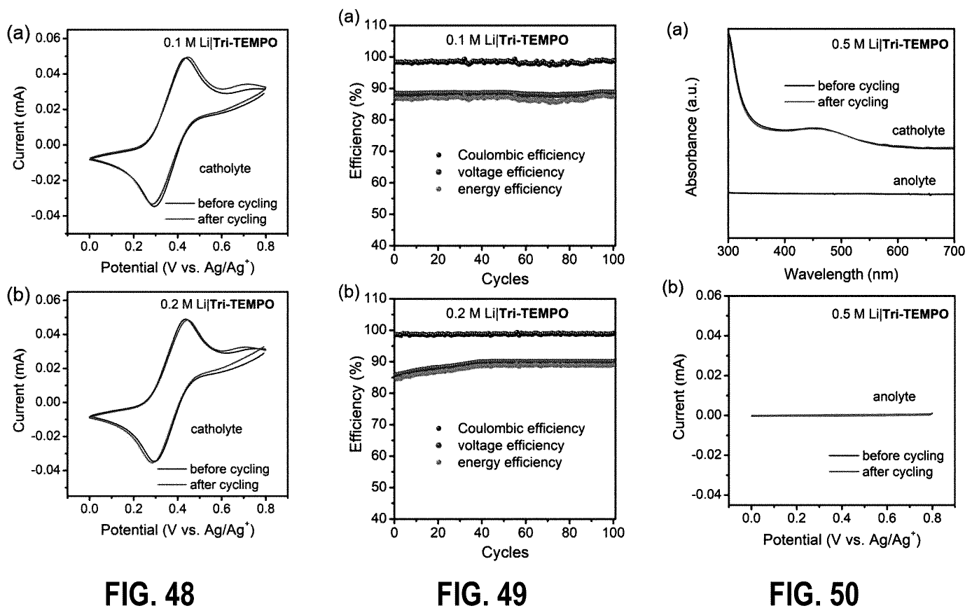

Chare/discharge performance of biphasic membrane-free batteries. Under static conditions: The viability of the developed biphasic system as a membrane-free battery was initially evaluated under static conditions (FIG. 27(a)). As a starting point, two nonaqueous biphasic static batteries (NBSBs) were assembled by pairing a Li-metal anode with 0.1 or 0.2 M Tri-TEMPO, and the batteries were subjected to charging/discharging for 100 cycles (~13 days for 0.1 M Tri-TEMPO and ~22 days for 0.2 M Tri-TEMPO) at a current density of 1 mA/cm². While the current density could be increased further, the operational current density was significantly higher than that reported previously for aqueous and nonaqueous biphasic membrane-free systems. The 0.1 M and 0.2 M Li|Tri-TEMPO NBSBs (FIG. 27(b)) both showed excellent cycling performances, exhibiting capacity retention rates of 99.87% (99.998% per cycle, 99.997% per day) and 99.91% (99.998% per cycle, 99.998% per day), respectively. This confirmed that the redox-active materials, supporting electrolytes, and solvent exhibited high stability under actual battery operation conditions. Moreover, both NBSBs exhibited high CE (over 99% for both) and EE values (86% for 0.1 M and 84% for 0.2 M). A CE value as high as ~99% suggests extremely low self-discharging and thus negligible active material crossover. Moreover, there was no obvious change in the peak current densities of the 0.1 M and 0.2 M Li|Tri-TEMPO catholytes (FIG. 48) post cycling, which further confirmed that the Tri-TEMPO redox molecules remained confined within the catholyte (FEC phase) during the prolonged cycling process. Based on these results, we built an NBSB containing the catholyte in a higher concentration. Specifically, a 0.5 M Li|Tri-TEMPO NBSB was assembled and subjected to long-term charging/discharging (100 cycles, ~55 days), as shown in FIG. 27(b). The 0.5 M Li|Tri-TEMPO battery exhibited a capacity retention rate of 97.5% (99.97% per cycle, 99.95% per day). Its cycling profile suggests a discharging voltage of 3.48 V with no significant change in the overpotential over the course of the cycling process (FIG. 27(c)). The 0.5 M Li|Tri-TEMPO NBSB exhibited CE, VE, and EE values of 96%, 87%, and 83% (FIG. 27(d)), respectively, which are significantly higher than those of previously reported membrane-free systems (FIG. 57). However, these values were slightly lower than those of the 0.1 M and 0.2 M NBSBs (FIG. 49). The Coulombic efficiency of a high concentration battery did not change with higher current density. Even though faster charging/discharging rates typically increase Coulombic efficiency, parasitic reactions could also occur at higher current density as a tradeoff. Moreover, a higher catholyte concentration would mean a relatively high flow resistance, resulting in lower ionic conductivity and greater transport losses and consequently a lower VE value. However, the 0.5 M Tri-TEMPO NBSB had a discharge volumetric energy density of 34 Wh/L which is significantly higher than those of most state-of-the-art biphasic membrane-free static and flow batteries (FIG. 57). The electrolytes were analyzed both before and after cycling using UV-visible spectroscopy (FIG. 50(a)) and CV (FIG. 27(e) and FIG. 50(b)). The analyses indicated that Tri-TEMPO was not present in the post-cycling anolyte. Hence, the high cycling stability of the Li|Tri-TEMPO biphasic static batteries with different Tri-TEMPO concentrations (0.1, 0.2, and 0.5 M) suggested that they are highly suited for practical use. It also confirmed the high compatibility of Li metal with the anolyte and that of GF with the catholyte.

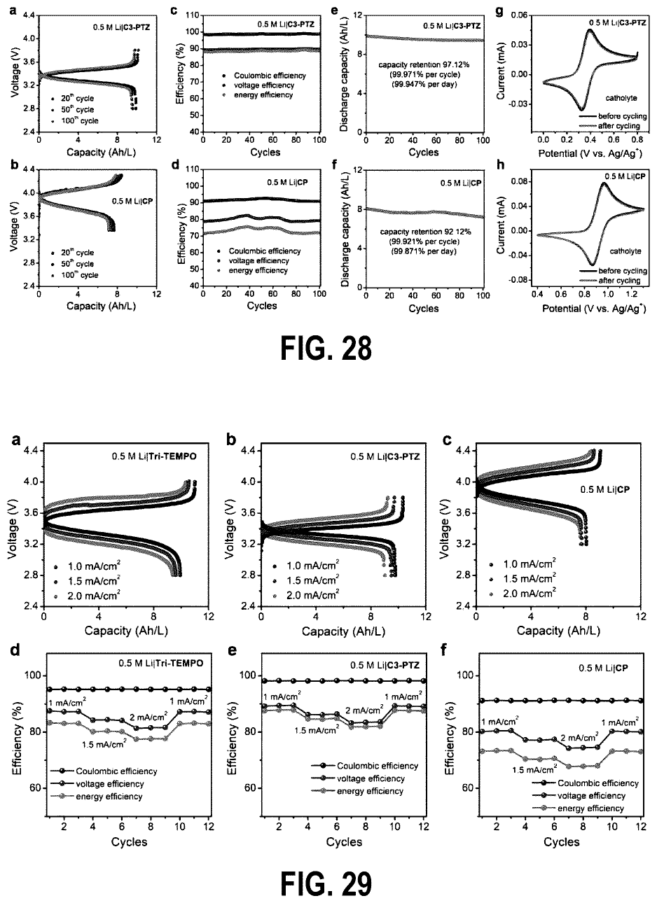

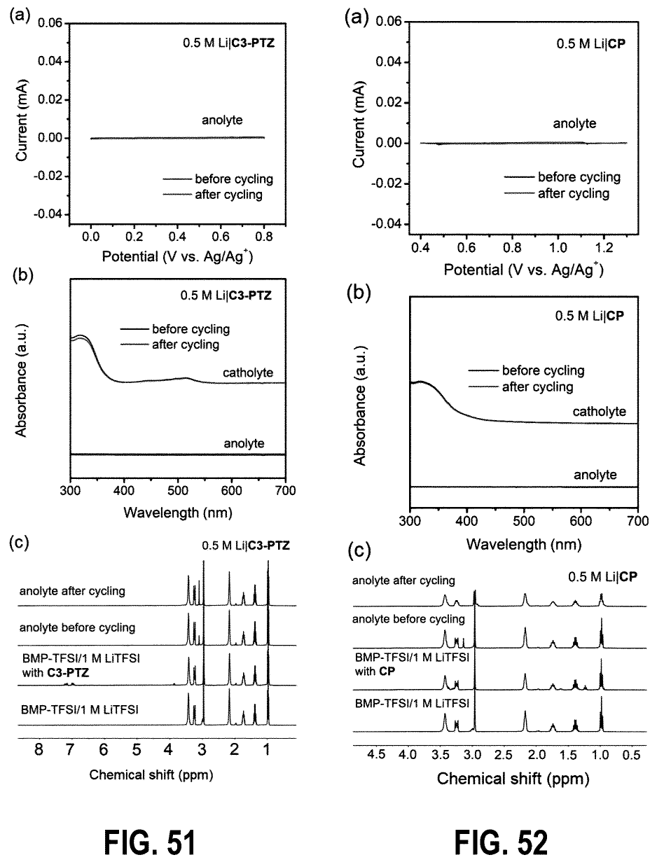

To evaluate the versatility of the developed NBS, the other two selected catholyte materials (C3-PTZ and CP) were studied under the same conditions as those used for the Li|Tri-TEMPO battery (FIG. 28). The long-term performances of both NBSBs were investigated through extended charging/discharging tests performed at 1 mA/cm² for 100 cycles. The 0.5 M Li|C3-PTZ battery was charged/discharged within the voltage range of 2.8-3.8 V (FIG. 28(a)), whereas the 0.5 M Li|CP battery was cycled in the 3.3-4.3 V range (FIG. 28(b)). The 0.5 M Li|C3-PTZ and 0.5 M Li|CP NBSBs exhibited distinct stable plateaus and discharging voltages of 3.42 and 3.94 V, respectively, which are significantly higher than those reported for most aqueous and nonaqueous membrane-free flow battery systems (FIG. 57). The 0.5 M Li|C3-PTZ (FIG. 28(c)) battery also showed stable CE, VE, and EE values of 98%, 90%, and 88%, respectively, throughout the cycling process, whereas the 0.5 M Li|CP (FIG. 28(d)) battery exhibited CE, VE, and EE values of 91%, 79%, and 72% respectively. That the CE values of both batteries were greater than 90% indicated that negligible self-discharging had occurred in the batteries Furthermore, the 0.5 M Li|C3-PTZ (FIG. 28(e)) and 0.5 M Li|CP (FIG. 28(f)) batteries showed excellent cycling stability, with their capacity retention rates being 97.12% (99.971% per cycle, 99.949 per day) and 92.12% (99.921 per cycle, 99.856 per day), respectively. The electrolytes of the 0.5 M Li|C3-PTZ (FIGS. 28(g) and 51) and 0.5 M Li|CP (FIGS. 28(h) and 52) batteries were subjected to CV measurements, UV-visible spectroscopy, and proton nuclear magnetic resonance (¹H NMR) spectroscopy both before and after cycling. The quantitative CV analysis of the catholytes and anolytes of the 0.5 M Li|C3-PTZ (FIGS. 28(g) and 51(a)) and 0.5 M Li|CP (FIGS. 4(h) and 52(a)) batteries did not indicate significant changes in their current densities even after 100 charge/discharge cycles. Moreover, the post-cycling UV-visible spectra of the 0.5 M Li|C3-PTZ and 0.5 M Li|CP anolytes confirmed the absence of crossover (FIGS. 51(b) and 52(b)). Finally, the NMR spectra of the pre- and post-cycled anolytes of both batteries (FIGS. 51(c) and 52(c)) were nearly identical, which confirmed that C3-PTZ and CP remained in the catholyte phases and did not cross over.

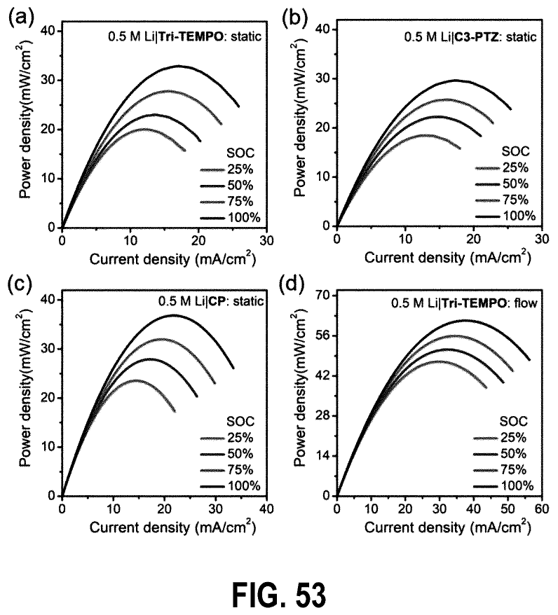

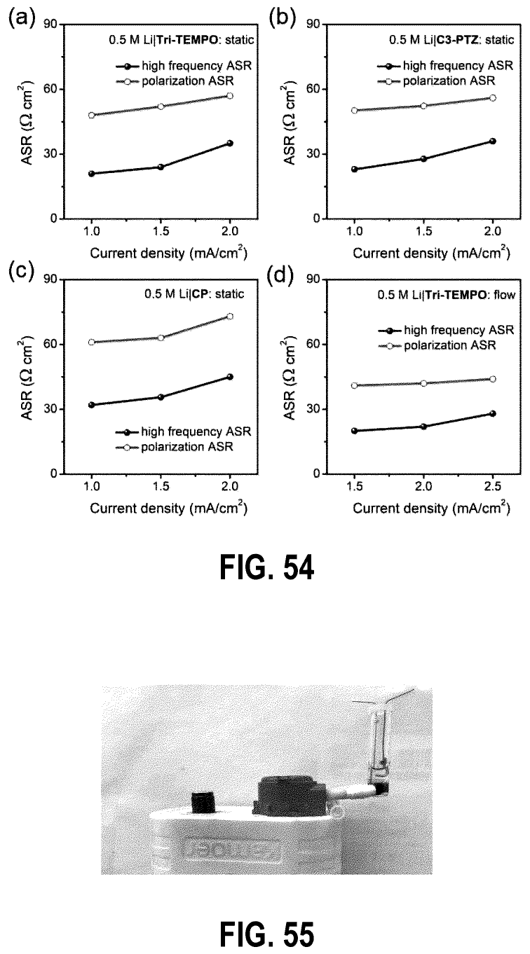

To elucidate the effect of the high current density of the NBSBs on their performance, the charge/discharge behaviors of the 0.5 M Li|Tri-TEMPO, 0.5 M Li|C3-PTZ, and 0.5 M Li|CP batteries were studied at current densities of 1, 1.5, and 2 mA/cm², and their average CE, VE, and EE values were measured for 3 cycles. The 0.5 M Li|Tri-TEMPO (FIG. 29(a)), 0.5 M Li|C3-PTZ (FIG. 29(b)), and 0.5 M Li|CP (FIG. 29(c)) NBSBs exhibited ohmic drops of ~80, ~50, and ~60 mV, respectively, at 1.5 mA/cm² and ~130, ~98, and ~110 mV, respectively, at 2 mA/cm². The increase in the ohmic loss at the higher current density can be ascribed to limitations related to mass diffusion. The Li|Tri-TEMPO (FIG. 29(d)), Li|C3-PTZ (FIG. 29(e)), and Li|CP (FIG. 29(f)) batteries showed CE values of 96%, 98%, and 92%, respectively, at all the operating current densities, indicating that fast charging/discharging did not induce noticeable side reactions. However, the EE values of the Li|Tri-TEMPO, Li|C3-PTZ, and Li|CP batteries were reduced from 83%, 88%, and 72%, respectively, to 78%, 80%, and 70%, respectively, when the applied current density was increased from 1 to 2 mA/cm². This was owing to an increase in the overpotential because of mass transport losses. It should be noted that all three batteries regained their original efficiencies when they were cycled back at 1 mA/cm², thus confirming their superior charge-rate performance. In addition to this, the polarization for the 0.5 M Li|Tri-TEMPO, C3-PTZ, and CP batteries under static conditions was also investigated at different states of charge (SOC). The peak power densities of the 0.5 M Li|Tri-TEMPO, C3-PTZ, and CP batteries under static conditions are 33, 30, and 37 mW/cm², respectively, at 100% SOC (FIG. 53). Correspondingly, the area-specific resistance (ASR) data for both the resistance of the electrolyte and the whole battery under static conditions was also studied. The results show that both the ASR of the electrolyte and the whole battery increase as the operating current density increases (FIG. 54). However, the electrolyte resistance accounts for over 50% of the whole battery for all batteries. Additionally, the energy densities of the static 0.5 M Li|Tri-TEMPO, C3-PTZ, and CP batteries were 34, 34, and 30 Wh/L, respectively. These values were found to be 71%, 72%, and 57% of their corresponding theoretical energy densities (FIG. 57).

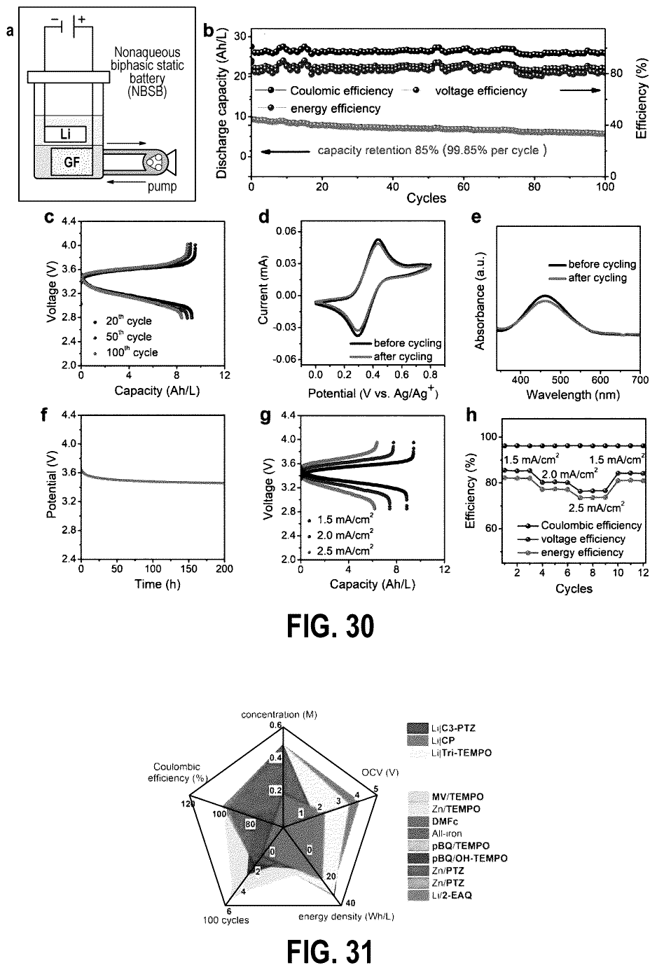

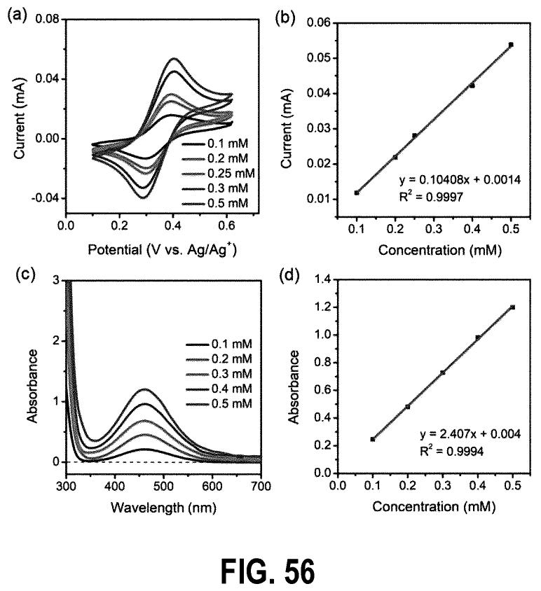

Under flow conditions: While the performances of the batteries under static conditions were compelling, their energy and power were not decoupled. Thus, the capacity of the batteries was not scalable, as is necessary under flow conditions. Hence, a Li-based nonaqueous biphasic flow battery based on 0.5 M Tri-TEMPO was assembled, and its long-term cycling performance was evaluated (FIGS. 30(a) and 55). Under flow conditions (1 mL/min), after 100 charge/discharge cycles, the 0.5 M Li|Tri-TEMPO battery showed a capacity retention rate of 81.12% (99.811 per cycle, 99.581 per day) along with a CE of ~96%, VE of ~85%, and EE of ~82% (FIGS. 30(b), (c)). To elucidate the mechanism responsible for its capacity fading, its electrolytes were analyzed both before and after cycling using CV (FIG. 30(d)) and UV-visible spectroscopy (FIG. 30(e)). The reduction in the CV peak current and absorbance of the post-cycling catholyte were indicative of the slight crossover of the Tri-TEMPO molecules due to the convective diffusion of the flowing catholyte during prolonged battery cycling. Both CV and UV-visible results (FIG. 56) suggested that 93% of total capacity fade is caused by the crossover of Tri-TEMPO. To clarify the effect of the flowing catholyte on the self-discharging of the battery, its open-circuit voltage (OCV) in the fully charged state was monitored over 200 hours (FIG. 30(f)). The OCV of the battery displayed a sharp decrease during the first 10 hours after the charging process owing to ohmic polarization (i_{R} drop), followed by a voltage loss of 0.63 mV/h in the next 190 hours, which corresponded to a total drop of 120 mV over 190 hours. However, the per-hour voltage loss of this battery was smaller than that of previously reported aqueous/nonaqueous biphasic membrane-free batteries. Further, the ASR result for both the resistance of the electrolyte and the whole battery under flow conditions suggests that the electrolyte resistance accounts for over 50% of the whole battery (FIG. 54). However, the ASR of both the electrolyte and the whole battery are significantly reduced under flow conditions for the 0.5 M Li|Tri-TEMPO battery, allowing for higher current and power densities without compromising performance. Hence, the peak power density of the 0.5 M Li|Tri-TEMPO battery under flow conditions was significantly higher at 61 mW/cm² compared to the Tri-TEMPO static battery (FIG. 53). The enhanced peak power density can be attributed to improved mass transport under flow conditions.

The charge-rate performance of the 0.5 M Li|Tri-TEMPO flow battery was evaluated at current densities of 1.5, 2.0, and 2.5 mA/cm², and the corresponding cycling profiles (FIG. 30(g)) as well as the CE, VE, and EE (FIG. 30(h)) values were measured for an average of three cycles. When operated at a current density of 2.5 mA/cm², the battery exhibited a discharge overpotential of 132 mV, which is nearly twice that when it was operated at a current density of 1.5 mA/cm². The increase in the overpotential and the corresponding reduction in the VE at the higher current density can be attributed to mass transport limitations. However, the battery was able to regain its original performance when cycled again at the applied current density of 1.5 mA/cm², suggesting that the biphasic battery showed excellent rate cyclability under flow conditions. Hence, the performance of membrane-free nonaqueous biphasic batteries demonstrated in this study, under both static and flow conditions, is significantly higher than earlier reported work (FIG. 57). A radar chart in FIG. 31 summarizes this work and reported battery performance, including number of cycles, energy density, Coulombic efficiency, and voltage.

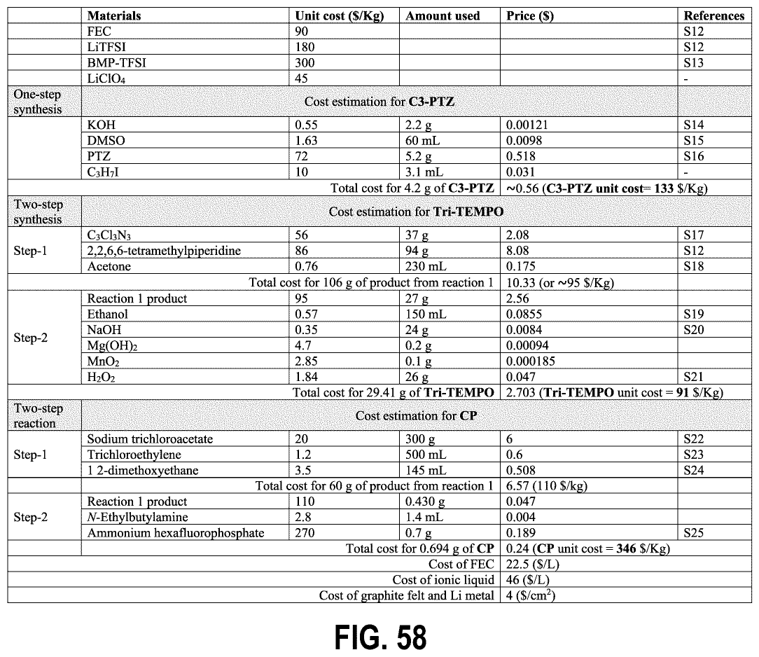

To establish the economic viability of the developed system, FIG. 58 outlines a cost estimation of the battery components and chemicals utilized in this study. The analysis reveals that the developed system is considerably more cost-effective than membrane-based batteries. As a result, the developed system could be highly suitable for deployment as an efficient energy storage system.

In summary, we report a nonaqueous biphasic membrane-free Li-based redox flow battery with high voltage and energy density. A nonaqueous biphasic system was developed using an IL and organic carbonate as the electrolytes based on the salt-out effect. Three redox-active cathode materials, namely, Tri-TEMPO, C3-PTZ, and CP, were selected after analyzing 11 organic redox-active compounds. Initially, the 0.1 M and 0.2 M Li|Tri-TEMPO static biphasic membrane-free batteries were subjected to 100 charge/discharge cycles and showed capacity retention rates of 99.87% and 99.91%, respectively. The 0.1 M and 0.2 M Li|Tri-TEMPO biphasic batteries exhibit energy densities of ~7.2 and 16.6 Wh/L, respectively. To increase the energy density, a 0.5 M Li|Tri-TEMPO membrane-free static battery was assembled and subjected to 100 cycles. It exhibited a capacity retention rate of ~98%, CE of 96%, and energy density of 34 Wh/L. To confirm the versatility of the proposed biphasic system, two more redox-active materials, namely, C3-PTZ and CP, were tested in a membrane-free battery under static conditions. The 0.5 M Li|C3-PTZ and 0.5 M Li|CP biphasic static batteries exhibited discharge voltages of 3.42 and 3.94 V, respectively, which were significantly higher than those of previously reported biphasic membrane-free battery systems. The Li|C3-PTZ and Li|CP biphasic static batteries containing the redox-active materials in a 0.5 M concentration displayed capacity retention rates of 98%, and 92%, respectively, after 100 cycles over ~55 days. Post-cycling analyses indicated that there were no signs of material degradation or crossover even after prolonged battery operation for any of the membrane-free static batteries. This confirmed the versatility of the nonaqueous biphasic system. To ensure the decoupling of the energy and power, the developed membrane-free batteries were also studied under flow conditions. The representative Li|Tri-TEMPO (0.5 M) flow battery exhibited a capacity retention rate of 81% after 100 cycles over ~45 days, with its CE and EE values being 96% and 82%, respectively. The flow biphasic battery displayed higher energy density (33 Wh/L) than those of the earlier reported membrane-free batteries. The peak power densities of the 0.5 M Li|Tri-TEMPO, C3-PTZ, and CP batteries under static conditions are 33, 30, and 37 mW/cm², respectively, at 100% SOC. The peak power density of the 0.5 M Li|Tri-TEMPO battery under flow conditions was significantly higher at 61 mW/cm² compared to the Tri-TEMPO static battery. In future work, several strategies can be implemented to improve the system's kinetics and overall performance, including: (1) optimizing the flow rates within the battery to enhance mass transfer kinetics; (2) selecting suitable supporting electrolyte (salt) that can improve the electrolyte's conductivity to regulate the overall battery kinetics, (3) implementing an advanced cell design for both static and flow conditions to reduce the dead volume of the cathode electrode, so as to improve capacity utilization, and (4) mitigating crossover of cathode materials from catholyte to anolyte at the liquid/liquid interface under flow conditions to further improve Coulombic efficiency. The high voltage, long cycling lifespan, and easy fabrication process of the proposed membrane-free battery makes it highly suited for use as a sustainable EES system. This study is a significant advance in the development of biphasic systems for membrane-free batteries that show both high voltage and high energy density under static as well as flow conditions.

Materials. Lithium hexafluorophosphate (LiPF₆, 99.99%) was purchased from Sigma Aldrich. The ILs used, namely, EMI-TFSI, PMP-TFSI, EMI-BF₄, and BMP-TFSI, were purchased from TCI Chemicals. Lithium perchlorate (LiClO₄, 98%), LiTFSI (99.94%), FEC, DEC, PC, NFTTS, BTF, THF, and TEGDME were purchased from Fisher Scientific and used without further purification. TBAPF₆ was recrystallized in anhydrous ethanol and dried under vacuum at 60° C. for 24 h. The other compounds used in this study, such as Tri-TEMPO, C3-P TZ, CP, C8-PTZ, C18-PTZ, PEG3-PTZ, PEG12-PTZ, PEG3-TTF, and PEG12-AQ were prepared as per the reported procedures.

Characterization. The UV-visible absorption spectra were recorded using a UV-visible spectrophotometer (Cary 8454 UV-Vis, Agilent Technologies). The CV measurements were performed using a Bio-Logic potentiostat. The charge/discharge performances were evaluated using Land and Bio-Logic potentiostats. ¹H NMR spectra were recorded on a Bruker AV400 spectrometer (400 MHz). Chemical shifts are reported in ppm.

Electrochemical characterizations. CV measurements were performed to evaluate the electrochemical properties of the redox-active materials (Tri-TEMPO, C3-PTZ, and CP) as well as the crossover of the redox-active materials before and after long-term battery cycling. For the CV measurements, 5 mM of Tri-TEMPO, C3-PTZ, and CP solutions were prepared in 0.1 M FEC/LiClO₄ electrolyte. A 3-mm glassy carbon disk was used as the working electrode and was polished with 5 nm Al₂O₃ before the measurements. A piece of Pt wire (0.5 mm) was used as the counter electrode while a Ag/Ag⁺ electrode was used as the reference electrode.

Calculation of diffusion coefficient and electron transfer rate. Linear sweep voltammetry (LSV) studies were carried out using a Pine modulated speed rotator with Biologic potentiostats. Rotating disk electrode (RDE, diameter: 5 mm), Pt wire electrode and Ag/Ag⁺ electrode were used as the working, counter and reference electrodes, respectively. Before testing, the samples were purged with argon for 10 min. LSV dates were collected at different rotation rates ranging from 100 to 1600 rpm. The diffusion coefficient (Do) of electroactive materials were calculated from the Levich plot using Equation 1:

$$i = 0.62 n F A {C}_{o} {D}^{2 / 3} {ω}^{1 / 2} {θ}^{- 1 / 6} \qquad Equation 1$$

Where i is limiting current density, n is the number of electrons in redox process, F is Faraday's constant, A is the area of the glassy carbon electrode, Co is the concentration of active material, w is angular rotation rate and P is the kinematic viscosity of 0.1 M FEC/LiClO₄.

The kinetic rate constant is calculated by Equation 2:

$${i}_{o} = F A {c}_{o} {k}_{o} \qquad Equation 2$$

Where i₀ was calculated from fitting line of Butler-Volmer equation, x-intercept is the log of the exchange current i0 (0.0003 A), F is Faraday's constant, A is the area of the glassy carbon electrode (0.196 cm²), Co is the concentration of redoxmers (0.5×10-6 mol/cm³), k₀ is reaction rate constant (cm/s).

Battery performance measurements. The biphasic system containing FEC (1.5 M LiClO₄) as catholyte and BMP-TFSI (1.0 M LiTFSI) as anolyte was utilized to assemble membrane-free static and flow batteries. The charge/discharge performances of the Li|Tri-TEMPO (0.1 M, 0.2 M, and 0.5 M), Li|C3-PTZ (0.5 M), and Li|CP (0.5 M) batteries were evaluated in the voltage ranges of 2.6-4.0, 2.8-3.8, and 3.3-4.3 V, respectively. The membrane-free batteries were tested in a cylindrical tube. For the static analyses, 0.25 mL of the catholyte and 0.25 mL of the anolyte were used. For the flow analyses, 0.6 mL of the catholyte and 0.6 mL of the anolyte were used; the catholyte was circulated through the cell at a flow rate of 1 mL/min using a peristaltic pump. The rate performances of the static and flow batteries were tested at current densities of 1, 1.5, and 2 mA/cm² and 1.5, 2.0, and 2.5 mA/cm², respectively. Three charge/discharge cycles were performed for each current density. The self-discharging performance of the 0.5 M Li/Tri-TEMPO membrane-free flow battery was tested by recording the OCV over time using a fully charged battery. All the electrochemical measurements were performed in a glove box filled with Ar.

Measurement of capacity utilization and retention. The capacity utilization was determined by the ratio the operational battery capacity (C_{b}) to the theoretical capacity (Ct) at a particular state of charge (SOC).

$$Capacity utilization ( \% ) = [ \frac{{C}_{b} ( charge or discharge )}{{C}_{t}} ] \times 100$$

Capacity retention was determined by normalizing the discharge capacity during cycling, where Cᵢ denotes the discharge capacity obtained in the first cycle and C_{f} represents the discharge capacity obtained in subsequent cycles.

$$Capacity retention ( \% ) = [ \frac{{C}_{f}}{{C}_{i}} ] \times 100$$

Solubility test. A solution of 1.5 M LiClO₄/FEC was used for the solubility measurements. The solution was gradually added to a vial containing known amounts of the organic compounds used as the catholytes (Tri-TEMPO, C3-PTZ, and CP). Once a clear solution was obtained, the volume of the electrolyte was determined using an analytical pipette. The solubilities of the organic compounds were calculated from the ratio of the molar amount to the electrolyte volume. These processes were repeated twice, and the average values are presented.

### Part C

The lithium redox flow batteries (LRFB) received separate attention due to decoupled scaling of energy and power. But their commercial production has been hindered by the limited availability of critically important ion-selective membranes. As a solution to this problem, membrane-free lithium redox flow batteries have been proposed and developed. The biphasic membrane-free lithium redox flow battery might deliver both high voltage and high energy density batteries that too at significantly lower cost in comparison to the typical lithium-redox flow battery. However, the uncontrollable self-discharge along the interface in the biphasic batteries is an issue that deteriorates the battery performance during prolonged cycling. To address this issue, an all-organic tri-phasic membrane-free system has been developed. The membrane-free lithium redox flow battery based on a tri-phasic system facilitates no self-discharge and results in superior battery performance with Coulombic efficiency of close to 100%.

Part C relates to electrochemical energy storage and, more particularly, to all organic triphasic membrane-free lithium redox flow batteries.

Rechargeable lithium-ion batteries received worldwide attention due to their extensive use in both portable and nonportable devices such as cell phones, laptop computers, and electric vehicles due to their high energy density and power. Moreover, the use of rechargeable lithium-ion batteries in energy grid storage is also possible. Besides being advantageous, the lithium-ion rechargeable battery comes with fixed energy and power, which means that these systems are not capable of decoupled scaling of power and energy, which limits their application in various demanding applications. However, the lithium redox flow battery (LRFB), which has an entirely different cell architecture than that of a lithium-ion rechargeable battery, is completely feasible for decoupled scaling of energy and power. However, the development of lithium redox flow batteries has been hindered by the limited availability of critically important ion-selective membranes. With that in mind, nonaqueous membrane-free lithium redox flow batteries have been proposed and developed. The biphasic membrane-free lithium redox flow battery provides a vital solution to produce high voltage and high energy density batteries with significantly lower cost than that of a typically available lithium-redox flow battery. However, the major possible shortcoming of biphasic batteries may be their uncontrollable self-discharge along the biphasic interface under long-term cycling. Therefore, the development of an all-organic tri-phasic membrane-free system can facilitate a membrane-free lithium redox flow battery with no self-discharge. Unlike the biphasic systems, the medium layer in the tri-phasic system act like a membrane that separated anolyte and catholyte and thus mitigates the self-discharge of the battery. This approach results in superior battery performance with Coulombic efficiency of close to 100%.

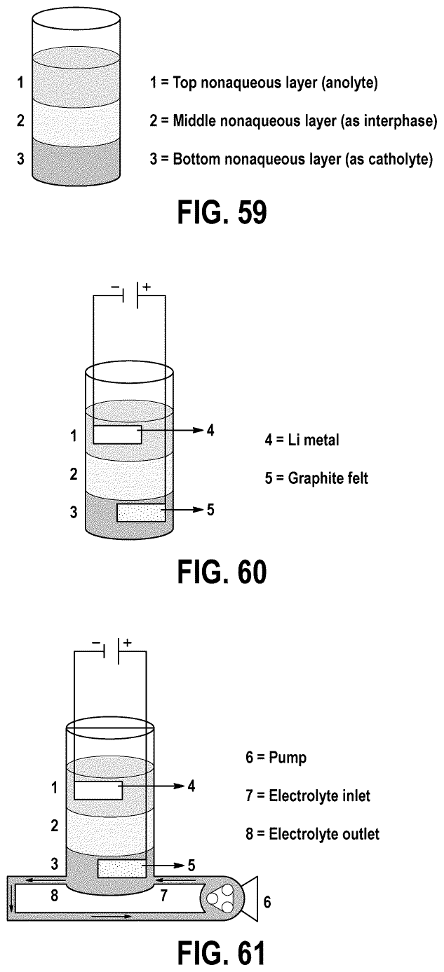

FIG. 59 shows the schematic representation of all organic nonaqueous tri-phasic system in which the top layer act as the anolyte, the middle layer act as the interface, and the bottom layer act as the catholyte.

FIG. 60 shows the fabrication of static membrane-free battery lithium static battery based on the tri-phasic system described in FIG. 60. Lithium metal was used as the anode, C18-PTZ was used as the cathode, and graphite felt was used as the cathode electrode.

FIG. 61 shows the membrane-free tri-phasic lithium battery under flowing catholyte.

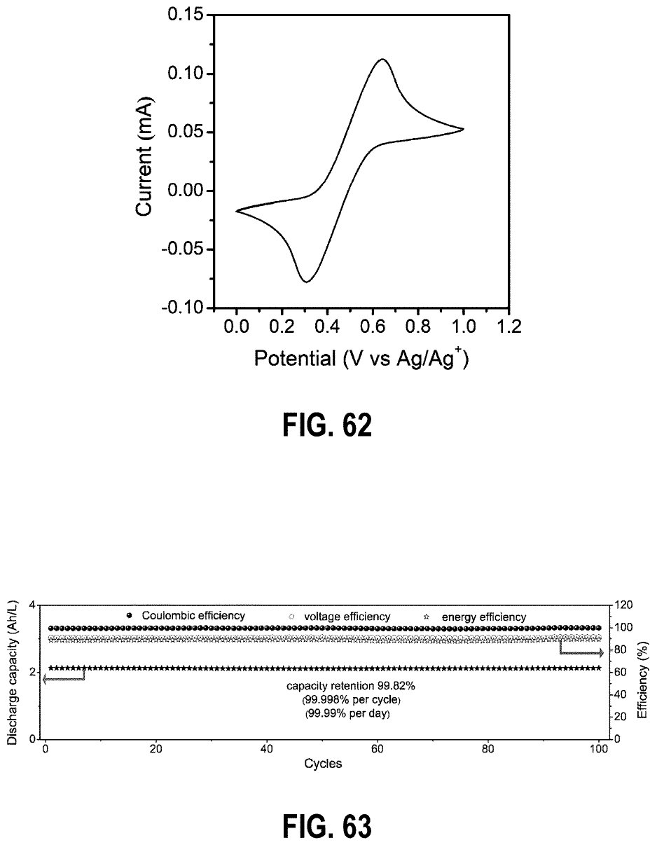

FIG. 62 shows the cyclic voltammograms of 5 mM C18-PTZ in 0.1 M LiClO₄/FEC solution at a scan rate of 50 mV/s.

FIG. 63 shows the charge-discharge performance of 0.1 M Li|C18-PTZ battery under static conditions for 100 charge/discharge cycles. The tri-phasic static battery displayed a capacity retention of ~100%, Coulombic efficiency of ~100, voltage efficiency of ~92, and energy efficiency of ~92, respectively.

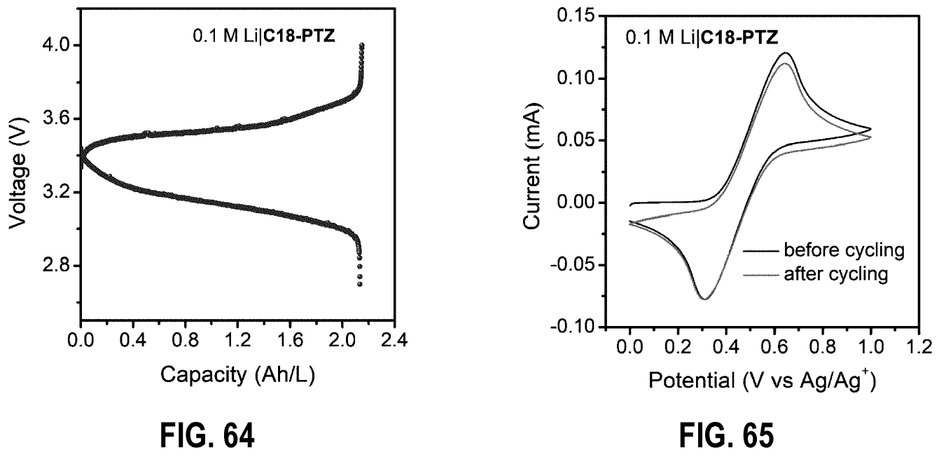

FIG. 64 shows the charge/discharge profile of 0.1 M Li|C18-PTZ static tri-phasic battery.

FIG. 65 shows the cyclic voltammetry of 0.1 M Li|C18-PTZ static tri-phasic battery before and after 100 charge/discharge cycles. No obvious change in anodic and cathodic current densities of the cyclic voltammetry curves before and after 100 battery cycles confirms no crossover of active materials.

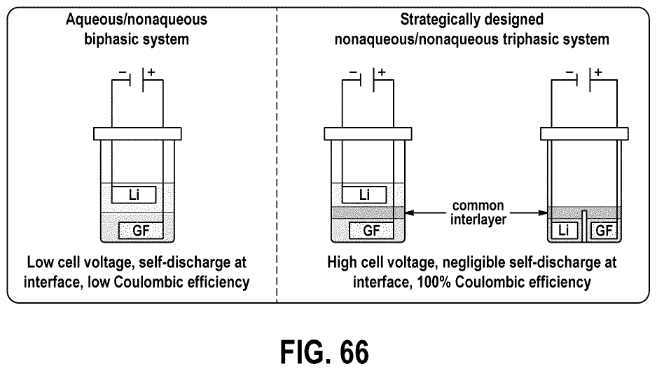

FIG. 66 shows high-voltage membrane-free redox flow battery based on nonaqueous liquid/liquid triphasic system with nearly 100% Coulombic efficiency.

### Part D

Biphasic membrane-free redox flow batteries received increasing attention as promising energy storage systems. The liquid/liquid biphasic strategy offers low battery cost, reduced crossover, and accessibility toward a wide range of redox-active molecules. However, the inevitable self-discharge at the biphasic interface, low Coulombic efficiency, and poor capacity retention under the flow condition are the major concerns associated with biphasic electrolyte-based membrane-free batteries. To address these issues, two new strategic designs were demonstrated based on triphasic liquid/liquid electrolytes, where the biphasic interface was replaced by a third electrolyte layer. The additional intermediate electrolyte layer suppresses the self-discharge, resulting in 100% Coulombic efficiency and excellent capacity retention. Here, the membrane-free batteries based on the two new strategic liquid/liquid triphasic designs were developed using three different nonaqueous electrolytes including tetraethylene glycol dimethyl ether (TEGDME), nonafluoro-1,1,2,2-tetrahydrohexyl-trimethoxysilane (NFTTS), and fluoroethylene carbonate (FEC). Lithium metal and phenothiazine derivative (C18-PTZ, 0.5 M) were selected as anode and cathode materials, respectively, which deliver a cell voltage of 3.52 V. The membrane-free batteries based on the two different triphasic designs were tested under both static and flow conditions, and all batteries showed excellent cycling performances with average Coulombic efficiency of 100% under both static and flow conditions.

Redox flow batteries (RFBs) have received increasing attention as promising energy storage systems due to their unique features of decoupled energy density and power. Based on the electrolyte types, the RFBs can conventionally be categorized into two types: aqueous RFB (ARFB) and nonaqueous RFB (NRFB). Each type of RFB utilizes the same working principle in which the redox active materials dissolved in the electrolyte solution are kept in two separate tanks named catholyte and anolyte. Each type has its advantages and demerit points. The ARFBs provide easy fabrication, long cycle life, and high current density operation at ambient conditions. However, the ARFBs exhibit a limited voltage window (1.23 V, standard conditions) due to the low electrolysis potential of water. On the other hand, the NRFBs exhibit a high electrochemical window (~5 V) yet their high current density operation is challenging due to the high viscosity of organic electrolytes. Conventionally, the active materials of an RFB are stored in two separate tanks named catholyte and anolyte. To perform the charge/discharge process, the electrolyte solutions from the catholyte and anolyte tanks are circulated through the cell with the help of pumps. To separate the catholyte and anolyte in the cell, various types of ion-selective membranes are generally used. However, the high cost of the ion-selective membranes (up to 20-40% of the total battery cost) hinders the broad deployment of RFBs.

Therefore, RFBs based on a membrane-free strategy have been developed to reduce the cost and realize broader application storage technology. Various chemistries of membrane-free batteries based on liquid/liquid biphasic systems have been demonstrated. So far, the membrane-free batteries reported by our group and in the literature are based on an aqueous/nonaqueous biphasic system. Few membrane-free batteries have been reported based on nonaqueous/nonaqueous biphasic systems because of their difficult biphasic designing and redox materials selection. The biphasic system can be formed using two immiscible electrolytes that have different gravimetric densities and suitable partition coefficient. The two phases of the biphasic system shared a common interface. Based on the compatibility of the redox materials, one phase of the biphasic system can be utilized as an anolyte and the other as the cathode. The liquid/liquid interface separates the two different redox active materials (catholyte and anolyte), thus avoiding the use of a membrane separator.

While compelling, membrane-free biphasic batteries still suffer from various major challenges including, (1) the capacity loss due to cross-contamination of redox molecule and ion migration, (2) self-discharge due to interfacial ion migration during the solvation/desolvation process and rate of solvent diffusion, and (3) low capacity utilization due to poor mass transfer conditions. Since the liquid/liquid interface of a membrane-free battery is not as stable as membrane-based RFB, the flow of electrolytes in membrane-free batteries can induce huge disturbance and break the thermodynamic balance. Moreover, the active materials crossover by convective mass transport under electrolyte flow can result in high capacity loss. This is presumably why most reported biphasic membrane-free batteries were demonstrated under static conditions. All these three factors discussed above result in low Coulombic efficiency, low capacity retention, and poor capacity utilization. It can be realized that the liquid/liquid interface is the limiting factor controlling the performance of biphasic membrane-free batteries.

Herein, this work demonstrates two new strategic designs based on triphasic liquid/liquid electrolytes, where the biphasic interface was replaced by an additional electrolyte layer. Similar to ion-selective membranes, the intermediate electrolyte layer facilitates the separation of the two phases (anolyte and catholyte), thus eliminating self-discharge and offering high Coulombic efficiency. Moreover, the presence of an intermediate layer improves the viability of electrolyte flow compared to that of a biphasic system. Here, the membrane-free batteries based on the two new strategic liquid/liquid triphasic designs were developed using three different nonaqueous electrolytes, including tetraethylene glycol dimethyl ether (TEGDME), nonafluoro-1,1,2,2-tetrahydrohexyl-trimethoxysilane (NFTTS), and fluoroethylene carbonate (FEC). Lithium metal and phenothiazine derivative (C18-PTZ) were selected as anode and cathode materials, respectively, which delivered a cell voltage of 3.52 V. The membrane-free batteries based on the triphasic designs were tested under both static and flow conditions. Under both static and flow conditions, all batteries showed excellent cycling performances with average Coulombic efficiency of 100% (both static and flow).

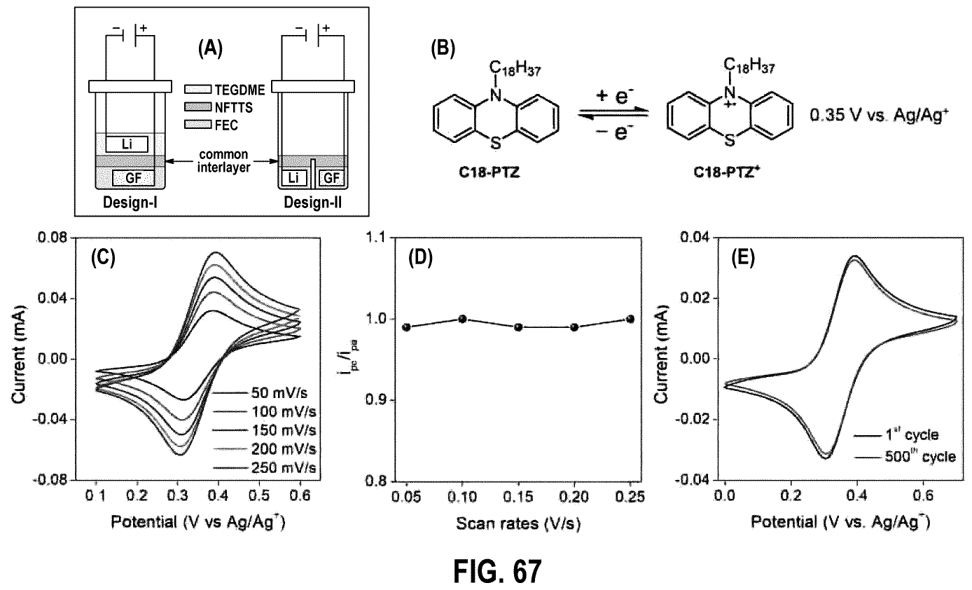

Results and Discussion. Design of nonaqueous triphasic system. The present study constructed two unique designs (design-I and II) for liquid/liquid triphasic systems, as illustrated in FIG. 67(a). The systems were comprised of three nonaqueous electrolytes, namely tetraethylene glycol dimethyl ether (TEGDME), nonafluoro-1,1,2,2-tetrahydrohexyl-trimethoxysilane (NFTTS), and fluoroethylene carbonate (FEC), which were chosen due to their inability to mix with each other, ability to dissolve specific redox materials, and varying gravimetric densities. Due to its intermediate gravimetric density and strong immiscibility with both FEC and TEGDME electrolytes, the NFTTS electrolyte is suitable to function as either an intermediate or ion-selective layer within the triphasic system. In order to create liquid/liquid triphasic systems with two unique designs, a biphasic system consisting of TEGDME and NFTTS was first prepared by incorporating 0.8 M LiTFSI salt into their solution mixture. Subsequently, both the TEGDME/LiTFSI and NFTTS/LiTFSI electrolyte phases separated out, along with the 2 M FEC/LiTFSI electrolyte phase. The triphasic system of design-I was produced by layering the TEGDME/NFTTS biphasic system on top of the 2 M FEC/LiTFSI layer (FIG. 67(a)). Using this triphasic system, a membrane-free lithium redox static and flow battery was developed, with the TEGDME electrolyte layer serving as the anolyte, the FEC electrolyte layer as the catholyte, and the NFTTS electrolyte layer as either an interface or ion-exchange layer. Design-II of the triphasic system was created by filling the two compartments of a container, separated by a common divider, with the FEC electrolyte. Next, the NFTTS electrolyte solution was added on top of the FEC electrolytes, which served as an interface between the FEC electrolyte on either side of the divider. In this design, the FEC electrolyte on one side of the divider functions as the catholyte, the FEC electrolyte on the other side serves as the anolyte, and the NFTTS electrolyte acts as a common interfacial electrolyte layer (FIG. 67(a)).

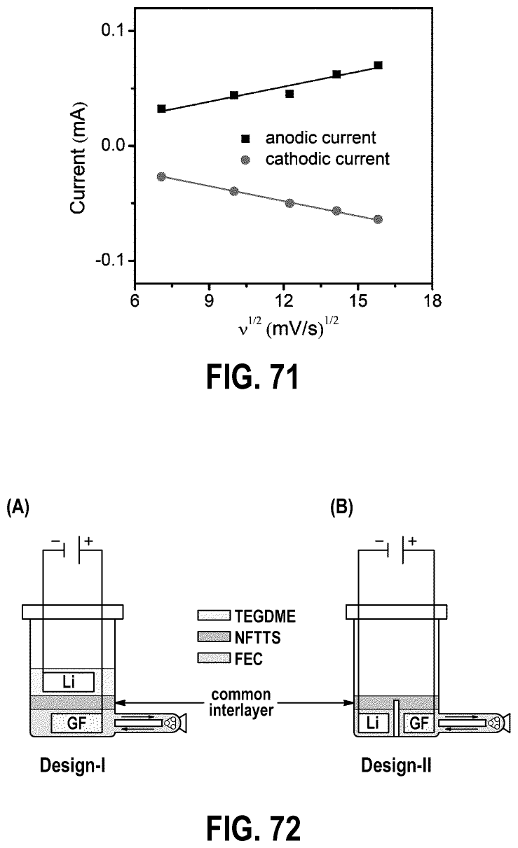

Electrochemical characteristics. Cyclic voltammetry (CV) was utilized to assess the electrochemical stability and reversibility of the C18-PTZ redox material whose chemical structure is depicted in FIG. 67(b). The CV analysis showed that C18-PTZ has a well-defined redox peaf with a reversible redox couple at 0.35 V vs. Ag/Ag⁺ in 0.1 M FEC/LiTFSI, as depicted in FIG. 67(c). The peak potential separations of C18-PTZ at a scan rate of 50 mV/s were ~68, which is indicative of a one-electron redox process as per the Nernst equation. Moreover, the ratios of the cathodic peak current (i_{pc}) and anodic peak current (iₚₐ) at scan rates ranging from 50 to 250 mV/s were approximately 1, as shown in FIG. 67(d). These results suggest that C18-PTZ exhibits excellent electrochemical reversibility in FEC. Moreover, the anodic and cathodic peak currents exhibited a linear relationship with the square root of the scan rate (v^{1/2}) (FIG. 71), indicating that the redox process is diffusion-controlled. The CV results revealed excellent electrochemical stability, as demonstrated by the almost identical voltammograms observed in FIG. 67(e).

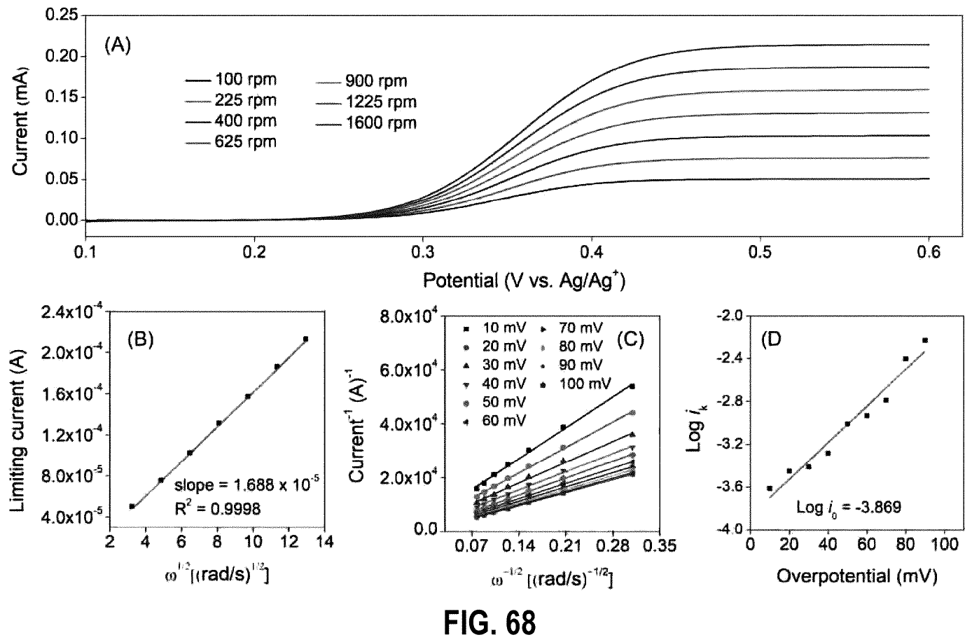

To investigate the electrochemical kinetics of C18-PTZ redox molecules, linear sweep voltammetry (LSV) was conducted using the rotating disk electrode (RDE) technique. The LSV curves of C18-PTZ were measured in electrolyte solutions containing 1.0 mM C18-PTZ in 0.1 M FEC/LiTFSI solution, and the results are presented in FIG. 68(a). The rotation rate (ω) was gradually increased from 100 to 1600 rpm, revealing well-defined plateaus of mass-transport-controlled limiting currents (i). FIG. 68(b) demonstrates linear relationships between the limiting currents (i) and the square root of the rotation rate (ω^{1/2}) for C18-PTZ, which are in accordance with the Levich equation (Equation 1).

Using the slopes of the fitted linear Levich plots, the diffusion coefficients D are determined to be 6.23×10-6 cm²/s for the C18-PTZ. Furthermore, the electrochemical kinetics of the charge-transfer reactions of C18-PTZ can be obtained using the Koutecky-Levich equation (Equation 1). FIG. 68(c) depicts the linear correlations between i⁻¹ and ω^{1/2} for C18-PTZ at different overpotentials (η=10, 20, 30, 40, 50, 75, and 100 mV). The iₖ values were obtained from the reciprocal of the Y-axis intercepts and plotted against the overpotential in FIG. 68(d). Thereafter, the kinetic rate constant is calculated using the Equation 1. The kinetic rate constants (k₀) of C18-PTZ was calculated to be 3.51×10⁻³ cm s⁻¹. The diffusion coefficients and rate constants of C18-PTZ comparable to those of some redox-active organic materials used in aqueous flow batteries. The fast electrode kinetics of C18-PTZ is expected to produce low activation polarization loss, which is favored for flow battery applications.

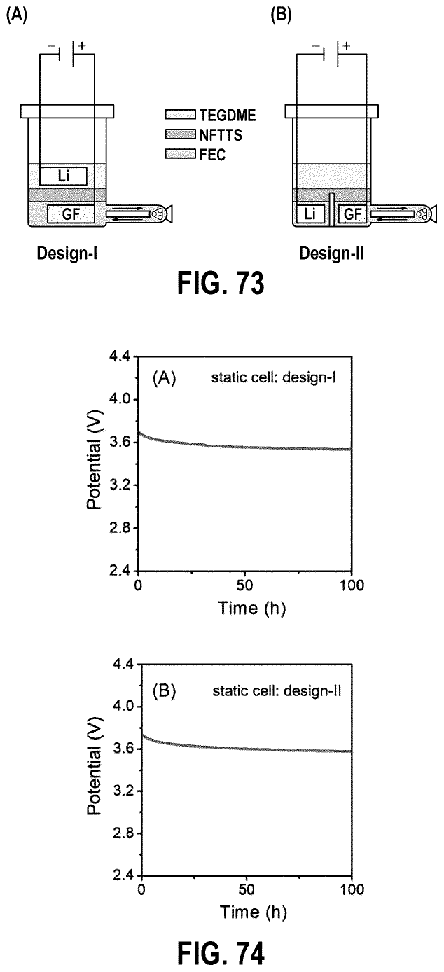

Charge/Discharge Performance. The charge/discharge performance of the liquid/liquid nonaqueous triphasic system was evaluated for both design-I and design-II (illustrated in FIG. 67(a)), wherein a 0.5 M C18-PTZ redox active cathode was coupled with a lithium (Li) metal anode. The cycling performance of 0.5 M Li|C18-PTZ cell was evaluated under both static and flow conditions. Triphasic cell schematic under static and flow are illustrated in FIGS. 72 and 73, respectively.

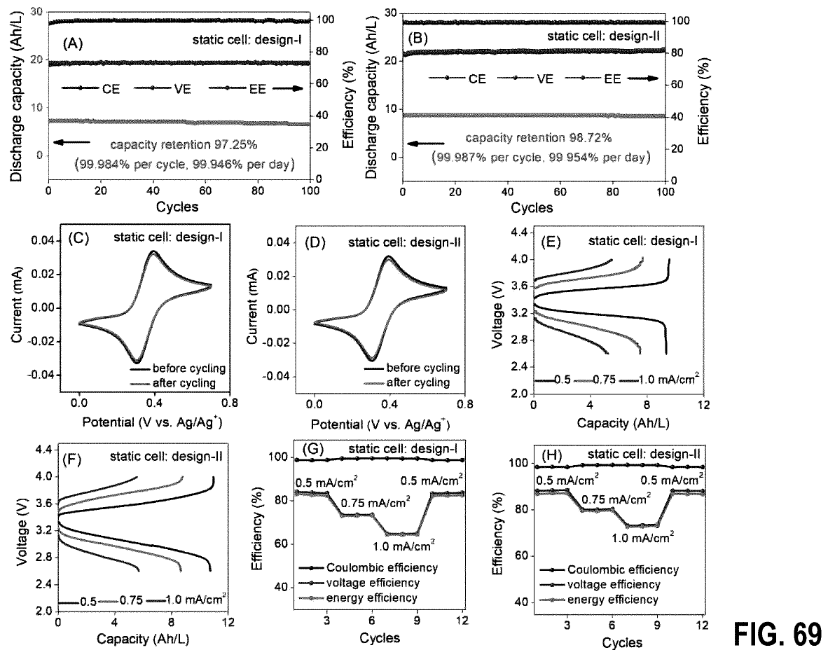

Under static condition. Two triphasic static cells were assembled using design-I and design-II by combining a Li-metal anode with 0.5 M C18-PTZ. Both static cells were charged/discharged for 100 cycles over approximately 33 days with a current density of 0.75 mA/cm² (FIGS. 69(a) and 69(b)). Although the current density was lower than that of membrane-based batteries, it was considerably higher than that of reported aqueous and nonaqueous biphasic membrane-free systems. Both designs of 0.5 M Li|C18-PTZ triphasic cells demonstrated excellent cycling performance, with capacity retentions of 97.25% (99.984% per cycle, 99.946% per day) and 98.72% (99.987% per cycle, 99.954% per day), respectively. The results indicate that the C18-PTZ, supporting electrolytes, and solvent were highly stable during actual battery operation conditions. Additionally, both triphasic static batteries demonstrated high Coulombic efficiency (over approximately 100% for both cells) and energy efficiency (74% for design-I and 82% for design-II), which is the highest Coulombic efficiency value reported for a membrane-free battery to our knowledge. Further, the post-cycling investigation of both triphasic static cells was carried out using CV (FIGS. 69(c) and 69(d)). The CV results of the catholytes from both static cells after cycling showed no significant change in peak current densities, indicating that C18-PTZ remained confined within the catholyte (FEC phase) during the extended cycling process. Hence, the presence of the intermediate electrolyte layer (NFTTS electrolyte) between the anolyte and catholyte in the triphasic static system played an important role as a separator or ion-selective electrolyte layer. The fact that the redox molecules did not migrate further confirms the stability and reliability of the triphasic static system. To investigate the impact of triphasic systems on the self-discharge of the static membrane-free batteries the open-circuit voltage (OCV) in the fully charged cell was monitored over 100 hours (FIGS. 74(a) and 74(b)). The OCV of the batteries displayed no significant loss in the voltage for both of the batteries over the time duration of 100 hours. The per-hour voltage loss (0.55 mV/h for both designs) for both of the batteries was extremely low compared to that of previously reported aqueous/nonaqueous biphasic membrane-free batteries and membrane-based batteries. Hence, the intermediate layer can effectively eliminate self-discharge resulting from ion migration from the catholyte to the anolyte. This leads to excellent Coulombic efficiency and high capacity retention in the battery system. The use of a triphasic electrolyte layer has proven to be an effective solution to the problem of self-discharge in membrane-free batteries.

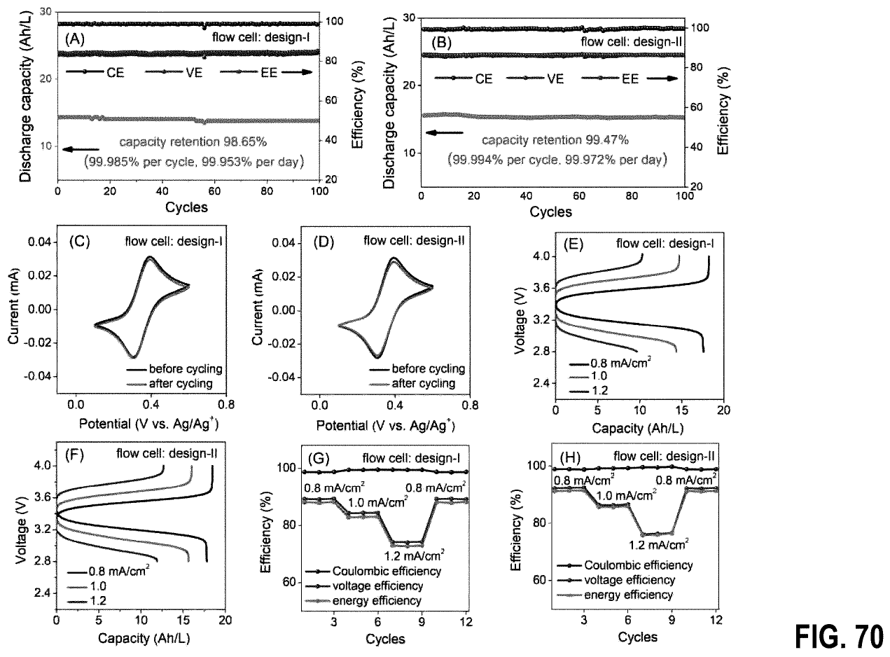

In addition, the impact of varied charge/discharge current densities on the performance of 0.5 M Li|C18-PTZ static cells based on design-I and design-II was also investigated. The cells were subjected to cycling at current densities of 0.5, 0.75, and 1.0 mA/cm², respectively, and the average CE, VE, and EE values were determined for three cycles (FIGS. 69(e) and 70(f)). The static cells based on design-I and design-II displayed approximately 102 mV and 108 mV ohmic drops, respectively, at 0.75 mA/cm². At 1.0 mA/cm², the cells exhibited approximately 142 mV and 139 mV ohmic drops, respectively. The rise in ohmic loss at the higher current density can be attributed to constraints associated to limited mass diffusion towards high current densities. Further, the both static cells (FIGS. 69(g) and (h)) showed CE values close to 100%, with an increasing trend in CE towards higher current densities. However, the EE values of the batteries were reduced from 84% to 64% (design-1) and 89% to 73% (design-II), respectively, when the applied current density was increased from 0.5 to 1.0 mA/cm². This was owing to an increase in the overpotential because of mass transport losses. It should be noted that all three batteries regained their original efficiencies when they were cycled back at 0.5 mA/cm², thus confirming their superior charge-rate performance.

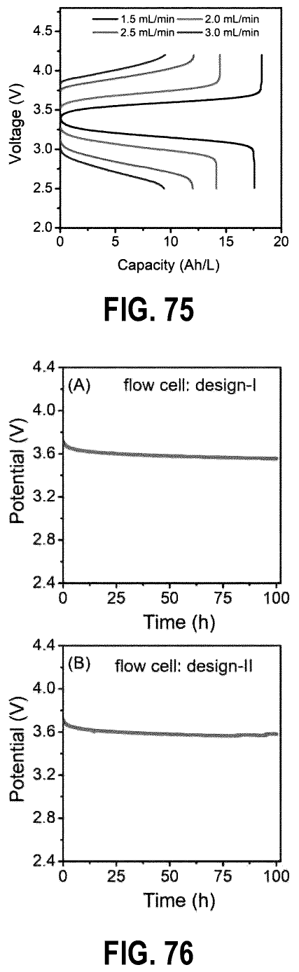

Under flow conditions: The triphasic membrane-free batteries under static conditions displayed excellent charge/discharge performance while facilitating no self-discharge, 100% Coulombic efficiency, and excellent capacity retention. However, low capacity utilization remains a major problem of static membrane-free batteries due to poor mass transfer conditions. In addition, independent scale-up of energy and power is inevitable for static conditions. For biphasic membrane-free batteries, the liquid/liquid interface is not as stable as membrane-based RFB. Therefore, the flow of electrolytes in biphasic membrane-free batteries can induce high disturbance. Moreover, the active materials crossover by convective mass transport under electrolyte flow can result in high capacity loss. However, the introduction of interfacial electrolyte layer (NFTTS electrolyte) of the liquid/liquid triphasic system not only separates the anolyte from the catholyte but also makes flow electrolytes (anolyte or catholyte) more convenient without disturbing the thermodynamic balance of electrolyte phases even at higher flow rates. Therefore, to investigate the efficacy of a triphasic system under flow conditions as well as to acquire independent scale-up of power and energy, membrane-free triphasic flow cells based on design-I and design-II were investigated for long charge/discharge cycling under flowing catholyte. Initially, the flow conditions were optimized by measuring the charge/discharge performance of 0.5 M Li|C18-PTZ flow cell with design-I at different flow rate of the catholyte (FIG. 75). As a result, an optimal flow rate of 1.0 mL/min was selected to perform long-term cycling of 0.5 M Li|C18-PTZ flow cells. Under the electrolyte flow condition, the flow cells based on design-I and design-II showed an excellent capacity retention of 98.65% (99.985 per cycle, 99.953 per day) and 99.47% (99.994 per cycle, 99.972 per day) (FIGS. 74(a) and 74(b)), respectively. The flow cell with design-I (FIG. 74(a)) displayed a CE of ~100%, VE of ~84%, and, EE of ~83%, CE of ~100%, VE of ~88%, and, EE of ~87% was displayed by cell based on design-II (FIG. 74(b)). The post-cycled battery cell investigation was done using CV. No obvious change in the CV current densities of the post-cycled battery confirms excellent stability of redox-active materials with no crossover of active material across the interfacial layer (FIG. 74(c) and FIG. 74(d)). Further, the open circuit voltage (OCV) of the fully charged cells were observed for the duration of 100 h to evaluate the impact of electrolyte flow on the self-discharge of the cells (FIGS. 76(a) and 76(b)). Throughout the duration, no obvious decay in the OCV were observed, which confirms no self-discharge of the cells. Hence, replacing the biphasic interface with an electrolyte layer can eliminate the interfacial self-discharge as well crossover of active materials under convective mass transport under electrolyte flowing conditions.

The charge-rate performance of the 0.5 M Li|C18-PTZ flow cells based on design-I and design-II were evaluated at current densities of 0.8, 1.0, and 1.2 mA/cm², and the corresponding cycling profiles as well as the CE, VE, and EE values were measured for an average of three cycles. When operated at a current density of 1.2 mA/cm², the flow cells exhibited a discharge overpotential of 182 mV and 156 mV, respectively, which is nearly twice that when it was operated at a current density of 1.0 mA/cm² (FIGS. 74(e) and 74(f)), could be due to induced transport losses towards high current. The Coulombic efficiency of the cell remains high as 100% at all the current densities; however VE and EE observed a decay with increasing current density. The increase in the overpotential and the corresponding reduction in the VE at the higher current density can be attributed to mass transport limitations (FIGS. 74(g) and 74(h)). Although, both the cells were able to regain its original performance when cycled again at the applied current density of 0.8 mA/cm². Further, the triphasic cell under flow condition displayed excellent capacity utilization compared to static cell. This suggest that the flow of electrolyte has significantly reduced the mass transport limitation faced by the static battery.

Conclusions. To address the issues associated with the biphasic electrolyte strategy, an advanced triphasic liquid/liquid system with two strategic designs (design-I and -II) was proposed. Unlike the biphasic electrolyte system, an additional electrolyte layer was introduced which helps in keeping the two phases (anolyte and catholyte) separated, thus eliminating the self-discharge and offering high Coulombic efficiency. Moreover, the presence of an intermediate layer makes the electrolyte flow more convenient compared to that of the biphasic system; therefore facilitates high-capacity utilization. Two membrane-free batteries based on the two new strategic liquid/liquid triphasic designs (design-I and design-II) were developed using three different nonaqueous electrolytes including tetraethylene glycol dimethyl ether (TEGDME), nonafluoro-1,1,2,2-tetrahydrohexyl-trimethoxysilane (NFTTS), and fluoroethylene carbonate (FEC). Lithium metal and phenothiazine derivative (C18-PTZ (0.5 M)) were selected as anode and cathode materials, respectively, which delivered a battery with a cell voltage of 3.52 V. The membrane-free batteries based on both triphasic designs (I and II) were tested under both static and flow conditions. Under both static and flow conditions, all batteries showed excellent cycling performances with average Coulombic efficiency of 100% (both static and flow) and capacity retention rates of 99% (static) and 97% (flow). This study is a significant advance in the development of high voltage membrane-free batteries with no self-discharge, 100% Coulombic efficiency, and excellent capacity retention.

General methods. Materials. Lithium perchlorate (LiClO₄, 98%), lithium bis(trifluoromethanesulfonyl)imide (LiTFSI, 99.94%), fluoroethylene carbonate (FEC), propylene carbonate (PC), nonafluoro-1,1,2,2-tetrahydrohexyl-trimethoxysilane (NFTTS), tetraethylene glycol dimethyl ether (TEGDME) were purchased from Fisher Scientific and used without further purification.

Characterization techniques. The UV-visible absorption spectra were collected on a UV-visible spectrophotometer (Agilent Technologies, Cary 8454 UV-Vis). Cyclic voltammetry (CV) was performed using Bio-Logic potentiostat. Charge/discharge performance were performed using Land and Bio-Logic potentiostats.

Electrochemical characterization. CV studies were carried out to estimate the electrochemical properties of redox material (C18-PTZ) as well as the crossover of redox-active cathode material before and after long-term battery cycling. For CV measurements, 5 mM of C18-PTZ solution were prepared in 0.1 M FEC/LiTFSI electrolyte. A 3-mm glassy carbon was used as the working electrode and was polished with 50 nm Al₂O₃ before measurements. Platinum wire (0.5 mm) was used as the counter electrodes. A Ag/Ag⁺ electrode was used as the reference electrode.

Calculation of diffusion coefficient and electron transfer rate. Linear sweep voltammetry (LSV) studies were carried out using a Pine modulated speed rotator with Biologic potentiostats. Rotating disk electrode (RDE, diameter: 5 mm), Pt wire electrode and Ag/Ag⁺ electrode were used as the working, counter and reference electrodes, respectively. Before testing, the samples were purged with argon for 10 min. LSV dates were collected at different rotation rates ranging from 100 to 1600 rpm. The diffusion coefficient (Do) of electroactive materials were calculated from the Levich plot using Equation 1.

The kinetic rate constant is calculated by Equation 2.

Battery performance measurement. The charge/discharge performance of the Li|C18-PTZ batteries were evaluated in the voltage ranges of 2.5-4.2 V. The membrane-free batteries were tested in a cylindrical tube. For static studies, a 0.2 mL catholyte and 0.2 mL anolyte were used. For flow battery studies, a 0.5 mL catholyte and 0.5 mL anolyte were used, where the catholyte was circulated through the cell at a flow rate of 1 mL min-1 with the aid of a peristaltic pump. The rate performance of static and flow batteries was tested at different current densities of 0.5, 0.75, 1.0 mA/cm² and 0.8, 1.0, 1.2 mA/cm², respectively. Three charge/discharge cycles were recorded for each current density. Self-discharge performance of flow battery was tested by recording OCV overtime on a fully-charged battery. All electrochemical experiments were carried out in a glove box filled with argon.

Solubility test. A solution of 2 M FEC/LiTFSI was used for solubility measurements. The solution was gradually added to a vial containing known amounts of C18-PTZ. Once a clear solution was just obtained, the volume of the electrolyte was determined by an analytical pipette. The solubility of organic compounds was calculated from the ratio of the molar amount to electrolyte volume. These processes are repeated twice, and the averaged values are presented.

### Part E

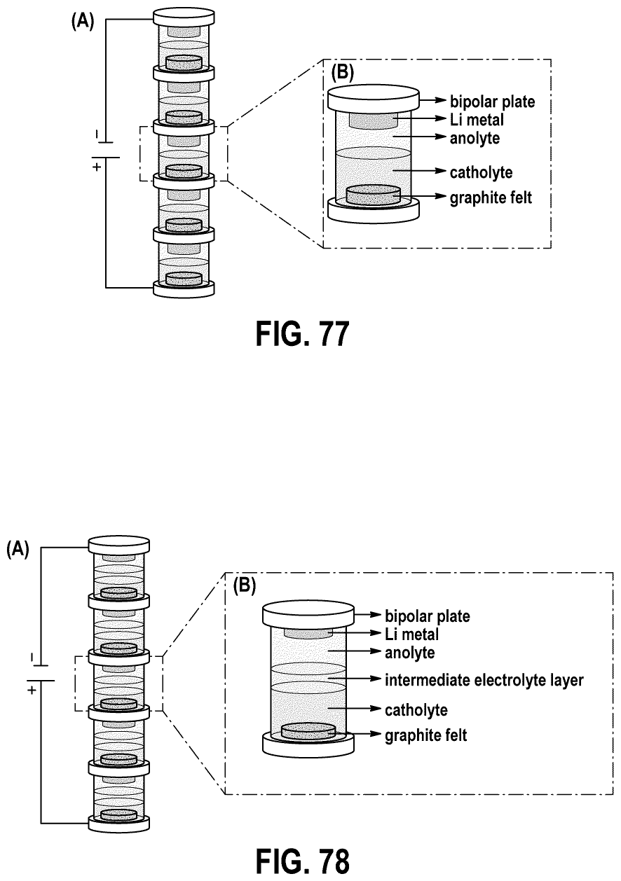

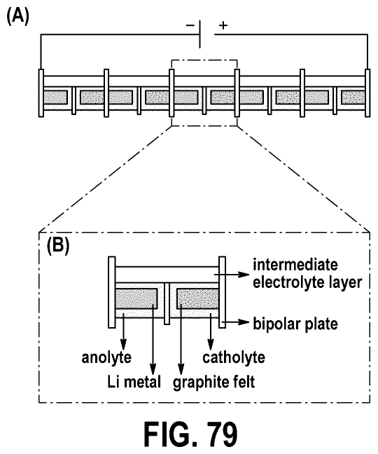

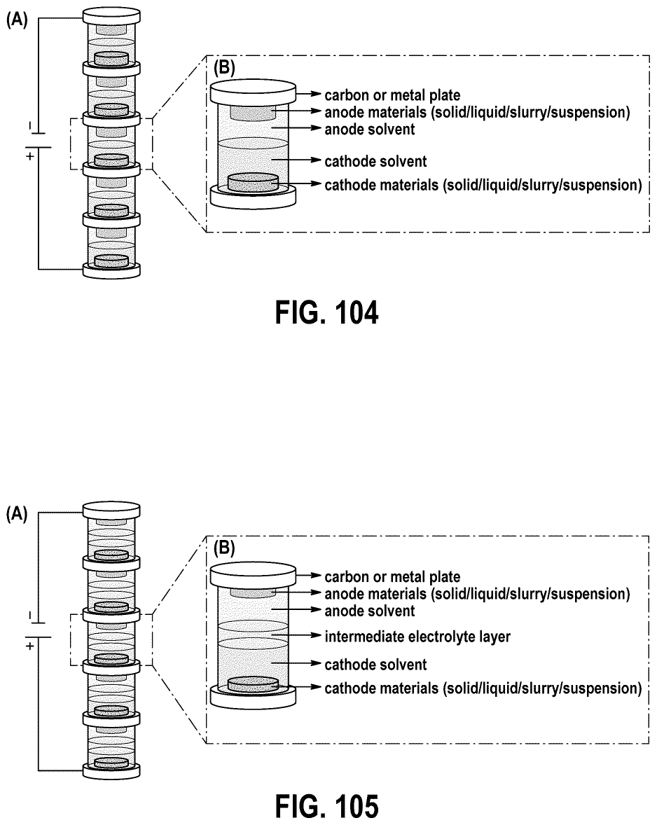

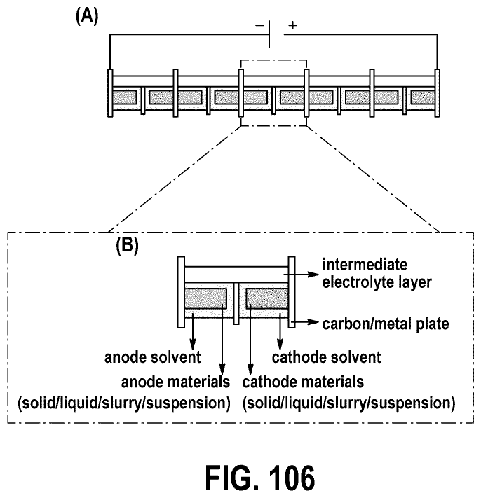

Cell stacking configuration for membrane-free batteries. Membrane-free batteries utilizing biphasic and triphasic systems (design-I and design-II) can be assembled into larger stacks, similar to conventional RFB systems using bipolar plates. To accomplish this, the configurations for the biphasic (FIGS. 77 and 104) and triphasic systems (FIGS. 78 and 105 for design-I and FIGS. 79 and 106 for design-II) are provided. This stacking configuration enables the scaling of power and energy at a larger scale for these battery systems.

### Part F

Liquid/liquid biphasic batteries without a membrane could be promising models of redox flow batteries. However, such batteries inherently undergo self-discharge at the liquid/liquid interface, resulting in low Coulombic efficiency and poor capacity retention. Herein, we report a triphasic system comprising all-nonaqueous electrolytes to overcome those challenges in biphasic systems. By incorporating a third electrolyte layer to separate the anolyte and catholyte, the system effectively impeded the self-discharge event without compromising the Coulombic efficiency and capacity retention. Li metal anode and phenothiazine derivative C18-PTZ (0.5 M) cathode have been used to construct the electrochemical cell. Moreover, we have designed two all-nonaqueous triphasic models either stacking the phases vertically or physically separating two phases side-wise along with a common interfacial layer at the top. Interestingly, both designs showed high capacity retention under static (~98%, 31 days, 100 cycles) and flow (~99%, 39 days, 100 cycles) conditions. Moreover, all batteries exhibited an average Coulombic efficiency of nearly 100%.

Global energy and climate challenges require the transition from fossil fuels to renewable energy resources, including, but not limited to solar, wind, and hydroelectric power, driving the utilization of large-scale energy storage devices. Redox flow batteries (RFBs) could be promising energy storage devices due to their unique properties, including high scalability, decoupled energy and power, and high safety. In the conventional RFB configuration, redox-active materials are dissolved in solvents to form a catholyte and anolyte, which are stored separately in external tanks. Depending on the electrolyte used, RFBs can be classified as either aqueous RFBs (ARFBs) or nonaqueous RFBs (NRFBs). Although ARFBs are safer and more cost-effective, they typically have a narrow voltage window (<1.6 V) due to the low thermodynamic stability of water. In contrast, NRFBs have a higher electrochemical window (~5.5 V), but they are associated with other challenges such as low ionic conductivity, high flammability, and the high cost of organic electrolytes. Additionally, NRFBs face the significant challenge of redoxmer crossover due to the lack of appropriate membranes in nonaqueous media, ultimately impacting the overall battery performance. To optimize RFB performance, it is crucial to develop membranes with high ionic conductivity, molecular selectivity, stability, and low cost.

An alternative strategy to address the aforementioned issues is the fabrication of RFBs without a membrane separator. This approach, demonstrated by our group and several other researchers, involves utilizing immiscible aqueous/nonaqueous electrolytes. This biphasic system consists of two immiscible electrolytes with different densities and a suitable partition coefficient, forming two phases with a common interface. This interface functions as a separator between the anolyte and the catholyte. However, membrane-free batteries with nonaqueous/nonaqueous electrolytes are rarely reported because of challenges in designing and selecting suitable solvents and redox-active materials. Although membrane-free biphasic batteries are promising, they face significant challenges that limit their practical application. These challenges include capacity loss due to the mixing of the anolyte and catholyte at the interface, self-discharge induced by interfacial ion migration during the solvation/desolvation process (rate of solvent diffusion), and low capacity utilization owing to poor mass transfer under static conditions. Additionally, compared with membrane-based RFBs, membrane-free batteries exhibit an unstable liquid/liquid interface that can significantly disrupt the thermodynamic balance under flow conditions. Active material crossover by convective mass transport under flow conditions further exacerbates capacity loss.

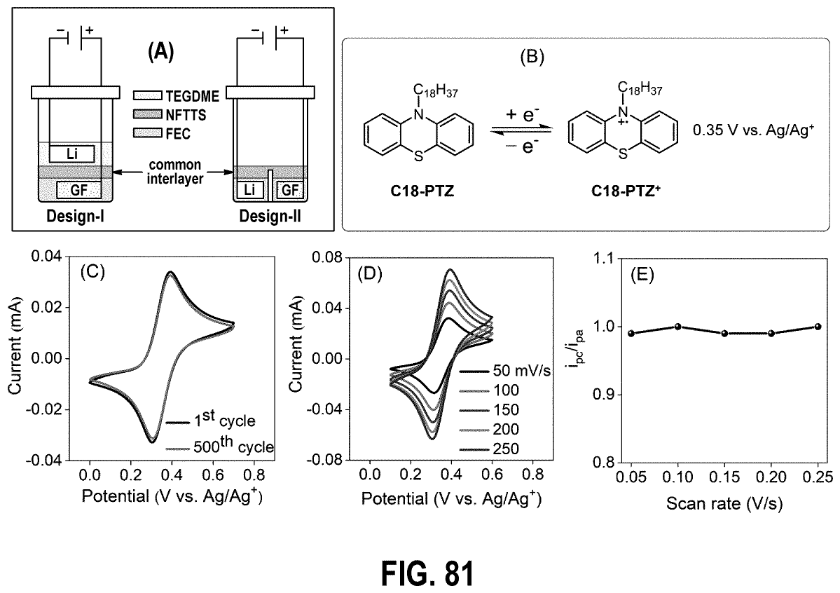

This study presents a new strategy by introducing a third layer as an ion-selective membrane to facilitate the separation of the anolyte and catholyte, alleviate self-discharge, and achieve high Coulombic efficiency. The introduction of an interfacial electrolyte layer in the liquid/liquid triphasic system not only effectively separates the anolyte and catholyte but also facilitates convenient electrolyte flow (anolyte or catholyte) without disturbing the thermodynamic balance of the electrolyte phases, even at high flow rates. This new approach enables the triphasic system to overcome the limitations of biphasic membrane-free batteries, resulting in improved capacity utilization and performance under flow conditions. The triphasic all-nonaqueous strategy is implemented using two distinct cell designs (see FIG. 81(a)). Three nonaqueous electrolytes, tetraethylene glycol dimethyl ether (TEGDME), nonafluoro-1,1,2,2-tetrahydrohexyl-trimethoxysilane (NFTTS), and fluoroethylene carbonate (FEC) are used in the membrane-free batteries with Li metal and a phenothiazine derivative as the anode and cathode materials, respectively, resulting in a cell voltage of 3.52 V. The cycling performances of triphasic membrane-free batteries based on both designs are evaluated under static and flow conditions. All batteries exhibited outstanding cycling performances with capacity retentions under static conditions (~98%, 31 days, 100 cycles) and flow conditions (~99%, 39 days, 100 cycles). Furthermore, all the batteries demonstrated an average Coulombic efficiency of nearly 100% under both static and flow conditions.

This study introduces three new triphasic configurations based on all non-aqueous electrolyte systems, utilizing various electrolyte solvents and salts. These configurations exhibit versatility beyond specific redox-active cathode materials. The combinations of electrolyte solvents and salts offer opportunities to explore a wide range of redox-active cathode and anode materials with varying solubility, paving the way for high-performance membrane-free redox flow batteries. In addition, it effectively addresses issues in conventional RFBs, such as membrane limitations and high costs. Furthermore, it tackles challenges related to self-discharge, low Coulombic efficiency, and crossover of redox materials during electrolyte flow in biphasic membrane-free batteries, demonstrating its broad applicability and improved performance across diverse battery chemistries.

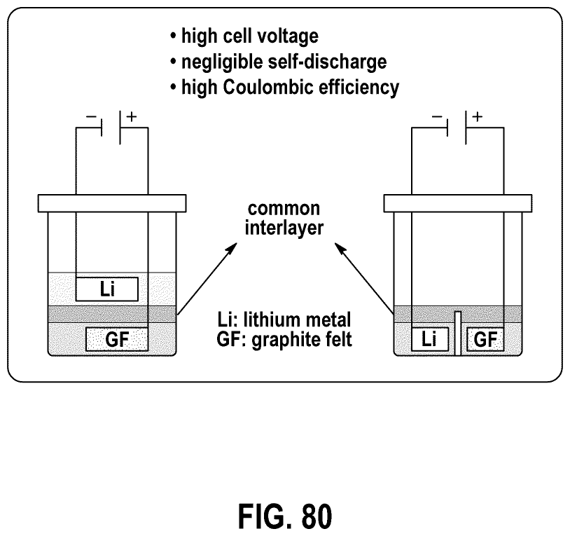

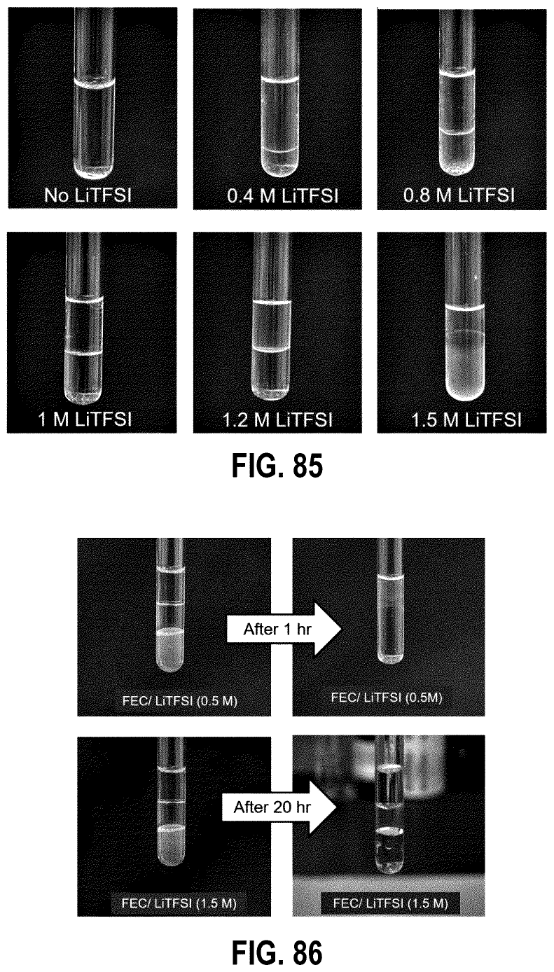

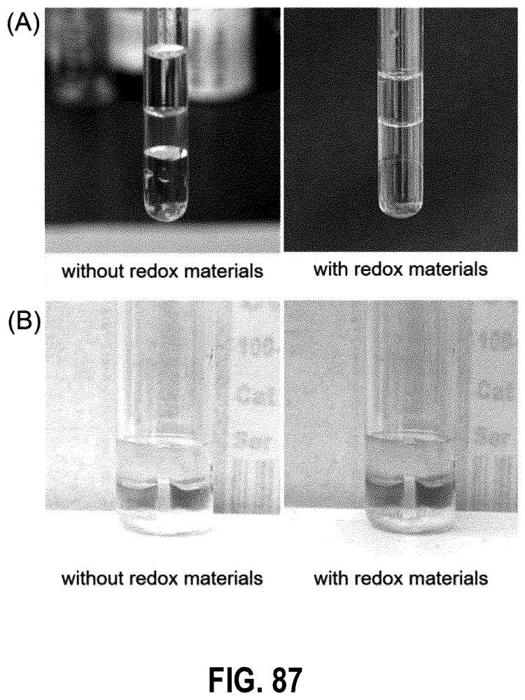

Design of the nonaqueous triphasic system. Designing an all-nonaqueous triphasic system with appropriate catholyte and anolyte materials is a significant challenge because of the complex interplay between the solubility of the active material and crossover. To successfully fabricate a high-performance membrane-free redox flow battery using a nonaqueous triphasic (three-layer) system, two primary requirements must be met. First, the three nonaqueous electrolytes must possess immiscibility, high ionic conductivity, and a wide electrochemical stability window. Second, the redox-active cathode material should exhibit high solubility in the catholyte layer and minimal solubility in the intermediate electrolyte layer or the anolyte during both the charging and discharging processes to prevent battery crossover-induced self-discharge. In this study, three triphasic systems were developed, each based on an all-nonaqueous electrolyte: propylene carbonate/NFTTS/1-Butyl-1-methylpyrrolidinium bis(trifluoromethylsulfonyl)imide, benzotrifluoride/1-ethyl-3-methylimidazolium tetrafluoroborate/NFTTS, and TEGDME/NFTTS/FEC. However, only TEGDME/NFTTS/FEC was studied for battery analysis due to its relatively lower cost compared to the remaining two systems. Three nonaqueous electrolytes, TEGDME, NFTTS, and FEC, were selected based on their desirable properties, including mutual immiscibility, high ionic conductivity, and key compatibility with Li metal anodes in lithium-ion batteries. The triphasic systems Design-I and -II were fabricated using the selected electrolytes (TEGDME, NFTTS, and FEC with lithium bis(trifluoromethanesulfonyl)imide (LiTFSI)), as shown in FIG. 80(A). Before fabricating the triphasic systems, individual electrolyte solutions were prepared for TEGDME, NFTTS, and FEC containing LiTFSI with specific quantities (FIGS. 85 and 86). The as-prepared electrolyte solutions exhibited gravimetric densities in the order of FEC/LiTFSI>NFTTS/LiTFSI>TEGDME/LiTFSI. Consequently, in the Design-I triphasic system, the electrolyte solutions were arranged as follows: FEC as the bottom layer, NFTTS as the middle layer, and TEGDME as the top layer (FIGS. 81(A) and 87(A)). The FEC, TEGDME, and NFTTS layers functioned as the catholyte, anolyte, and ion-exchange layers, respectively. Moreover, the NFTTS layer served as the separator, preventing direct contact between the FEC and TEGDME layers while facilitating the desired electrochemical processes.

Utilizing the inherent gravimetric density differences between the as-prepared electrolyte solutions, a Design-II triphasic system was developed using a glass vial with two compartments separated by a common divider (FIGS. 81(A) and 87(B)). Both compartments were filled with the FEC electrolyte solution, and the NFTTS electrolyte solution was added on top of each FEC-containing compartment. In this design, one side of the divider used the FEC electrolyte as the catholyte, whereas the other side used the FEC electrolyte as the anolyte. The strategic positioning of the NFTTS electrolyte as an interfacial layer enabled efficient ion transport and suppressed the crossover of redox species, ensuring appropriate functionality of the triphasic system while preserving the integrity of the electrochemical processes involved. The triphasic systems constructed in this study according to Design-I and —II, were thoroughly evaluated for their long-term charge/discharge performances.

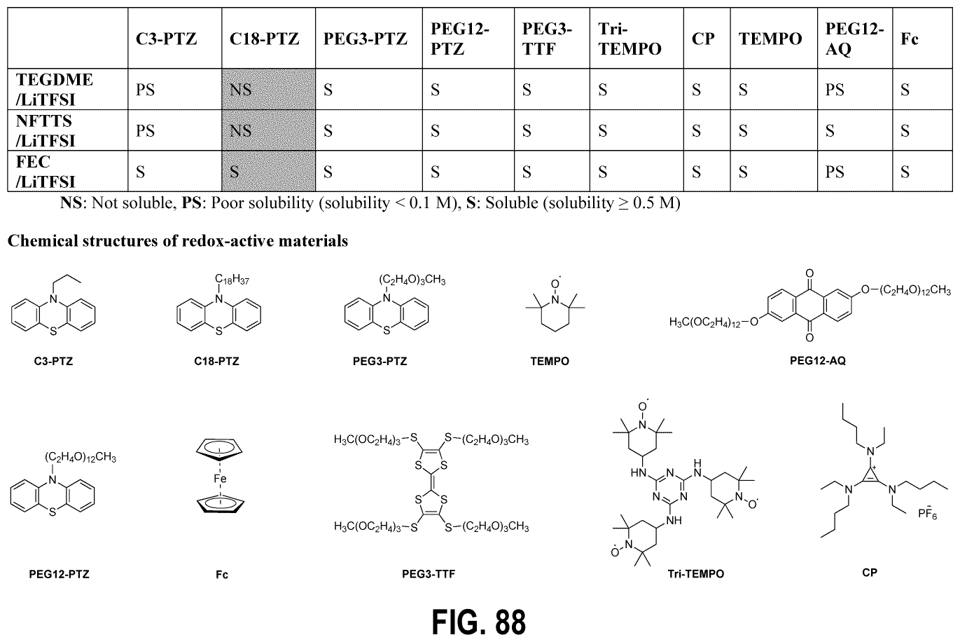

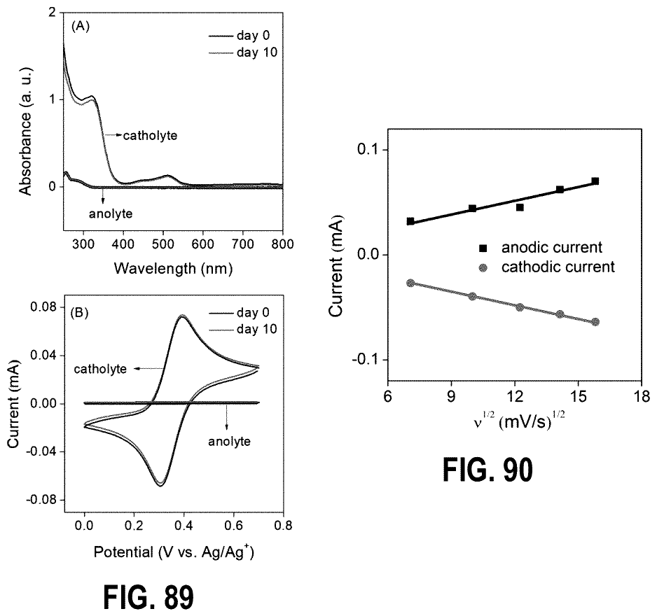

Selection of the anode and cathode materials. Achieving a high capacity for RFBs requires the selection of redox-active materials with high potential. In this study, Li metal was selected as the anode because of its low electrochemical potential (−3.04 V vs. a standard hydrogen electrode), high energy density, and theoretical capacity (~3,860 mAh/g). Graphite felt (GF) was selected as the cathode owing to its chemical inertness in nonaqueous electrolytes, high electrical conductivity, highly porous structure, and high specific surface area. To increase the Coulombic efficiency and suppress crossover, the solubility of the catholyte compounds in the catholyte solvent should be high, and the solubility in the separating and anolyte electrolytes should be minimal. The solubility properties of several redox-active catholyte compounds, including derivatives of phenothiazine, cyclopropenium, 2,2,6,6-tetramethylpiperidinyloxy (TEMPO), anthraquinone (AQ), and ferrocene, were evaluated as the three supporting electrolytes in the triphasic system (FIG. 88). The phenothiazine derivative C18-PTZ (FIG. 81(B)) exhibited high solubility in FEC and poor solubility in TEGDME and NFTTS. The solubility of C18-PTZ in FEC/LiTFSI (1.2 M) was determined to be 0.5 M. To investigate the confinement of C18-PTZ within the FEC layer, a crossover study was conducted using the triphasic system based on Design-I over a 10-day period under static conditions. The system was evaluated for the potential crossover of 0.5 M C18-PTZ dissolved in the FEC phase. Notably, no significant crossover was observed throughout the 10-day period, as confirmed by ultraviolet-visible spectroscopy (FIG. 89(A)) and cyclic voltammetry (CV) (FIG. 89(B)). These results demonstrate the effective confinement of C18-PTZ within the FEC layer. Based on these favorable results, C18-PTZ was selected as the cathode material for subsequent investigations.

Electrochemical characterization. CV was used to determine the redox potentials and evaluate the electrochemical stability of C18-PTZ in the FEC electrolyte. A well-defined redox couple (0.35 V vs. Ag/Ag⁺) was observed in FEC/LiTFSI (0.1 M). The almost identical voltammograms obtained after 500 cycles demonstrated the high electrochemical stability of C18-PTZ in the FEC/LiTFSI electrolyte (FIG. 81(C)). The peak potential separation of C18-PTZ at a scan rate of 50 mV/s was 68 mV, which is indicative of a one-electron redox process as per the Nernst equation. Moreover, the ratios of the cathodic peak current (i_{pc}) and anodic peak current (iₚₐ) at scan rates ranging from 50 to 250 mV/s were approximately 1 (FIGS. 81(D) and 81(E)), indicating high stability under different scan rates. Furthermore, the anodic and cathodic peak currents had a linear relationship with the square root of the scan rate (v^{1/2}, FIG. 90), indicating that the redox process is diffusion-controlled.

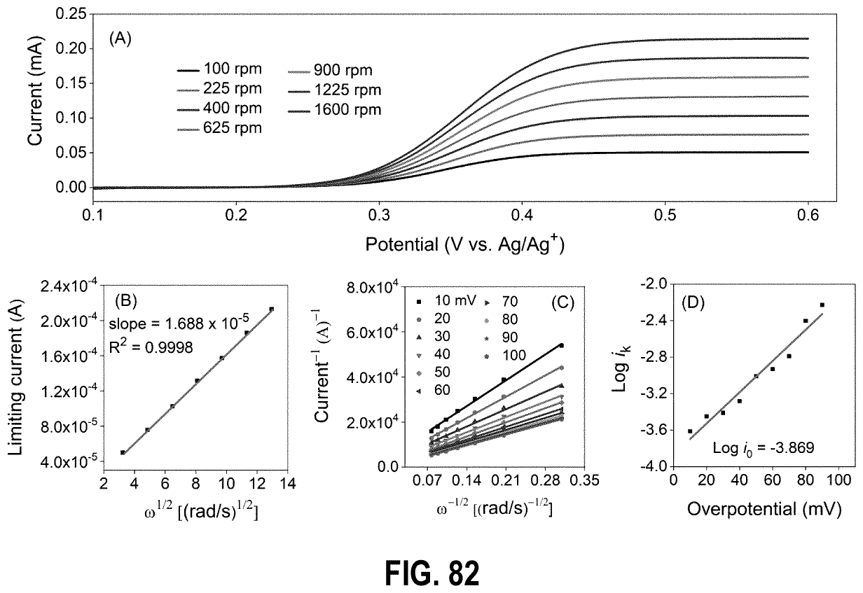

The diffusion coefficient D derived from the slopes of the linearly fitted Lévich plots was 6.23×10⁻⁶ cm²/s (FIG. 82(B)). The electrochemical kinetic rate constants of the charge-transfer reactions of C18-PTZ were obtained using the Koutecký-Lévich equation (Equation 1). The linear correlations between i⁻¹ and ω^{-1/2} for C18-PTZ at different overpotentials (r=10, 20, 30, 40, 50, 60, 70, 80, 90, and 100 mV) were used to estimate the iₖ values (FIG. 82(C)), which were obtained from the reciprocal of the Y-axis intercepts and plotted against the overpotential, as shown in FIG. 82(D). The kinetic rate constants (k₀) of C18-PTZ were calculated to be 3.51×10⁻³ cm s⁻¹ using Equation 1. The diffusion coefficients and rate constants of C18-PTZ are comparable to those of redox-active organic materials used in aqueous flow batteries.

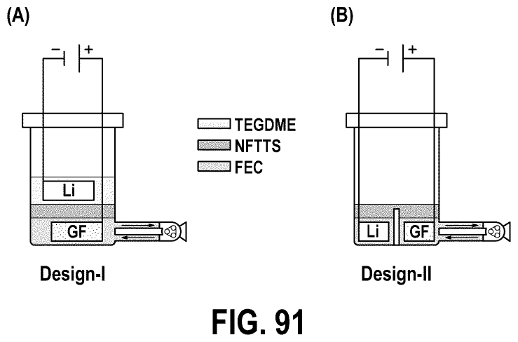

Charge/Discharge Performance. The charge/discharge performances of the nonaqueous triphasic systems (Design-I and -II) using C18-PTZ (0.5 M) in FEC (Design-I and -II) as the catholyte and Li metal in TEGDME (Design-I) and FEC (Design-II) as the anolyte were studied under both static and flow conditions. Schematics of the triphasic cell systems are shown in FIGS. 81(A) and 91.

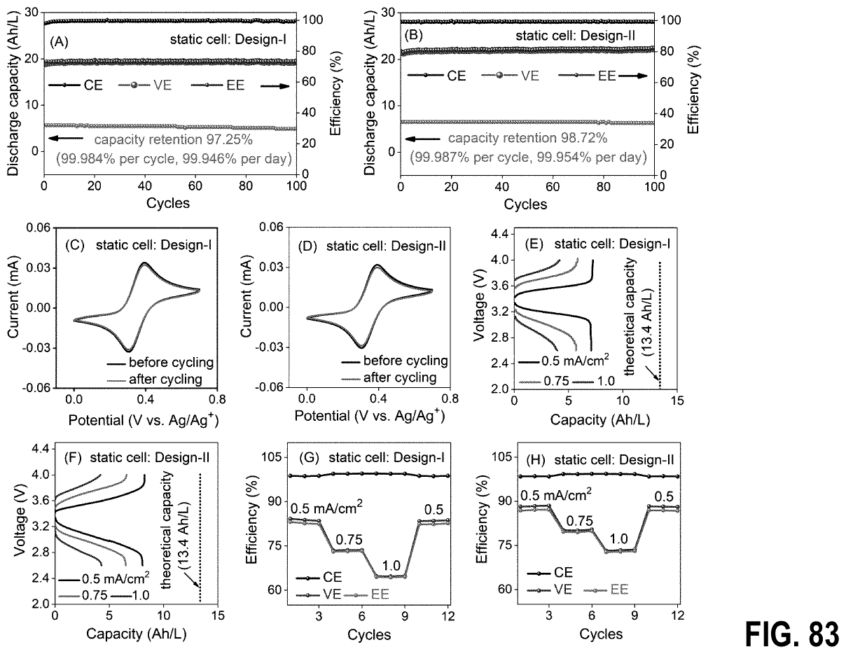

Under static conditions. Two triphasic cells based on Design-I and -II were assembled by pairing Li metal as the anode and C18-PTZ (0.5 M) as the cathode. To evaluate the battery cycling performances of the cells, they were subjected to charging and discharging within the voltage range of 4.0-2.6 V, as the cutoff limits. All charge/discharge experiments were performed in a glove box filled with an inert Ar atmosphere under normal conditions (27° C.). To evaluate the long-term cycling performances of the cells, they were operated for 100 for charge/discharge cycles at a current density of 0.75 mA/cm². For the Design-I and -II cells, the operation durations were 28 and 33 days, respectively. Both Li∥C18-PTZ (0.5 M) triphasic cells exhibited good cycling performances. The capacity retentions Design-I and -II were 97.25% (99.98% per cycle, 99.94% per day, FIG. 83(A)) and 98.72% (99.98% per cycle, 99.95% per day, FIG. 83(B)), respectively. The theoretical capacity utilization of the battery cells based on Design-I and -II were measured to be 52.2% and 58.6%, respectively. These results demonstrate that the combination of redox materials (Li and C18-PTZ), supporting electrolyte solvents (FEC and TEGDME), and electrolyte salt (LiTFSI) is not only compatible but also stable under real battery operating conditions. Additionally, both static batteries demonstrated high Coulombic efficiencies (approximately 100% for both cells) and energy efficiencies (74% for Design-I and 82% for Design-II), exceeding those of reported membrane-free batteries (80%-96%). The CV results of the pre- and post-cycling electrolytes for both triphasic static cells showed negligible changes in peak current densities (FIGS. 87(C) and 87(D)), suggesting that C18-PTZ remained confined within the catholyte during extended cycling. Thus, the battery cycling performance and post-cycling analysis confirmed the importance of the intermediate electrolyte layer (NFTTS) as an ion-exchange separator in the triphasic static system.

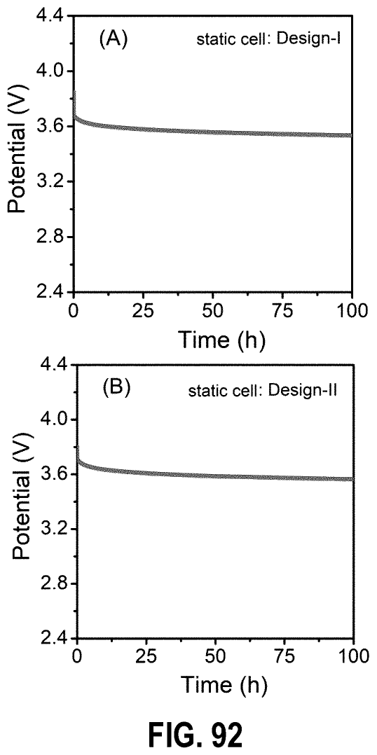

To investigate the self-discharge of the static membrane-free batteries, the open-circuit voltage (OCV) of the completely charged cells was monitored for 100 h. The OCV exhibited no significant voltage drop for either battery for over 100 h. The per-hour voltage loss was 0.45 mV/h for Design-I and 0.53 mV/h for Design-II (FIG. 92). Thus, the intermediate layer effectively eliminates self-discharge originating from the migration of the redox species from the catholyte to the anolyte. Moreover, these results demonstrate the high Coulombic efficiency and high capacity retentions of both batteries.

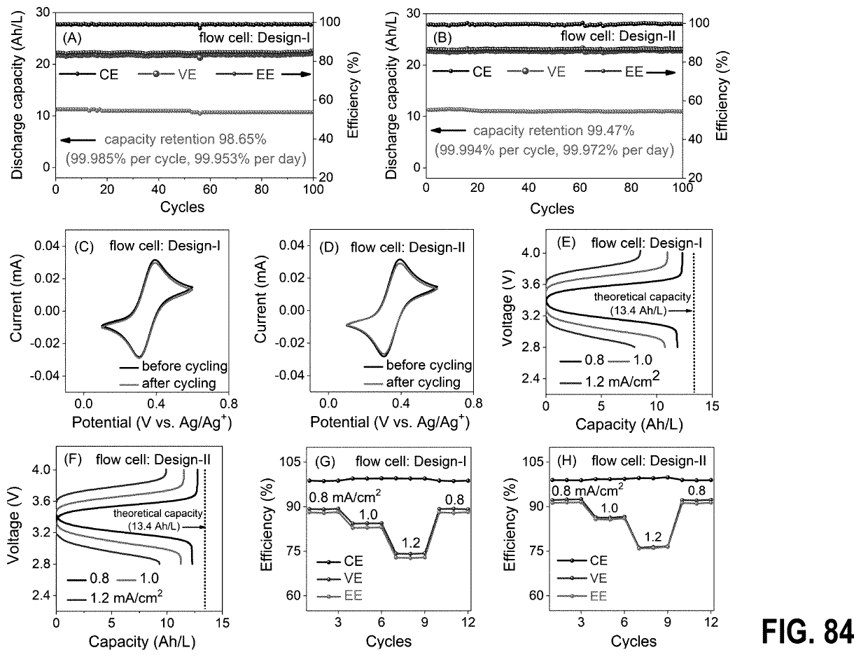

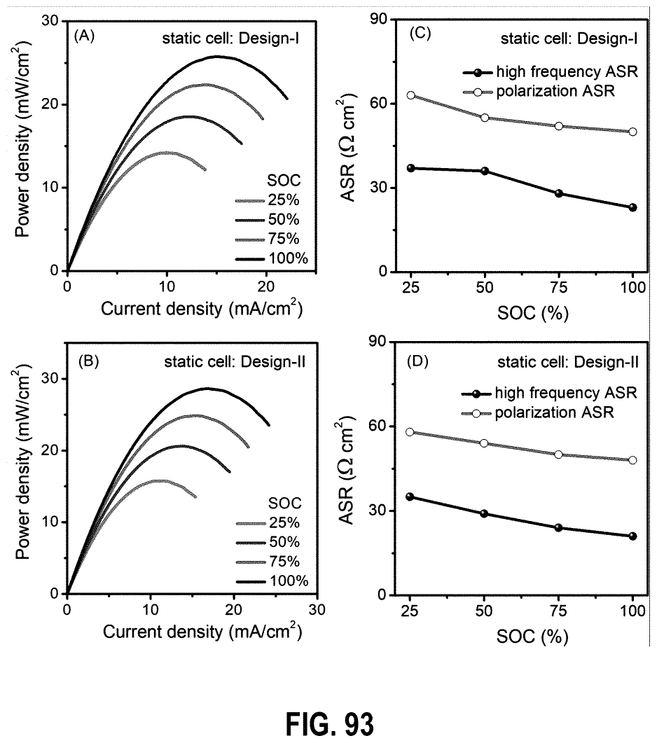

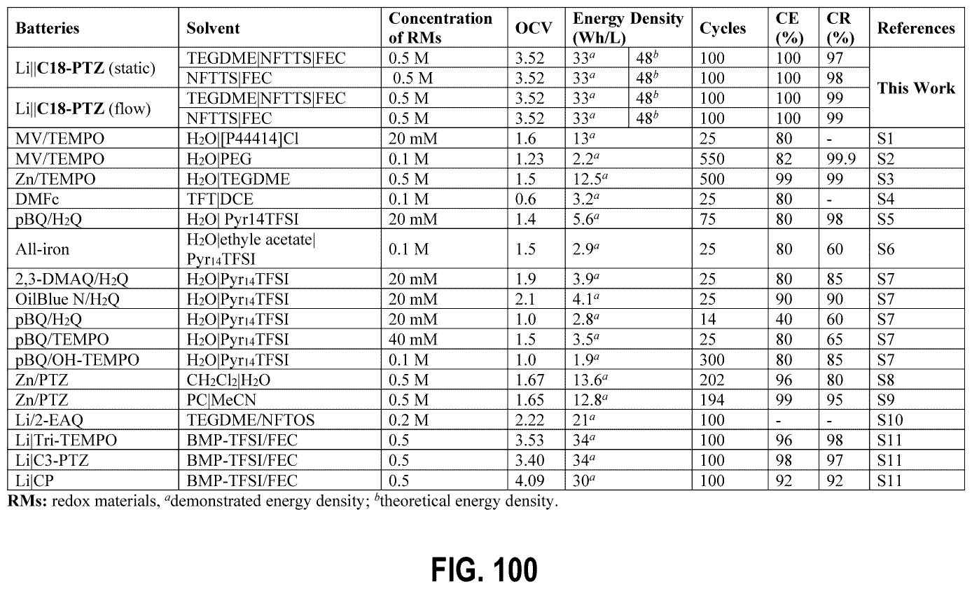

In addition, the effect of various charge/discharge current densities on the performance of the Li∥C18-PTZ (0.5 M) static cells was investigated. The cells (Design-I and -II) were subjected to cycling at current densities of 0.5, 0.75, and 1.0 mA/cm², respectively, and the average Coulombic efficiency, voltage efficiency, and energy efficiency values were determined at each current density over three cycles (FIGS. 83(g) and 83(h)). The static cells of Design-I and -II exhibited an increase in overpotential with increasing applied current density. The increase in the overpotential at higher current densities can be attributed to limited mass diffusion. Furthermore, both static cells (FIGS. 84(g) and 84(h)) showed Coulombic efficiencies close to 100%, which is higher compared to the performances of previously reported membrane-free systems (FIG. 100). When the applied current density was increased from 0.5 to 1.0 mA/cm², the energy efficiency values of the batteries decreased from 84% to 64% (Design-I) and 89% to 73% (Design-II). This is caused by the overpotential increase owing to mass transport losses. Notably, both the batteries regained their original efficiencies when cycled back at 0.5 mA/cm², thus confirming their improved charge-rate performances. In addition, the polarization of batteries based on Design-I and -II under static conditions was investigated at different states of charge (SOCs). The peak power densities of the batteries under static conditions were 27 mW/cm² (Design-I) (FIG. 93(A)) and 30 mW/cm² (Design-II) (FIG. 93(B)) at 100% SOC. Correspondingly, the area-specific resistance (ASR) for both the electrolyte and the entire battery under static conditions (Design-I and Design-II) was also investigated. The ASR of both the electrolyte and the entire battery decreased with increasing SOC. Moreover, the electrolyte contributed more than 60% (Design-I) (FIG. 93(C)) and 53% (Design-II) (FIG. 93(D)) of the resistance compared with the entire battery.

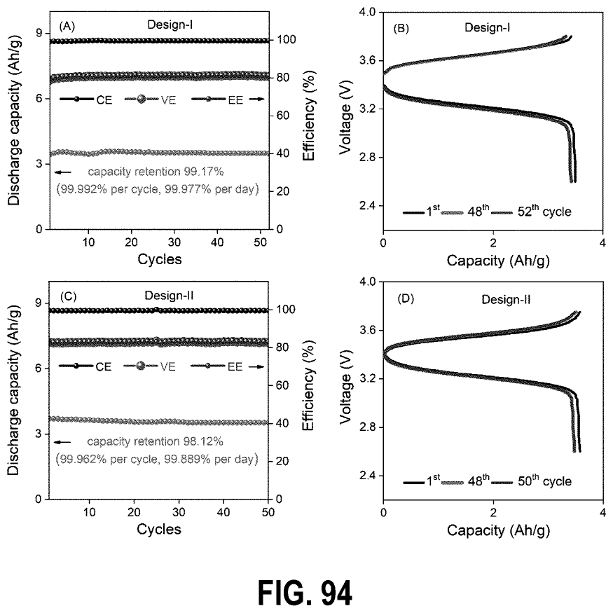

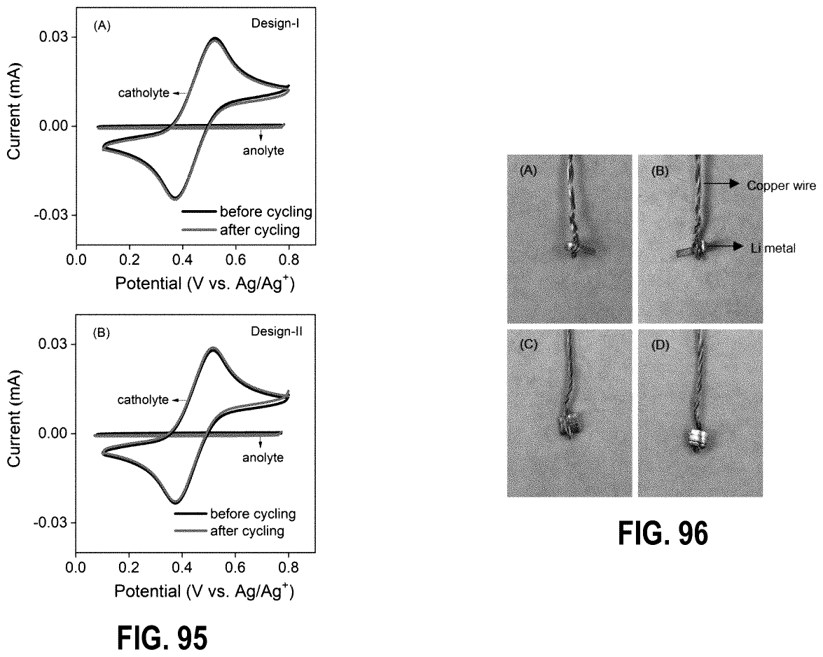

To study the cycling stability of the Li anode, we investigated the battery performance (Design-I and Design-II) utilizing a limited amount of Li metal anode (0.9 equivalent to the catholyte material) to further assess the efficacy of our developed triphasic electrolyte system. Both batteries underwent 50 charge/discharge cycles (approximately 17 days), with continuous monitoring of their capacity over time. The results indicate that both batteries exhibited capacity retention of 99.17% for Design-I (FIGS. 94(A) and 94(B)) and 98.12% for Design-II (FIGS. 94(C) and 94(D)) and Coulombic efficiencies of nearly 100%. CV analysis of pre- and post-cycled catholytes and anolytes of batteries based on Design-I (FIG. 95(A)) and Design-II (FIG. 95(B)) suggest negligible crossover of active materials. Moreover, the digital images of pre- and post-cycled Li metal anode of batteries based on Design-I and Design-II (FIG. 96) show no signs of dendrite formation. Therefore, the notable capacity retention observed in both batteries demonstrates the good state of health of the Li metal anode and highlights the better efficacy of the developed triphasic electrolyte system.

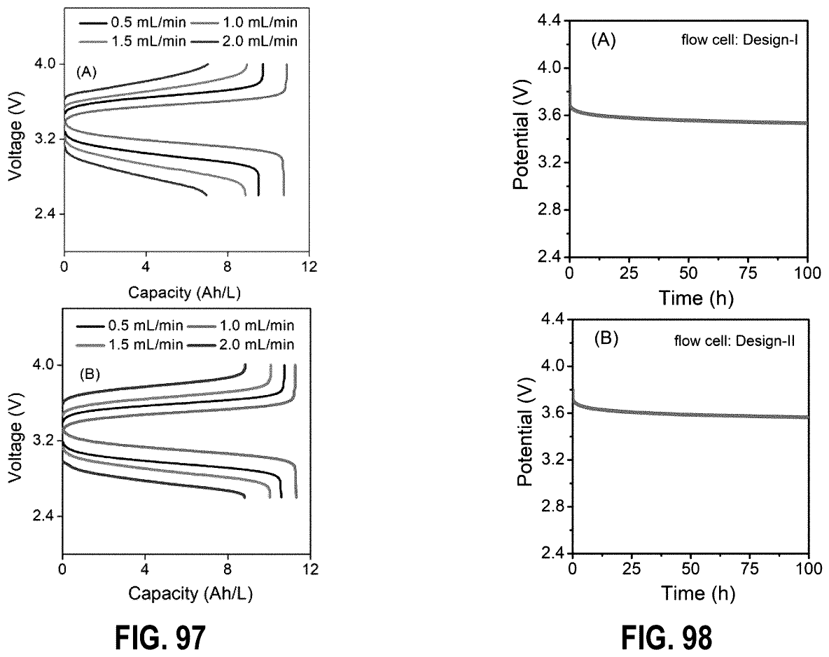

Under flow conditions. While the static triphasic membrane-free batteries demonstrated a notable charge/discharge performance with a Coulombic efficiency of nearly 100% and improved capacity retention, the limited mass-transfer conditions resulted in low capacity utilization. In addition, independent scaling of energy and power is challenging under static conditions. To evaluate the efficacy of the triphasic system under flow conditions and enable the independent scaling of power and energy, membrane-free triphasic flow cells based on Design-I and -II were evaluated for long-term charge/discharge cycling using a flowing catholyte. The flow conditions were optimized by evaluating the charge/discharge performance of Li∥C18-PTZ (0.5 M) flow cells with Design-I (FIG. 97(A)) and Design-II (FIG. 97(B)) at various catholyte flow rates (0.5 to 2.0 mL/min) at a current density of 1 mA/cm². Consequently, an optimal flow rate of 1.0 mL/min was selected to perform long-duration cycling. At this flow rate, the flow cells of Design-I and -II showed improved capacity retentions of 98.65% (99.985% per cycle, 99.953% per day) and 99.47% (99.994% per cycle, 99.972% per day), respectively (FIGS. 83(A) and 83(B)). Design-I (FIG. 84(A)) exhibited a Coulombic efficiency of ~100%, voltage efficiency of ~84%, and energy efficiency of ~83%, whereas Design-II exhibited a Coulombic efficiency of ~100%, voltage efficiency of ~88%, and energy efficiency of ~87% (FIG. 84(B)). No obvious change in the CV current densities of the post-cycled batteries was observed, confirming the high stability of the redox-active materials, with no crossover of the active material to the interfacial layer (FIGS. 83(C) and 83(D)). Both designs exhibited improved performance in terms of efficiency and retention compared to those reported previously (FIG. 100).

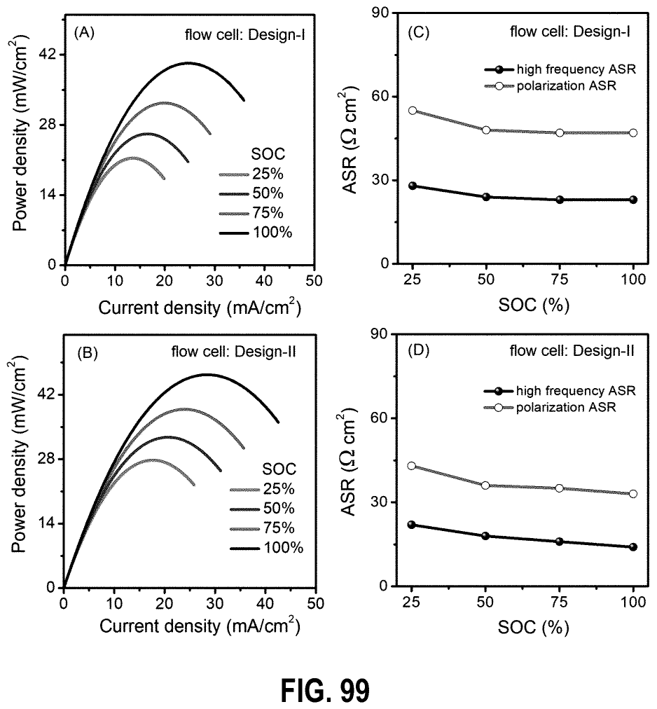

The OCV of the completely charged cells was observed for 100 h to evaluate the effect of electrolyte flow on the self-discharge of the cells (FIGS. 97(A) and 97(B)). Over the investigated period, minimal decay in the OCV values (0.57 mV/h for Design-I and 0.49 mV/h for Design-II) was observed, which confirmed the absence of self-discharge in the cells. Thus, replacing the biphasic interface with an electrolyte layer can eliminate the interfacial self-discharge and crossover of active materials under convective mass transport using electrolyte-flowing conditions. The charge rate performances of the Li∥C18-PTZ (0.5 M) flow cells based on Design-I and -II were evaluated at current densities of 0.8, 1.0, and 1.2 mA/cm², and the corresponding cycling profiles, as well as the Coulombic efficiency, voltage efficiency, and energy efficiency values were measured for an average of three cycles. Similar to the static cells, the flow cells exhibited an increase in overpotential with increasing applied current density (FIGS. 83(E) and 83(F)). This increase in overpotential is attributed to the induced transport losses that occur at higher current densities. The Coulombic efficiency of the cells remained at 100% for all current densities; however, the voltage efficiency and energy efficiency values decayed with increasing current density. The increase in the overpotential and the corresponding reduction in voltage efficiency at higher current densities may be attributed to mass transport limitations (FIGS. 83(G) and 83(H)). Both cells regained their original performances when cycled back at 0.8 mA/cm². Furthermore, the triphasic cells under flow conditions exhibited improved capacity utilization compared to the static cells (80% for Design-I and 84% for Design-II under flow conditions at 1 mA/cm² compared to 42% for Design-I and 48% for Design-II under static conditions at 0.75 mA/cm²), indicating that the flow of electrolytes significantly reduced the mass transport limitations of the static battery. As a result of the enhanced mass transport, the triphasic batteries exhibited higher peak power densities under flow conditions compared to static conditions. Specifically, Design-I achieved a peak power density of 39 mW/cm² (FIG. 99(A)), while Design-II reached an even higher peak power density of 46 mW/cm² (FIG. 99(B)). The ASR results for both the electrolyte and the entire battery under flow conditions indicated that the electrolyte resistance accounted for over 58% (Design-I) (FIG. 99(C)) and 47% (Design-II) (FIG. 99(D)) of the entire battery. Thus, the ASR of the electrolyte and the entire battery are significantly reduced under flow conditions, allowing for higher current densities without compromising the performance. The relatively low power densities compared to these of conventional aqueous membrane-based redox flow batteries can be attributed to the reduced ionic conductivity of nonaqueous solvents and increased mass transfer resistance from the triphasic interface.

In summary, to overcome the challenges associated with the biphasic electrolyte approach, a triphasic liquid/liquid system with two new strategic designs (Design-I and -II) was proposed. In contrast to biphasic systems, the novel developed triphasic system features an additional electrolyte layer to separate the anolyte and catholyte, eliminating self-discharge and providing high Coulombic efficiency and capacity retention. The intermediate layer enabled improved cycling performance and the flow of the electrolyte to achieve decoupled energy and power studies. The triphasic batteries based on the two novel designs were assembled using Li metal as the anode and a phenothiazine derivative C18-PTZ (0.5 M) as the cathode. The cycling performances of the triphasic membrane-free batteries based on Design-I and -II were evaluated under static and flow conditions. Static batteries based on Design-I and -II yielded outstanding cycling performance with high capacity retentions of 97.25% and 98.72%, respectively, and Coulombic efficiencies close to 100%. However, under static conditions, the capacity utilization of the batteries was lower owing to limited mass transport. To enhance capacity utilization and enable the decoupled scaling of energy and power, flow conditions were introduced for both designs of the triphasic system using an optimized flow rate of 1 mL/min. Flow batteries based on these designs exhibit significantly higher capacity utilization than static batteries. Moreover, Design-I and -II flow batteries achieved improved capacity retentions of 98.65% and 99.47%, respectively, with Coulombic efficiencies close to 100% under flow conditions. The peak power densities of the Design I and II batteries under static conditions were 27 and 30 mW/cm², respectively, whereas those under flow conditions increased to 39 and 46 mW/cm², respectively. The improved power densities of the flow batteries were attributed to the lowered electrolyte resistance resulting from enhanced mass transport compared with static batteries. Therefore, the outstanding performance of the nonaqueous triphasic system provides a novel strategy for developing membrane-free, nonaqueous batteries with high voltage, high Coulombic efficiency (close to 100%), improved capacity utilization, and high capacity retention.

### Part G

Liquid/liquid biphasic batteries without a membrane could be promising models of redox flow batteries. However, such batteries inherently undergo self-discharge at the liquid/liquid interface, resulting in low Coulombic efficiency and poor capacity retention. Herein, we report a triphasic system comprising all-nonaqueous electrolytes to overcome those challenges in biphasic systems. By incorporating a third electrolyte layer to separate the anolyte and catholyte, the system effectively impeded the self-discharge event without compromising the Coulombic efficiency and capacity retention. Li metal anode and phenothiazine derivative C18-PTZ (0.5 M) cathode have been used to construct the electrochemical cell. Moreover, we have designed two all-nonaqueous triphasic models either stacking the phases vertically or physically separating two phases side-wise along with a common interfacial layer at the top. Interestingly, both designs showed high capacity retention under static (~98%, 31 days, 100 cycles) and flow (~99%, 39 days, 100 cycles) conditions. Moreover, all batteries exhibited an average Coulombic efficiency of nearly 100%.

Global energy and climate challenges require the transition from fossil fuels to renewable energy resources, including, but not limited to solar, wind, and hydroelectric power, driving the utilization of large-scale energy storage devices. Redox flow batteries (RFBs) could be promising energy storage devices due to their unique properties, including high scalability, decoupled energy and power, and high safety. In the conventional RFB configuration, redox-active materials are dissolved in solvents to form a catholyte and anolyte, which are stored separately in external tanks. Depending on the electrolyte used, RFBs can be classified as either aqueous RFBs (ARFBs) or nonaqueous RFBs (NRFBs). Although ARFBs are safer and more cost-effective, they typically have a narrow voltage window (<1.6 V) due to the low thermodynamic stability of water. In contrast, NRFBs have a higher electrochemical window (~5.5 V), but they are associated with other challenges such as low ionic conductivity, high flammability, and the high cost of organic electrolytes. Additionally, NRFBs face the significant challenge of redoxmer crossover due to the lack of appropriate membranes in nonaqueous media, ultimately impacting the overall battery performance. To optimize RFB performance, it is crucial to develop membranes with high ionic conductivity, molecular selectivity, stability, and low cost.

An alternative strategy to address the aforementioned issues is the fabrication of RFBs without a membrane separator. This approach, demonstrated by our group and several other researchers, involves utilizing immiscible aqueous/nonaqueous electrolytes. This biphasic system consists of two immiscible electrolytes with different densities and a suitable partition coefficient, forming two phases with a common interface. This interface functions as a separator between the anolyte and the catholyte. However, membrane-free batteries with nonaqueous/nonaqueous electrolytes are rarely reported because of challenges in designing and selecting suitable solvents and redox-active materials. Although membrane-free biphasic batteries are promising, they face significant challenges that limit their practical application. These challenges include capacity loss due to the mixing of the anolyte and catholyte at the interface, self-discharge induced by interfacial ion migration during the solvation/desolvation process (rate of solvent diffusion), and low capacity utilization owing to poor mass transfer under static conditions. Additionally, compared with membrane-based RFBs, membrane-free batteries exhibit an unstable liquid/liquid interface that can significantly disrupt the thermodynamic balance under flow conditions. Active material crossover by convective mass transport under flow conditions further exacerbates capacity loss.

This study presents a new strategy by introducing a third layer as an ion-selective membrane to facilitate the separation of the anolyte and catholyte, alleviate self-discharge, and achieve high Coulombic efficiency. The introduction of an interfacial electrolyte layer in the liquid/liquid triphasic system not only effectively separates the anolyte and catholyte but also facilitates convenient electrolyte flow (anolyte or catholyte) without disturbing the thermodynamic balance of the electrolyte phases, even at high flow rates. This new approach enables the triphasic system to overcome the limitations of biphasic membrane-free batteries, resulting in improved capacity utilization and performance under flow conditions. The triphasic all-nonaqueous strategy is implemented using two distinct cell designs (see FIG. 81(A)). Three nonaqueous electrolytes, tetraethylene glycol dimethyl ether (TEGDME), nonafluoro-1,1,2,2-tetrahydrohexyl-trimethoxysilane (NFTTS), and fluoroethylene carbonate (FEC) are used in the membrane-free batteries with Li metal and a phenothiazine derivative as the anode and cathode materials, respectively, resulting in a cell voltage of 3.52 V. The cycling performances of triphasic membrane-free batteries based on both designs are evaluated under static and flow conditions. All batteries exhibited outstanding cycling performances with capacity retentions under static conditions (~98%, 31 days, 100 cycles) and flow conditions (~99%, 39 days, 100 cycles). Furthermore, all the batteries demonstrated an average Coulombic efficiency of nearly 100% under both static and flow conditions.

This study introduces three new triphasic configurations based on all non-aqueous electrolyte systems, utilizing various electrolyte solvents and salts. These configurations exhibit versatility beyond specific redox-active cathode materials. The combinations of electrolyte solvents and salts offer opportunities to explore a wide range of redox-active cathode and anode materials with varying solubility, paving the way for high-performance membrane-free redox flow batteries. In addition, it effectively addresses issues in conventional RFBs, such as membrane limitations and high costs. Furthermore, it tackles challenges related to self-discharge, low Coulombic efficiency, and crossover of redox materials during electrolyte flow in biphasic membrane-free batteries, demonstrating its broad applicability and improved performance across diverse battery chemistries.

Design of the nonaqueous triphasic system. Designing an all-nonaqueous triphasic system with appropriate catholyte and anolyte materials is a significant challenge because of the complex interplay between the solubility of the active material and crossover. To successfully fabricate a high-performance membrane-free redox flow battery using a nonaqueous triphasic (three-layer) system, two primary requirements must be met. First, the three nonaqueous electrolytes must possess immiscibility, high ionic conductivity, and a wide electrochemical stability window. Second, the redox-active cathode material should exhibit high solubility in the catholyte layer and minimal solubility in the intermediate electrolyte layer or the anolyte during both the charging and discharging processes to prevent battery crossover-induced self-discharge. In this study, three triphasic systems were developed, each based on an all-nonaqueous electrolyte: propylene carbonate/NFTTS/1-Butyl-1-methylpyrrolidinium bis(trifluoromethylsulfonyl)imide, benzotrifluoride/1-ethyl-3-methylimidazolium tetrafluoroborate/NFTTS, and TEGDME/NFTTS/FEC. However, only TEGDME/NFTTS/FEC was studied for battery analysis due to its relatively lower cost compared to the remaining two systems. Three nonaqueous electrolytes, TEGDME, NFTTS, and FEC, were selected based on their desirable properties, including mutual immiscibility, high ionic conductivity, and key compatibility with Li metal anodes in lithium-ion batteries.30,35-36 The triphasic systems Design-I and -II were fabricated using the selected electrolytes (TEGDME, NFTTS, and FEC with lithium bis(trifluoromethanesulfonyl)imide (LiTFSI)), as shown in FIG. 81(A). Before fabricating the triphasic systems, individual electrolyte solutions were prepared for TEGDME, NFTTS, and FEC containing LiTFSI with specific quantities (FIGS. 85 and 86). The as-prepared electrolyte solutions exhibited gravimetric densities in the order of FEC/LiTFSI>NFTTS/LiTFSI>TEGDME/LiTFSI. Consequently, in the Design-I triphasic system, the electrolyte solutions were arranged as follows: FEC as the bottom layer, NFTTS as the middle layer, and TEGDME as the top layer (FIGS. 81(A) and 87(A)). The FEC, TEGDME, and NFTTS layers functioned as the catholyte, anolyte, and ion-exchange layers, respectively. Moreover, the NFTTS layer served as the separator, preventing direct contact between the FEC and TEGDME layers while facilitating the desired electrochemical processes.

To effectively construct a stable triphasic system for an energy storage battery, several essential criteria must be followed/satisfied. First, gravimetric density differences are required between the solvents to enable self-stratification, facilitating the formation of three distinct phases. Second, mutual immiscibility is crucial; the top, anolyte phase should be immiscible with the middle, electrolyte phase, and the middle, electrolyte phase, should be immiscible with the bottom, catholyte phase. Third, in conjunction with the aforementioned criteria, the redox-active cathode must remain confined within the catholyte phase, preventing crossover to either the middle, electrolyte phase or anolyte phase. Using this approach, three triphasic systems were developed based on an all-nonaqueous electrolyte: PC/NFTTS/BMP-TFSI, BTF/EMI-BF₄/NFTTS, and TEGDME/NFTTS/FEC. The outlined procedure ensures the fulfillment of these criteria and can be applied to fabricate numerous other nonaqueous/nonaqueous triphasic electrolyte systems for advanced energy storage batteries.

Utilizing the inherent gravimetric density differences between the as-prepared electrolyte solutions, a Design-II triphasic system was developed using a glass vial with two compartments separated by a common divider (FIGS. 81(A) and 87(B)). Both compartments were filled with the FEC electrolyte solution, and the NFTTS electrolyte solution was added on top of each FEC-containing compartment. In this design, one side of the divider used the FEC electrolyte as the catholyte, whereas the other side used the FEC electrolyte as the anolyte. The strategic positioning of the NFTTS electrolyte as an interfacial layer enabled efficient ion transport and suppressed the crossover of redox species, ensuring appropriate functionality of the triphasic system while preserving the integrity of the electrochemical processes involved. The triphasic systems constructed in this study according to Design-I and —II, were thoroughly evaluated for their long-term charge/discharge performances.

Selection of the anode and cathode materials. Achieving a high capacity for RFBs requires the selection of redox-active materials with high potential. In this study, Li metal was selected as the anode because of its low electrochemical potential (−3.04 V vs. a standard hydrogen electrode), high energy density, and theoretical capacity (~3,860 mAh/g). Graphite felt (GF) was selected as the cathode owing to its chemical inertness in nonaqueous electrolytes, high electrical conductivity, highly porous structure, and high specific surface area. To increase the Coulombic efficiency and suppress crossover, the solubility of the catholyte compounds in the catholyte solvent should be high, and the solubility in the separating and anolyte electrolytes should be minimal. The solubility properties of several redox-active catholyte compounds, including derivatives of phenothiazine, cyclopropenium, 2,2,6,6-tetramethylpiperidinyloxy (TEMPO), anthraquinone (AQ), and ferrocene, were evaluated as the three supporting electrolytes in the triphasic system (FIG. 85). The phenothiazine derivative C18-PTZ (FIG. 81(B)) exhibited high solubility in FEC and poor solubility in TEGDME and NFTTS (see the Supporting Information for details on the solubility tests). The solubility of C18-PTZ in FEC/LiTFSI (1.2 M) was determined to be 0.5 M. To investigate the confinement of C18-PTZ within the FEC layer, a crossover study was conducted using the triphasic system based on Design-I over a 10-day period under static conditions. The system was evaluated for the potential crossover of 0.5 M C18-PTZ dissolved in the FEC phase. Notably, no significant crossover was observed throughout the 10-day period, as confirmed by ultraviolet-visible spectroscopy (FIG. 89(A)) and cyclic voltammetry (CV) (FIG. 89(B)). These results demonstrate the effective confinement of C18-PTZ within the FEC layer. Based on these favorable results, C18-PTZ was selected as the cathode material for subsequent investigations.

Electrochemical characterization. CV was used to determine the redox potentials and evaluate the electrochemical stability of C18-PTZ in the FEC electrolyte. A well-defined redox couple (0.35 V vs. Ag/Ag⁺) was observed in FEC/LiTFSI (0.1 M). The almost identical voltammograms obtained after 500 cycles demonstrated the high electrochemical stability of C18-PTZ in the FEC/LiTFSI electrolyte (FIG. 81(C)). The peak potential separation of C18-PTZ at a scan rate of 50 mV/s was 68 mV, which is indicative of a one-electron redox process as per the Nernst equation. Moreover, the ratios of the cathodic peak current (ipc) and anodic peak current (ipa) at scan rates ranging from 50 to 250 mV/s were approximately 1 (FIGS. 81(D) and 81(E)), indicating high stability under different scan rates. Furthermore, the anodic and cathodic peak currents had a linear relationship with the square root of the scan rate (v1/2, FIG. S5), indicating that the redox process is diffusion-controlled.

The diffusion coefficient D derived from the slopes of the linearly fitted Lévich plots was 6.23×10-6 cm²/s (FIG. 82(B)). The electrochemical kinetic rate constants of the charge-transfer reactions of C18-PTZ were obtained using the Koutecký-Lévich equation (Equation 1). The linear correlations between i⁻¹ and ω^{-1/2} for C18-PTZ at different overpotentials (η=10, 20, 30, 40, 50, 60, 70, 80, 90, and 100 mV) were used to estimate the iₖ values (FIG. 82(C)), which were obtained from the reciprocal of the Y-axis intercepts and plotted against the overpotential, as shown in FIG. 82(D). The kinetic rate constants (k₀) of C18-PTZ were calculated to be 3.51×10-3 cm s⁻¹ using Equation 1. The diffusion coefficients and rate constants of C18-PTZ are comparable to those of redox-active organic materials used in aqueous flow batteries.

Charge/Discharge Performance. The charge/discharge performances of the nonaqueous triphasic systems (Design-I and -II) using C18-PTZ (0.5 M) in FEC (Design-I and -II) as the catholyte and Li metal in TEGDME (Design-I) and FEC (Design-II) as the anolyte were studied under both static and flow conditions. Schematics of the triphasic cell systems are shown in FIGS. 81(A) and 91.

Under static conditions. Two triphasic cells based on Design-I and -II were assembled by pairing Li metal as the anode and C18-PTZ (0.5 M) as the cathode. To evaluate the battery cycling performances of the cells, they were subjected to charging and discharging within the voltage range of 4.0-2.6 V, as the cutoff limits. All charge/discharge experiments were performed in a glove box filled with an inert Ar atmosphere under normal conditions (27° C.). To evaluate the long-term cycling performances of the cells, they were operated for 100 for charge/discharge cycles at a current density of 0.75 mA/cm². For the Design-I and -II cells, the operation durations were 28 and 33 days, respectively. Both Li∥C18-PTZ (0.5 M) triphasic cells exhibited good cycling performances. The capacity retentions Design-I and -II were 97.25% (99.98% per cycle, 99.94% per day, FIG. 83(A)) and 98.72% (99.98% per cycle, 99.95% per day, FIG. 83(B)), respectively. The theoretical capacity utilization of the battery cells based on Design-I and -II were measured to be 52.2% and 58.6%, respectively. These results demonstrate that the combination of redox materials (Li and C18-PTZ), supporting electrolyte solvents (FEC and TEGDME), and electrolyte salt (LiTFSI) is not only compatible but also stable under real battery operating conditions. Additionally, both static batteries demonstrated high Coulombic efficiencies (approximately 100% for both cells) and energy efficiencies (74% for Design-I and 82% for Design-II), exceeding those of reported membrane-free batteries (80%-96%). The CV results of the pre- and post-cycling electrolytes for both triphasic static cells showed negligible changes in peak current densities (FIGS. 83(C) and 83(D)), suggesting that C18-PTZ remained confined within the catholyte during extended cycling. Thus, the battery cycling performance and post-cycling analysis confirmed the importance of the intermediate electrolyte layer (NFTTS) as an ion-exchange separator in the triphasic static system.

To investigate the self-discharge of the static membrane-free batteries, the open-circuit voltage (OCV) of the completely charged cells was monitored for 100 h. The OCV exhibited no significant voltage drop for either battery for over 100 h. The per-hour voltage loss was 0.45 mV/h for Design-I and 0.53 mV/h for Design-II (FIG. 92). Thus, the intermediate layer effectively eliminates self-discharge originating from the migration of the redox species from the catholyte to the anolyte. Moreover, these results demonstrate the high Coulombic efficiency and high capacity retentions of both batteries.

In addition, the effect of various charge/discharge current densities on the performance of the Li∥C18-PTZ (0.5 M) static cells was investigated. The cells (Design-I and -II) were subjected to cycling at current densities of 0.5, 0.75, and 1.0 mA/cm², respectively, and the average Coulombic efficiency, voltage efficiency, and energy efficiency values were determined at each current density over three cycles (FIGS. 83(G) and 83(H)). The static cells of Design-I and -II exhibited an increase in overpotential with increasing applied current density. The increase in the overpotential at higher current densities can be attributed to limited mass diffusion. Furthermore, both static cells (FIGS. 83(G) and 83(H)) showed Coulombic efficiencies close to 100%, which is higher compared to the performances of previously reported membrane-free systems (FIG. 86). When the applied current density was increased from 0.5 to 1.0 mA/cm2, the energy efficiency values of the batteries decreased from 84% to 64% (Design-I) and 89% to 73% (Design-II). This is caused by the overpotential increase owing to mass transport losses. Notably, both the batteries regained their original efficiencies when cycled back at 0.5 mA/cm², thus confirming their improved charge-rate performances. In addition, the polarization of batteries based on Design-I and -II under static conditions was investigated at different states of charge (SOCs). The peak power densities of the batteries under static conditions were 27 mW/cm² (Design-I) (FIG. 93(A)) and 30 mW/cm² (Design-II) (FIG. 93(B)) at 100% SOC. Correspondingly, the area-specific resistance (ASR) for both the electrolyte and the entire battery under static conditions (Design-I and Design-II) was also investigated. The ASR of both the electrolyte and the entire battery decreased with increasing SOC. Moreover, the electrolyte contributed more than 60% (Design-I) (FIG. 93(C)) and 53% (Design-II) (FIG. 93(D)) of the resistance compared with the entire battery.

To study the cycling stability of the Li anode, we investigated the battery performance (Design-I and Design-II) utilizing a limited amount of Li metal anode (0.9 equivalent to the catholyte material) to further assess the efficacy of our developed triphasic electrolyte system. Both batteries underwent 50 charge/discharge cycles (approximately 17 days), with continuous monitoring of their capacity over time. The results indicate that both batteries exhibited capacity retention of 99.17% for Design-I (FIGS. 94(A) and 94(B)) and 98.12% for Design-II (FIGS. 94(C) and 94(D)) and Coulombic efficiencies of nearly 100%. CV analysis of pre- and post-cycled catholytes and anolytes of batteries based on Design-I (FIG. 95(A)) and Design-II (FIG. 95(B)) suggest negligible crossover of active materials. Moreover, the digital images of pre- and post-cycled Li metal anode of batteries based on Design-I and Design-II (FIG. 96) show no signs of dendrite formation. Therefore, the notable capacity retention observed in both batteries demonstrates the good state of health of the Li metal anode and highlights the better efficacy of the developed triphasic electrolyte system.

Under flow conditions. While the static triphasic membrane-free batteries demonstrated a notable charge/discharge performance with a Coulombic efficiency of nearly 100% and improved capacity retention, the limited mass-transfer conditions resulted in low capacity utilization. In addition, independent scaling of energy and power is challenging under static conditions. To evaluate the efficacy of the triphasic system under flow conditions and enable the independent scaling of power and energy, membrane-free triphasic flow cells based on Design-I and -II were evaluated for long-term charge/discharge cycling using a flowing catholyte. The flow conditions were optimized by evaluating the charge/discharge performance of Li∥C18-PTZ (0.5 M) flow cells with Design-I (FIG. 97(A)) and Design-II (FIG. 97(B)) at various catholyte flow rates (0.5 to 2.0 mL/min) at a current density of 1 mA/cm². Consequently, an optimal flow rate of 1.0 mL/min was selected to perform long-duration cycling. At this flow rate, the flow cells of Design-I and -II showed improved capacity retentions of 98.65% (99.985% per cycle, 99.953% per day) and 99.47% (99.994% per cycle, 99.972% per day), respectively (FIGS. 84(A) and 84(B)). Design-I (FIG. 84(A)) exhibited a Coulombic efficiency of ~100%, voltage efficiency of ~84%, and energy efficiency of ~83%, whereas Design-II exhibited a Coulombic efficiency of ~100%, voltage efficiency of ~88%, and energy efficiency of ~87% (FIG. 84(B)). No obvious change in the CV current densities of the post-cycled batteries was observed, confirming the high stability of the redox-active materials, with no crossover of the active material to the interfacial layer (FIGS. 84(C) and 84(D)). Both designs exhibited improved performance in terms of efficiency and retention compared to those reported previously (FIG. 100).

The OCV of the completely charged cells was observed for 100 h to evaluate the effect of electrolyte flow on the self-discharge of the cells (FIGS. 98(A) and 98(B)). Over the investigated period, minimal decay in the OCV values (0.57 mV/h for Design-I and 0.49 mV/h for Design-II) was observed, which confirmed the absence of self-discharge in the cells. Thus, replacing the biphasic interface with an electrolyte layer can eliminate the interfacial self-discharge and crossover of active materials under convective mass transport using electrolyte-flowing conditions. The charge rate performances of the Li∥C18-PTZ (0.5 M) flow cells based on Design-I and -II were evaluated at current densities of 0.8, 1.0, and 1.2 mA/cm², and the corresponding cycling profiles, as well as the Coulombic efficiency, voltage efficiency, and energy efficiency values were measured for an average of three cycles. Similar to the static cells, the flow cells exhibited an increase in overpotential with increasing applied current density (FIGS. 84(E) and 84(F)). This increase in overpotential is attributed to the induced transport losses that occur at higher current densities. The Coulombic efficiency of the cells remained at 100% for all current densities; however, the voltage efficiency and energy efficiency values decayed with increasing current density. The increase in the overpotential and the corresponding reduction in voltage efficiency at higher current densities may be attributed to mass transport limitations (FIGS. 84(G) and 84(H)). Both cells regained their original performances when cycled back at 0.8 mA/cm². Furthermore, the triphasic cells under flow conditions exhibited improved capacity utilization compared to the static cells (80% for Design-I and 84% for Design-II under flow conditions at 1 mA/cm² compared to 42% for Design-I and 48% for Design-II under static conditions at 0.75 mA/cm²), indicating that the flow of electrolytes significantly reduced the mass transport limitations of the static battery. As a result of the enhanced mass transport, the triphasic batteries exhibited higher peak power densities under flow conditions compared to static conditions. Specifically, Design-I achieved a peak power density of 39 mW/cm² (FIG. 99(A)), while Design-II reached an even higher peak power density of 46 mW/cm² (FIG. 99(B)). The ASR results for both the electrolyte and the entire battery under flow conditions indicated that the electrolyte resistance accounted for over 58% (Design-I) FIG. 99(C)) and 47% (Design-II) (FIG. 99(D)) of the entire battery. Thus, the ASR of the electrolyte and the entire battery are significantly reduced under flow conditions, allowing for higher current densities without compromising the performance. The relatively low power densities compared to these of conventional aqueous membrane-based redox flow batteries can be attributed to the reduced ionic conductivity of nonaqueous solvents and increased mass transfer resistance from the triphasic interface.

In summary, to overcome the challenges associated with the biphasic electrolyte approach, a triphasic liquid/liquid system with two new strategic designs (Design-I and -II) was proposed. In contrast to biphasic systems, the novel developed triphasic system features an additional electrolyte layer to separate the anolyte and catholyte, eliminating self-discharge and providing high Coulombic efficiency and capacity retention. The intermediate layer enabled improved cycling performance and the flow of the electrolyte to achieve decoupled energy and power studies. The triphasic batteries based on the two novel designs were assembled using Li metal as the anode and a phenothiazine derivative C18-PTZ (0.5 M) as the cathode. The cycling performances of the triphasic membrane-free batteries based on Design-I and -II were evaluated under static and flow conditions. Static batteries based on Design-I and -II yielded outstanding cycling performance with high capacity retentions of 97.25% and 98.72%, respectively, and Coulombic efficiencies close to 100%. However, under static conditions, the capacity utilization of the batteries was lower owing to limited mass transport. To enhance capacity utilization and enable the decoupled scaling of energy and power, flow conditions were introduced for both designs of the triphasic system using an optimized flow rate of 1 mL/min. Flow batteries based on these designs exhibit significantly higher capacity utilization than static batteries. Moreover, Design-I and -II flow batteries achieved improved capacity retentions of 98.65% and 99.47%, respectively, with Coulombic efficiencies close to 100% under flow conditions. The peak power densities of the Design I and II batteries under static conditions were 27 and 30 mW/cm², respectively, whereas those under flow conditions increased to 39 and 46 mW/cm², respectively. The improved power densities of the flow batteries were attributed to the lowered electrolyte resistance resulting from enhanced mass transport compared with static batteries. Therefore, the outstanding performance of the nonaqueous triphasic system provides a novel strategy for developing membrane-free, nonaqueous batteries with high voltage, high Coulombic efficiency (close to 100%), improved capacity utilization, and high capacity retention.

### Part H

Large-scale electrical energy storage (EES) systems are vital for the efficient utilization of widely available intermittent renewable energy sources such as solar and wind energy to mitigate the mismatch between the generation and consumption of electrical energy. Rechargeable batteries are the first choice for building advanced EES systems owing to their high efficiency and flexible installation. Among the various battery technologies being explored, redox-flow batteries (RFBs) have attracted particular attention as promising EES systems because of their unique feature of the decoupling of energy density and power. Based on the electrolyte used, RFBs can generally be classified into two types: aqueous and nonaqueous RFBs. Aqueous RFBs use water as the solvent for the anolyte and catholyte, as this offers several advantages, including fast reaction kinetics, low cost, nonflammability, and high ionic conductivity. Remarkable progress has been made with regard to aqueous RFBs, and they have been commercialized. However, aqueous RFBs suffer from two major problems: limited cell voltage owing to the narrow electrochemical window of water (1.23 V) and low energy density (20-50 Wh/L)6,9. In contrast, nonaqueous RFBs (NRFBs) exhibit a wider electrochemical window (up to 6 V) and potentially higher energy density. Moreover, the fact that one can employ widely available solvents and supporting electrolytes allows for the use of a range of redox-active compounds. However, the development of NRFBs has been hindered by the limited availability of critically important ion-selective membranes, the low ionic conductivity of nonaqueous electrolytes, and the high costs of these materials. Specifically, the limited availability of appropriate ion-selective membranes and their high cost (approaching 40% of the total battery cost) are the key challenges. To address these limitations, cost-effective size-exclusive separators have been used in NRFBs as alternatives to ion-selective membranes. These porous-separator-based batteries can exhibit high current densities; however, this strategy has several downsides, including low rates of active material utilization, low Coulombic efficiency, and self-discharging.

Thus, several membrane-free batteries have been proposed and developed. Initially, classical fluid dynamics engineering based on the laminar flow of electrolytes through parallel microchannels was exploited to develop membrane-free batteries. However, these microfluidic batteries can only be realized at the microscale and thus are not suitable for large-scale energy storage. Recently, immiscible electrolyte-based liquid-liquid biphasic systems have received significant attention for the construction of membrane-free batteries. The liquid-liquid interface of these biphasic systems separates the catholyte and anolyte and functions as a natural barrier, thus eliminating the need for a membrane. Unlike the case for laminar-flow batteries, the biphasic membrane-free approach allows for the design of flow batteries with higher power and capacity. However, most of the previously reported membrane-free ABSs were investigated under static conditions and showed limited scalability. Membrane-free batteries have rarely been investigated under actual flow conditions because of the convective-mass-transport-induced disturbances at the liquid-liquid interface under flow conditions, which results in self-discharging and active material crossover. Moreover, ABS batteries typically show low energy density owing to their limited cell voltage. Therefore, membrane-free batteries based on nonaqueous electrolytes have been developed to increase the energy density. However, the development of flow batteries based on a nonaqueous biphasic system (NBS) has been hindered by the lack of immiscible organic solvents and redox-active materials that exhibit suitable solubilities in each phase to prevent active material crossover in the self-stratified biphasic system. Liu et al. demonstrated a static membrane-free battery-based all-organic NBS using Li metal in nonafluoro-1,1,2,2-tetrahydrohexyl-trimethoxysilane (NFTOS) as the anolyte and 2-ethylanthraquinone (2-EAQ) and benzo[1,2-b:4,5-b′]dithiophene-4,8-dione (BDTD) tetraethylene glycol dimethyl ether paired together as the catholyte23. Both catholyte materials (i.e., 2-EAQ and BDTD) exhibit low solubilities in the anolyte (NFTOS), thus allowing for the study of the charge/discharge cycling characteristics. However, this battery suffers from (1) low charge/discharge current density (50 μA/cm2), (2) relatively low nominal cell voltage (~2.2 V) for both cathodic materials and (3) a lack of information regarding its capacity retention rate and cycling characteristics under flow conditions. Hence, there is an urgent need to develop membrane-free batteries that use flowable nonaqueous electrolytes with high voltage and energy density.

In this work, we report an all-nonaqueous biphasic membrane-free battery that shows high voltage and energy density under both static and flow conditions. The NBS-based battery employs Li metal in an ionic liquid (1-butyl-1-methylpyrrolidinium bis(tri-fluoromethylsulfonyl)imide (BMP-TFSI)) as the anode electrolyte solvent (top phase) and a set of metal-free organic compounds (FIG. 25), which include TEMPO derivative (2,4,6-tri-(1-cyclohex-yloxy-4-imino-2,2,6,6-tetramethylpiperidine)-1,3,5-triazine (Tri-TEMPO)), phenothiazine derivative (N-propyl phenothiazine (C3-PTZ)), or cyclopropenium derivative (tris(dialkylamino)cyclo-propenium (CP)) in fluoroethylene carbonate (FEC) as the cathode electrolyte solvent (bottom phase). The Li∥Tri-TEMPO, Li∥C3-PTZ, and Li∥CP biphasic batteries exhibited theoretical cell voltages of 3.53, 3.49, and 4.09 V, respectively. The developed biphasic system was investigated under both static and flow conditions using the catholyte in different concentrations (0.1, 0.2, and 0.5 M). The static Li∥Tri-TEMPO, Li∥C3-PTZ, and Li∥CP batteries with 0.5 M catholyte displayed capacity retention rates of 98%, 98%, and 92%, respectively, after 100 cycles over ~55 days at a current density of 1 mA/cm² and a temperature of 27° C. Moreover, under flow conditions, the prolonged cycling of the 0.5 M Li∥Tri-TEMPO battery resulted in a capacity retention rate of 81% after 100 cycles over ~45 days. The cycling was conducted at a higher current density of 1.5 mA/cm2 and a temperature of 27° C. The Coulombic efficiency (CE), voltage efficiency (VE), and energy efficiency (EE) were measured to be 96%, 85%, and 82%, respectively. The flow battery exhibits a high cell voltage of 3.53 V, resulting in a high energy density of approximately 33 Wh/L. Pre- and post-cycling battery analysis confirmed the absence of crossover of the active materials.

Results and Discussion. Fabrication of NBS and selection of redox-active cathode materials. Developing an all-organic NBS with suitable catholyte and anolyte materials is challenging owing to the interplay between the solubility of the active material and its crossover. Li metal was selected as the anode material because of its high energy density and theoretical capacity (~3860 mAh/g) and low electrochemical potential (−3.04 V vs. SHE). On the other hand, graphite felt (GF) was selected as the cathode material because of its high specific surface area, porous structure, high electrical conductivity, and chemical inertness in nonaqueous electrolytes. The unique structure of GF and the presence of a large number of surface catalytic sites result in fast redox-reaction kinetics and hence improved battery performance. The successful fabrication of an NBS for high-performance membrane-free LRFBs requires that (1) the two nonaqueous electrolytes must be immiscible, show high ionic conductivities, and a wide electrochemical stability window and (2) the redox-active cathode material should have high solubility in the catholyte and low solubility in the anolyte in both the charging and discharging states to prevent the self-discharging of the battery because of crossover. Both requirements are discussed below.

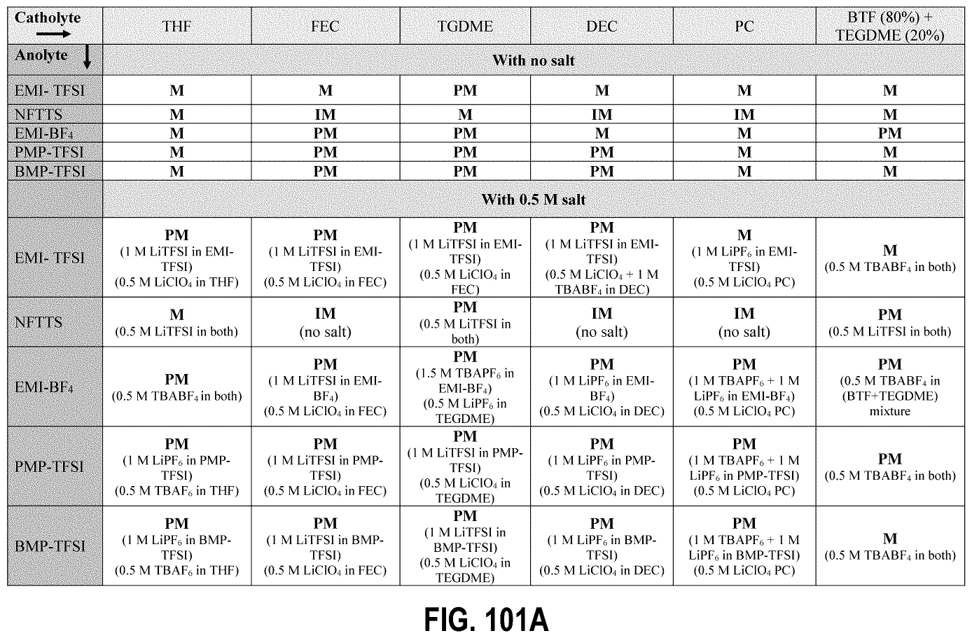

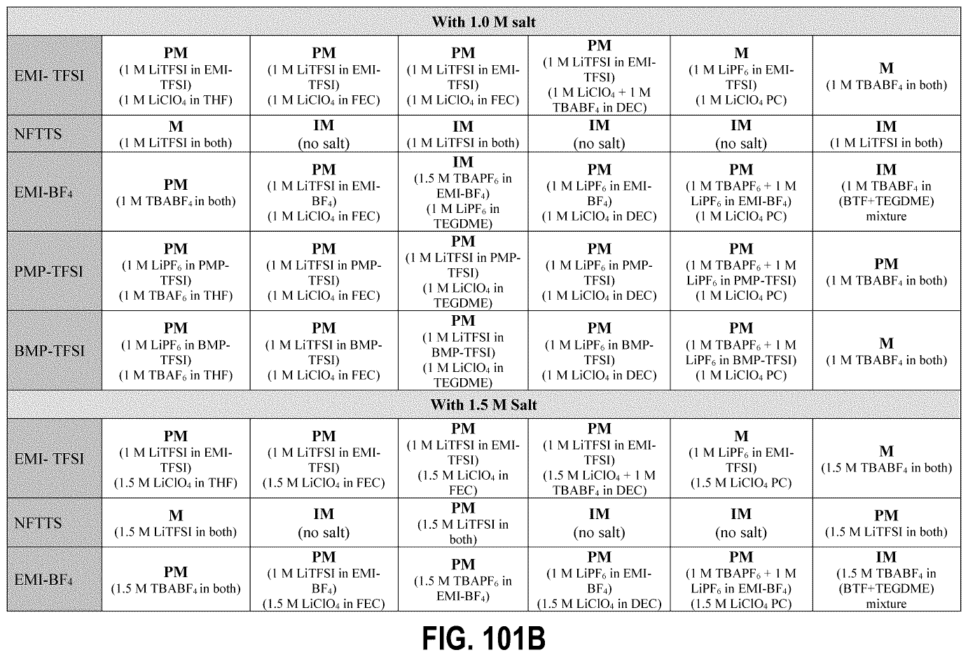

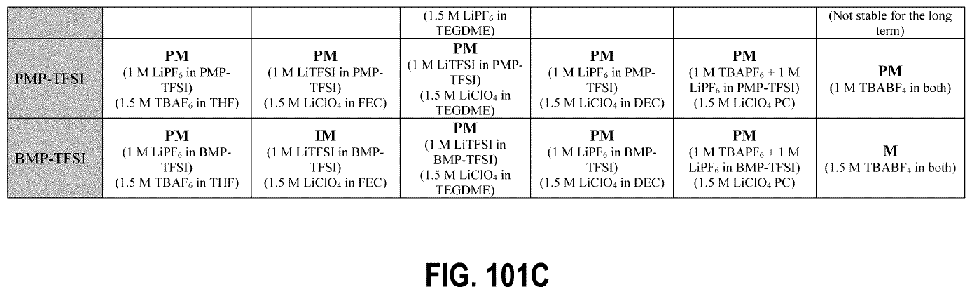

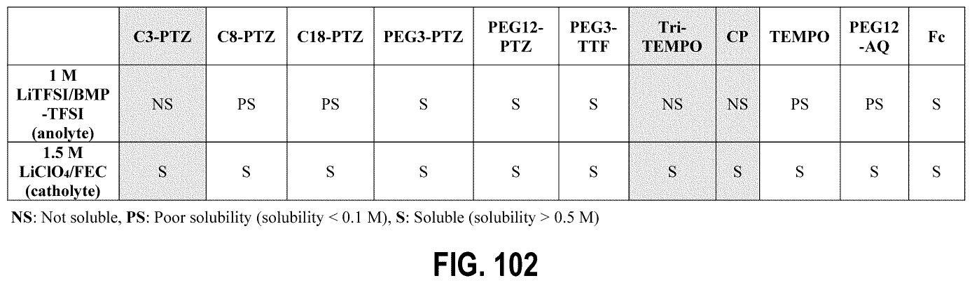

To explore electrolytes with the above-mentioned properties, eleven nonaqueous solvents (including four ionic and seven nonionic organic solvents) were screened to construct the NBS (FIG. 101). Ionic liquids have been explored widely for use in Li-ion batteries as compatible anolytes for Li metal, as they not only allow for a wider electrochemical window (~6 V) but also suppress the growth of Li dendrites during longer battery operations. Here, four ionic liquids, namely, ethyl-3-methylimidazolium bis(trifluoromethylsulfonyl)imide (EMI-TFSI), N-propyl-N-methylpyrrolidinium bis(trifluoromethanesulfonyl)imide (PMP-TFSI), 1-ethyl-3-methyl imidazolium tetrafluoroborate (EMI-BF₄), and 1-butyl-1-methylpyrrolidinium bis(trifluoromethylsulfonyl) imide (BMP-TFSI), along with nonafluoro-1,1,2,2-tetrahydrohexyl-tri-methoxysilane (NFTTS) were selected as the anolyte solvents, and six organic solvents, namely, tetrahydrofuran (THF), tetraethylene glycol dimethyl ether (TEGDME), fluoroethylene carbonate (FEC), diethylene carbonate (DEC), propylene carbonate (PC), and benzotrifluoride (BTF), were explored for use as the catholyte. A few pairs of the anolyte and catholyte solvents were intrinsically immiscible in their neat forms. The other electrolytes that were either miscible or partially immiscible in their neat forms could be rendered immiscible using salt-out strategies. The most effective salt-out strategy involves the use of salts that have high solubility in one organic phase and low (or no) solubility in another organic phase to facilitate the formation of a biphasic system. To screen the electrolyte salts with the above-mentioned properties, five salts, namely, lithium bis(trifluoromethanesulfonyl)imide (LiTFSI), lithium per-chlorate (LiClO₄), tetrabutylammonium hexafluorophosphate (TBAPF₆), tetrabutylammonium tetrafluoroborate (TBABF₄), and lithium hexafluorophosphate (LiPF₆), were selected for solubility analyses. The concentration of various salts was adjusted within the range of 0.5 M to 1.5 M to achieve the separation of two organic solvents. However, the selective solubility of organic salts in different solvents resulted in only a few pairs forming a stable biphasic system, while others remained miscible or partially miscible. Following the analyses, three NBSs were formed: FEC (LiClO₄ (1.5 M))/BMP-TFSI (LiTFSI (1 M)), TEGDME/NFTTS with LiTFSI (1 M), and BTF-TEGDME/EMI-BF₄ with TBABF₄ (1 M). Since both phases of the NBS should have the same exchange ions to facilitate the charging/discharging of the membrane-free battery, Li⁺ ions were used as the exchange ions for FEC/BMP-TFSI and TEGDME/NFTTS biphasic systems, and BF₄-ions for BTF-TEGDME/EMI-BF₄ biphasic. Of the three NBSs, FEC/BMP-TFSI (FIG. 34(A)) was selected for the subsequent electrochemical analyses and battery performance studies due to the following reasons. The high solubilizing ability of FEC solvent (bottom phase) allowed catholytes (FIGS. 33 and 102) with different redox potentials to be evaluated. Plus, FEC exhibits higher ionic conductivity compared with those of BTF and NFTTS. Meanwhile, BMP-TFSI solvent (top phase) facilitates improved compatibility as an anolyte electrolyte solvent for Li metal anode. In addition, the organic solvents utilized in this study as the anolyte and catholyte solvents possess high flash points of approximately 210° C. and 115° C., respectively. For clarification, we have conducted an ignition test on both the top (BMP-TFSI/LiTFSI) and bottom (FEC/LiClO₄) phases of the biphasic system. As illustrated in FIG. 35, both phases were determined to have high flame resistance.

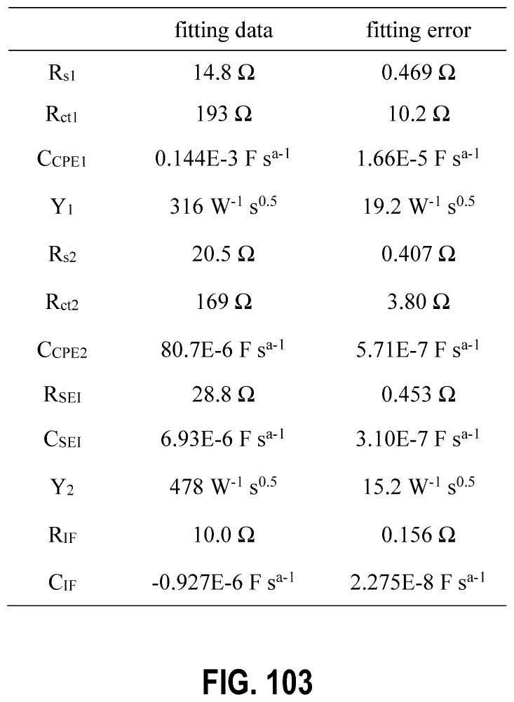

Moreover, to investigate the ion transport kinetics in different phases as well as at the liquid-liquid interface, we carried out electrochemical impedance spectroscopy (EIS) measurements for the FEC electrolyte solvent, BMP-TFSI electrolyte solvent, and the BMP-TFSI/FEC (liquid/liquid) system, which included the liquid/liquid interface. The equivalent circuit of a BMP-TFSI/FEC system is composed of bulk impedance (solution and wire), FEC capacitance, BMP-TFSI capacitance (including SEI layer) and liquid-liquid interface resistance, and diffusion impedance. By separately measuring the impedance of the FEC and the BMP-TFSI electrolytes (FIGS. 36(A) and 36(B)), and fixing the main parameters of these two parts during the fitting process, the liquid-liquid interface impedance was calculated to be ~10.0 0 (FIG. 36(C)). The equivalent circuit fitting data for the EIS measurement are detailed in the FIG. 103. It should be noted that a negative CIF capacitance was obtained, as observed in other similar systems, presumably due to the delayed-current phenomenon. However, compared to Rct of over 100 0, an interfacial impedance of 10.0 0 is not considered to be a limiting factor.

A catholyte with high solubility with respect to the anolyte solvent would ensure high energy density while one with low (ideally zero) solubility would prevent crossover. To explore catholyte materials that meet these solubility requirements, eleven organic compounds were selected, and their solubilities in both phases of the NBS were tested. These materials included derivatives of phenothiazine, cyclopropenium, 2,2,6,6-tetramethylpiperidinyloxy (TEMPO), anthraquinone (AQ), and ferrocene (FIGS. 33 and 102). Among the catholyte materials, Tri-TEMPO, C3-PTZ, and CP showed high solubilities in cathode electrolyte (FEC/LiClO₄) and poor affinity towards the anode electrolyte (BMP-TFSI/LiTFSI) (FIGS. 34(B)-(D)). The solubilities of Tri-TEMPO, C3-PTZ, and CP in FEC/LiCO4 (1.5 M) were ~1.2 M, ~1 M, and 1.8 M, respectively. Negligible crossover occurred under static conditions over 15 days, as confirmed by ultraviolet (UV)-visible spectroscopy (FIG. 37) and cyclic voltammetry (CV) (FIG. 38). Hence, Tri-TEMPO, C3-PTZ, and CP were selected as the cathode materials for the subsequent experiments.

Electrochemical Characterization. The CV measurement was conducted to ascertain the electrochemical compatibility of the Li metal anode in the ionic liquid (BMP-TFSI), as well as to evaluate the reversibility of the redox-active cathode materials (Tri-TEMPO, C3-PTZ, and CP) in FEC under an inert argon atmosphere at a temperature of 27° C. Tri-TEMPO, C3-PTZ, and CP exhibit a reversible redox couple at 0.37, 0.33, and 0.93 V vs. Ag/Ag+ in FEC/LiClO₄ (0.1 M) (FIG. 33(A)). The pairs of the Li-metal anode and the three cathode materials (i.e., Li∥Tri-TEMPO, Li∥C3-PTZ, and Li∥CP) exhibited theoretical cell voltages of 3.53, 3.49, and 4.09 V, respectively; these are higher than those of previously reported biphasic membrane-free batteries (FIG. 57). The peak potential separations of Tri-TEMPO, C3-PTZ, and CP at a scan rate of 5 mV/s were −74, −69, and −76 mV, respectively (FIG. 39) and indicative of a one-electron redox process as per the Nernst equation 50. Next, CV measurements were performed at scan rates of 50-200 mV/s (FIG. 40) to study the electrochemical kinetics of the catholyte compounds. The ratios of the cathodic peak current (ipc) and anodic peak current (ipa) for Tri-TEMPO, C3-PTZ, and CP at the investigated scan rates (50-200 mV/s) were close to 1 (FIG. 41), suggesting that the compounds exhibited good electrochemical reversibility in FEC. Further, the peak currents (anodic and cathodic) exhibit a linear relationship with the square root of the scan rate (v^{1/2}) for all three cathode materials (FIG. 42), indicating that the redox process is diffusion-controlled. In addition, linear sweep voltammetry (LSV) was also performed using the rotating disk electrode (RDE) experiments (FIGS. 43, 44, and 45) to study the electrochemical kinetics of redox molecules used in this work. The Koutecký-Lévich curves (Eq. 1) were used to measure the diffusion coefficients (D) of the redox materials at varying rotating rates. The diffusion coefficients of Tri-TEMPO, C3-PTZ, and CP are in the range of 10-6-10-5 cm² s⁻¹. Furthermore, the kinetic rate constants (k₀) of all three redox compounds were determined by fitting the Butler-Volmer equation (Eq. 2) and were found to be in the range of 10-4-10-2 cm s⁻¹. Notably, the diffusion coefficients and rate constants of these compounds are comparable to those of certain redox-active organic materials employed in aqueous flow batteries. The fast electrode kinetics of Tri-TEMPO, C3-PTZ, and CP are anticipated to result in low activation polarization loss, which is beneficial for flow battery applications. The electrochemical and chemical stability of organic redox materials were evaluated using CV and proton nuclear magnetic resonance (¹H NMR) spectroscopy. The CV cycling results showed improved electrochemical stability, as evidenced by the nearly superimposable voltammograms (FIGS. 26(B)-(D)). In addition, the ¹H NMR spectra of C3-PTZ and CP demonstrated improved thermo-stability over 10 days at 25° C. and 60° C. (FIGS. 46 and 47).

Charge/discharge performance of biphasic membrane-free batteries under static conditions. The viability of the developed biphasic system as a membrane-free battery was initially evaluated under static conditions under an inert argon atmosphere (27° C.). The schematic illustration, FIG. 27(A), offers a clear representation of the cell's structural arrangement and functional elements. As a starting point, two nonaqueous biphasic static batteries (NBSBs) were assembled by pairing a Li-metal anode with 0.1 or 0.2 M Tri-TEMPO, and the batteries were subjected to charging/discharging for 100 cycles (−13 days for 0.1 M Tri-TEMPO and −22 days for 0.2 M Tri-TEMPO) at a current density of 1 mA/cm². While the current density could be increased further, the operational current density was notably higher than what has been previously reported for aqueous and nonaqueous biphasic membrane-free systems. The 0.1 M and 0.2 M Li∥Tri-TEMPO NBSBs (FIG. 27(B)) both showed good cycling performances, exhibiting capacity retention rates of 99.87% (99.998% per cycle, 99.997% per day) and 99.91% (99.998% per cycle, 99.998% per day), respectively. This confirmed that the redox-active materials, supporting electrolytes, and solvent exhibited high stability under actual battery operation conditions. Moreover, both NBSBs exhibited high CE (over 99% for both) and EE values (86% for 0.1 M and 84% for 0.2 M). A CE value as high as −99% suggests low self-discharging and thus negligible active material crossover. Moreover, there was no obvious change in the peak current densities of the 0.1 M and 0.2 M Li∥Tri-TEMPO catholytes (FIG. 48) post-cycling, which further confirmed that the Tri-TEMPO redox molecules remained confined within the catholyte (FEC phase) during the pro-longed cycling process. Based on these results, we built an NBSB containing the catholyte in a higher concentration. Specifically, a 0.5 M Li∥Tri-TEMPO NBSB was assembled and subjected to long-term charging/discharging (100 cycles, ~55 days) at a current density of 1 mA/cm² (27° C.), as shown in FIG. 27(B). The 0.5 M Li∥Tri-TEMPO battery exhibited a capacity retention rate of 97.5% (99.97% per cycle, 99.95% per day). Its cycling profile suggests a discharging voltage of 3.48 V with no significant change in the overpotential throughout the cycling process (FIG. 27(C)). The 0.5 M Li∥Tri-TEMPO NBSB displayed CE, VE, and EE values of 96%, 87%, and 83% (FIG. 27(D)), respectively, which surpass those of previously reported membrane-free systems (FIG. 57). However, these values were lower than those of the 0.1 M and 0.2 M NBSBs (FIG. 49). The Coulombic efficiency of a high-concentration battery did not change with higher current density. Even though faster charging/discharging rates typically increase Coulombic efficiency, parasitic reactions could also occur at higher current density as a tradeoff. Moreover, a higher catholyte concentration would mean a relatively high flow resistance, resulting in lower ionic conductivity and greater transport losses, and consequently a lower VE value. However, the 0.5 M Tri-TEMPO NBSB had a discharge volumetric energy density of 34 Wh/L which is higher than those of most state-of-the-art biphasic membrane-free static and flow batteries (FIG. 57). The electrolytes were analyzed both before and after cycling using CV (FIG. 27(E) and FIG. 50(B)) and UV-visible spectroscopy (FIG. 50(A)). The analyses indicated that Tri-TEMPO was not present in the post-cycling anolyte. Hence, the high cycling stability of the Li∥Tri-TEMPO biphasic static batteries with different Tri-TEMPO concentrations (0.1, 0.2, and 0.5 M) suggested that they are suited for practical use. It also confirmed the high compatibility of Li metal with the anolyte and that of GF with the catholyte.

To evaluate the versatility of the developed NBS, the other two selected catholyte materials (C3-PTZ and CP) were studied under the same conditions as those used for the Li∥Tri-TEMPO battery (FIG. 28). The long-term performances of both NBSBs were investigated through extended charging/discharging tests performed at 1 mA/cm² for 100 cycles. The 0.5 M Li∥C3-PTZ battery was charged/discharged within the voltage range of 2.8-3.8 V (FIG. 28(A)), whereas the 0.5 M Li∥CP battery was cycled in the 3.3-4.3 V range (FIG. 28(B)). The 0.5 M Li∥C3-PTZ and 0.5 M Li∥CP NBSBs exhibited distinct stable plateaus and discharging voltages of 3.42 and 3.94 V, respectively, which are considerably greater than those reported in the majority of membrane-free flow battery systems, whether aqueous or nonaqueous (FIG. 57). The 0.5 M Li∥C3-PTZ (FIG. 28(C)) battery also showed stable CE, VE, and EE values of 98%, 90%, and 88%, respectively, throughout the cycling process, whereas the 0.5 M Li∥CP (FIG. 28(D)) battery exhibited CE, VE, and EE values of 91%, 79%, and 72%, respectively. That the CE values of both batteries were greater than 90% indicated that negligible self-discharging had occurred in the batteries. Furthermore, the 0.5 M Li∥C3-PTZ (FIG. 28(E)) and 0.5 M Li∥CP (FIG. 28(F)) batteries showed good cycling stability, with their capacity retention rates being 97.12% (99.971% per cycle, 99.949 per day) and 92.12% (99.921 per cycle, 99.856 per day), respectively. The electrolytes of the 0.5 M Li∥C3-PTZ and 0.5 M Li∥CP batteries were subjected to CV measurements, UV-visible spectroscopy, and proton nuclear magnetic resonance (¹H NMR) spectroscopy both before and after cycling. The quantitative CV analysis of the catholytes and anolytes of the 0.5 M Li∥C3-PTZ (FIG. 28(G), FIG. 51(A)) and 0.5 M Li∥CP (FIG. 28(H), FIG. 52(A)) batteries did not indicate significant changes in their current densities even after 100 charge/discharge cycles. Moreover, the post-cycling UV-visible spectra of the 0.5 M Li∥C3-PTZ and 0.5 M Li∥CP anolytes confirmed the absence of crossover (FIGS. 51(B) and 52(B)). Finally, the NMR spectra of the pre- and post-cycled anolytes of both batteries (FIGS. 51(C) and 52(C)) were nearly identical, which confirmed that C3-PTZ and CP remained in the catholyte phases and did not cross over.

To elucidate the effect of the high current density of the NBSBs on their performance, the charge/discharge behaviors of the 0.5 M Li∥Tri-TEMPO, 0.5 M Li∥C3-PTZ, and 0.5 M Li∥CP batteries were studied at current densities of 1, 1.5, and 2 mA/cm², and their average CE, VE, and EE values were measured for 3 cycles. The 0.5 M Li∥Tri-TEMPO (FIG. 29(A)), 0.5 M Li∥C3-PTZ (FIG. 29(B)), and 0.5 M Li∥CP (FIG. 29(C)) NBSBs exhibited ohmic drops of −80, −50, and −60 mV, respectively, at 1.5 mA/cm² and −130, −98, and −110 mV, respectively, at 2 mA/cm². The increase in the ohmic loss at the higher current density can be ascribed to limitations related to mass diffusion. The Li∥Tri-TEMPO (FIG. 5d), Li∥C3-PTZ (FIG. 29(E)), and Li∥CP (FIG. 29(F)) batteries showed CE values of 96%, 98%, and 92%, respectively, at all the operating current densities, indicating that fast charging/discharging did not induce noticeable side reactions. However, the EE values of the Li∥Tri-TEMPO, Li∥C3-PTZ, and Li∥CP batteries were reduced from 83%, 88%, and 72%, respectively, to 78%, 80%, and 70%, when the applied current density was increased from 1 to 2 mA/cm². This was owing to an increase in the overpotential because of mass transport losses. It should be noted that all three batteries regained their original efficiencies when they were cycled back at 1 mA/cm², thus confirming their improved charge-rate performance. In addition to this, the polarization for the 0.5 M Li∥Tri-TEMPO, C3-PTZ, and CP batteries under static conditions was also investigated at different states of charge (SOC). The peak power densities of the 0.5 M Li∥Tri-TEMPO, C3-PTZ, and CP batteries under static conditions are 33, 30, and 37 mW/cm², respectively, at 100% SOC (FIG. 53). Correspondingly, the area-specific resistance (ASR) data for both the resistance of the electrolyte and the whole cell under static conditions was also studied. The results show that both the ASR of the electrolyte and the whole cell increase as the operating current density increases (FIG. 54). However, the electrolyte resistance accounts for over 50% of the whole cell for all batteries. In addition, the energy densities of the static 0.5 M Li∥Tri-TEMPO, C3-PTZ, and CP batteries were 34, 34, and 30 Wh/L, respectively. These values were found to be 71%, 72%, and 57% of their corresponding theoretical energy densities (FIG. 57).

Charge/discharge performance of biphasic membrane-free batteries under flow conditions. While the batteries showcased impressive performance under static conditions, their energy and power remained intertwined, limiting their full potential. Thus, the capacity of the batteries was not scalable, as is necessary under flow conditions. Hence, a Li-based nonaqueous biphasic flow battery based on 0.5 M Tri-TEMPO was assembled. FIG. 55 presents a comprehensive digital photograph, while FIG. 30(A) provides a schematic illustration, both showcasing the com-ponents of a membrane-free biphasic flow battery. The long-term cycling performance was evaluated under an inert argon atmosphere (at 27° C.) at the current density of 1.5 mA/cm². Under flow conditions (1 mL/min), after 100 charge/discharge cycles, the 0.5 M Li∥Tri-TEMPO battery showed a capacity retention rate of 81.12% (99.811 per cycle, 99.581 per day) along with a CE of −96%, VE of −85%, and EE of −82% (FIGS. 30(B) and 30(C)). To elucidate the mechanism responsible for its capacity fading, its electrolytes were analyzed both before and after cycling using CV (FIG. 30(D)) and UV-visible spectroscopy (FIG. 30(E)). The reduction in the CV peak current and absorbance of the post-cycling catholyte were indicative of the crossover of the Tri-TEMPO molecules due to the convective diffusion of the flowing catholyte during prolonged battery cycling. Both CV and UV-visible results (FIG. 56) suggested that 93% of total capacity fade is caused by the crossover of Tri-TEMPO. To clarify the effect of the flowing catholyte on the self-discharging of the battery, its open-circuit voltage (OCV) in the fully charged state was monitored over 200 h (at 27° C.) (FIG. 30(F)). The OCV of the battery displayed a sharp decrease during the first 10 h after the charging process owing to ohmic polarization (i_{R} drop), followed by a voltage loss of 0.63 mV/h in the next 190 h, which corresponded to a total drop of 120 mV over 190 h. However, the per-hour voltage loss of this battery was smaller than that of previously reported aqueous/nonaqueous biphasic membrane-free batteries. Further, the ASR result for both the resistance of the electrolyte and the whole cell under flow conditions suggests that the electrolyte resistance accounts for over 50% of the whole battery (FIG. 54). Nonetheless, for the 0.5 M Li∥Tri-TEMPO battery, both the electrolyte and overall battery's ASR exhibit a notable decrease under flow conditions. This reduction in ASR under flow conditions enables the battery to achieve higher current and power densities without compromising its performance. Hence, the peak power density of the 0.5 M Li∥Tri-TEMPO battery under flow conditions was significantly higher at 61 mW/cm² compared to the Tri-TEMPO static battery (FIG. 53). The enhanced peak power density can be attributed to improved mass transport under flow conditions.

The charge-rate performance of the 0.5 M Li∥Tri-TEMPO flow battery was evaluated at current densities of 1.5, 2.0, and 2.5 mA/cm², and the corresponding cycling profiles (FIG. 30(G)) as well as the CE, VE, and EE (FIG. 30(H)) values were measured for an average of three cycles. When operated at a current density of 2.5 mA/cm², the battery exhibited a discharge overpotential of 132 mV, which is nearly twice that when it was operated at a current density of 1.5 mA/cm². The increase in the overpotential and the corresponding reduction in the VE at the higher current density can be attributed to mass transport limitations. However, the battery was able to regain its original performance when cycled again at the applied current density of 1.5 mA/cm², suggesting that the biphasic battery showed good rate cyclability under flow conditions. Hence, the performance of membrane-free nonaqueous biphasic batteries demonstrated in this study, under both static and flow conditions, is well positioned compared to the state-of-the-art literature of similar battery systems (FIG. 57). A radar chart in FIG. 31 summarizes this work and reported battery performance, including number of cycles, energy density, Coulombic efficiency, and voltage.

To evaluate the economic feasibility of the developed system, FIG. 58 presents a cost estimation of the battery components and chemicals employed in this study. This economic analysis provides comprehensive information regarding the cost analysis of the redox-active materials utilized in this research. The findings indicate that the synthesized redox-active cathode materials can be prepared on a larger scale at economically favorable prices, further supporting their viability.

Analyzing the cost or conducting an economic assessment of membrane-free batteries is essential. The cost of the Tri-TEMPO, C3-PTZ, and CP nonaqueous membrane-free batteries is primarily determined by the price of the components used in both the catholyte and anolyte layers, including redox-active materials, FEC, LiClO4, GF, BMP-TFSI, LiTFSI, and Li metal. The estimated costs of each component are detailed in FIG. 58. The costs of the components used in this study are relatively comparable to those of the Li∥TEMPO membrane-based nonaqueous battery. In contrast, the major expenses associated with nonaqueous Li redox flow batteries stem from typical components including the bipolar plate, GF, membrane, and current collector plate. These components account for approximately 18%, 28%, 35%, and 3% of the total cost, respectively. Despite the higher costs of the ILs used in this study and the synthesized compounds, the elimination of high-cost membrane separators significantly improves the cost-effectiveness of the developed system. Therefore, the proposed batteries are comparatively cost-effective.

In summary, we report a nonaqueous biphasic membrane-free Li-based redox flow battery with high voltage and energy density. A nonaqueous biphasic system was developed using an ionic liquid (BMP-TFSI) and organic carbonate as the electrolytes (FEC) based on the salt-out effect. Three redox-active cathode materials, namely, Tri-TEMPO, C3-PTZ, and CP, were selected after analyzing 11 organic redox-active compounds. Initially, the 0.1 M and 0.2 M Li∥Tri-TEMPO static biphasic membrane-free batteries were subjected to 100 charge/discharge cycles and showed capacity retention rates of 99.87% and 99.91%, respectively. The 0.1 M and 0.2 M Li∥Tri-TEMPO biphasic batteries exhibit energy densities of ~7.2 and 16.6 Wh/L, respectively. To increase the energy density, a 0.5 M Li∥Tri-TEMPO membrane-free static battery was assembled and subjected to 100 cycles. It exhibited a capacity retention rate of ~98%, CE of 96%, and energy density of 34 Wh/L. To confirm the versatility of the proposed biphasic system, two more redox-active materials, namely, C3-PTZ and CP, were tested in a membrane-free battery under static conditions. The 0.5 M Li∥C3-PTZ and 0.5 M Li∥CP biphasic static batteries exhibited discharge voltages of 3.42 and 3.94 V, respectively, which were higher than those of previously reported biphasic membrane-free battery systems. The Li∥C3-PTZ and Li∥CP biphasic static batteries containing the redox-active materials in a 0.5 M concentration displayed capacity retention rates of 98%, and 92%, respectively, after 100 cycles over ~55 days. Post-cycling analyses indicated that there were no signs of material degradation or crossover even after prolonged battery operation for any of the membrane-free static batteries. This confirmed the versatility of the nonaqueous biphasic system. To ensure the decoupling of energy and power, the developed membrane-free batteries were also studied under flow conditions. The representative 0.5 M Li∥Tri-TEMPO flow battery exhibited a capacity retention rate of 81% after 100 cycles over ~45 days, with its CE and EE values being 96% and 82%, respectively. The flow biphasic battery displayed higher energy density (33 Wh/L) than those of the earlier reported membrane-free batteries. The peak power densities of the 0.5 M Li∥Tri-TEMPO, C3-PTZ, and CP batteries under static conditions are 33, 30, and 37 mW/cm², respectively, at 100% SOC. The peak power density of the 0.5 M Li∥Tri-TEMPO battery under flow conditions was higher at 61 mW/cm² compared to the Tri-TEMPO static battery. In future work, several strategies can be implemented to improve the system's kinetics and overall performance, including: (1) optimizing the flow rates within the battery to enhance mass transfer kinetics; (2) selecting suitable supporting electrolyte (salt) that can improve the electrolyte's conductivity to regulate the overall battery kinetics, (3) implementing an advanced cell design for both static and flow conditions to reduce the dead volume of the cathode electrode, to improve capacity utilization, and (4) mitigating crossover of cathode materials from catholyte to anolyte at the liquid/liquid interface under flow conditions to further improve Coulombic efficiency.

Methods. Materials. Lithium hexafluorophosphate (LiPF6, 99.99%) was purchased from Sigma Aldrich. The ILs used, namely, 1-Ethyl-3-methylimidazolium Bis(trifluoromethanesulfonyl)imide (EMI-TFSI, 98.0%), N-propyl-N-methylpyrrolidinium bis(trifluoromethanesulfonyl)imide (PMP-TFSI, 99.9%), 1-ethyl-3-methyl imidazolium tetrafluoroborate (EMI-BF₄, 97.0%), and 1-butyl-1-methylpyrrolidinium bis(tri-fluoromethylsulfonyl)imide (BMP-TFSI, 98%), were purchased from TCI Chemicals, all the ionic liquids were used as received (water impurity content was not measured). Lithium perchlorate (LiClO4, 98%), lithium bis(trifluoromethanesulfonyl)imide (LiTFSI, 99.94%), fluoroethylene carbonate (FEC, 99%), diethyl carbonate (DEC, 99%), propylene carbonate (PC, 99.7%), nonafluoro-1,1,2,2-tetrahydrohexyl-trimethoxysilane (NFTTS, 97%), benzotrifluoride (BTF, 99.8%), Tetrahydrofuran (THF, 99.9), and tetraethylene glycol dimethyl ether (TEGDME, 98.0%) were purchased from Fisher Scientific and used without further purification. Tetra-butylammonium hexafluorophosphate (TBAPF6, 99.0%) was recrystallized in anhydrous ethanol and dried under vacuum at 60° C. for 24 h. The other compounds used in this study, such as Tri-TEMPO55, C3-PTZ56, CP57,58, C8-PTZ59, C18-PTZ60, PEG3-PTZ61, PEG12-PTZ56, PEG3-TTF62,63, and PEG12-AQ64 were prepared as per the reported procedures. To prepare nonaqueous electrolyte solutions for the cathode or anode, the following procedure was followed. Initially, a glass vial was filled with 3 mL of the desired electrolyte solution, either FEC or BMP-TFSI. Next, the appropriate amount of electrolyte salt was carefully added to the electrolyte solution in the glass vial. For FEC, LiClO₄ (1.5) was added, while for BMP-TFSI, LiTFSI (1 M) was used. The entire process took place inside an argon-filled glove box, maintaining a temperature of 27° C. To achieve a homogeneous solution, the contents of the vial were gently shaken and then subjected to ultra-sonication for 10 min. This combination of moderate shaking and ultra-sonication resulted in a uniformly mixed, clear solution, which was subsequently utilized for further analysis.

Physiochemical Characterization. The UV-visible absorption spectra were recorded using a UV-visible spectrophotometer (Cary 8454 UV-Vis, Agilent Technologies). To perform UV-vis measurements, samples with concentrations below 5 mM were prepared. To achieve this, highly concentrated samples were diluted in an appropriate electrolyte solvent before conducting the UV-vis measurements. For the UV-vis calibration curve, stock solutions of Tri-TEMPO at concentrations of 0.3 M and 0.5 M were prepared in FEC/LiClO₄ (1.5 M). These solutions were then further diluted to prepare solutions with concentrations of 1, 2, 3, 4, and 5 mM. In addition, a blank sample containing no redox materials was prepared to measure the UV-vis spectrum. The absorption intensity of the UV-vis spectra at different concentrations was used to construct the UV-vis calibration curve. This curve was subsequently utilized to determine the unknown concentration of the redox-active materials due to crossover.

The ¹H NMR spectra were recorded on a Bruker AV400 spectrometer (400 MHz). The chemical shifts were reported in ppm. To determine if CP or C3PTZ had crossed through the biphasic layer, we extracted 50 mL samples from anolyte before and after subjecting the system to extended charge/discharge cycles (~100 cycles). These 50 mL samples were subjected to 1H NMR analysis by combining them with 250 mL of CD3CN, resulting in a total NMR solvent volume of 300 mL. In addition, we followed specific sample preparation procedures to assess the stability of CP and C3-PTZ using ¹H NMR. Approximately 5 mg of either solid CP or C3-PTZ was mixed with 400 mL of CD3CN to create NMR samples. Two NMR samples were prepared for each compound in NMR tubes equipped with J. Young air-inlet valves. Firstly, we recorded ¹H NMR spectra for these NMR samples, after which we stored one NMR tube of each sample at room temperature while the other was placed at 60° C. Subsequently, we collected a series of ¹H NMR spectra at 24-h intervals for 10 days using these samples.

Electrochemical Characterizations. For the CV measurements, 5 mM of Tri-TEMPO, C3-PTZ, and CP solutions were prepared in FEC/LiClO4 (0.1 M) electrolyte. A glassy carbon disk (CHI Instrument, 3 mm) was used as the working electrode and was polished with Al₂O₃(Pine Research Instrumentation, Inc., 5 mm) before the measurements, where water was used as the solvent to polish the electrode. A piece of Pt wire (Pine Research Instrumentation, Inc., thickness 0.5 mm, purity 99.99%) was used as the counter electrode while an Ag/Ag+ (Fisher Scientific) electrode was used as the reference electrode. The CV measurements were performed using a Bio-Logic potentiostat. Electrochemical impedance spectroscopy (EIS) was performed using a potentiostatic signal spanning from 200 KHz to 100 mHz, with an amplitude of 10 mV. The measurements were conducted under open-circuit voltage (OCV) conditions for a total of 54 data points. The charge/discharge performances were evaluated using Land and Bio-Logic potentiostats.

The area-specific resistance (ASR) of both static and flow cells was determined using the linear sweep voltammetry (LSV) technique. LSV experiments were conducted on batteries containing different redox materials, and the resulting polarization curves were generated by plotting the current (i) against the applied potential (V). By identifying the linear region of the polarization curve, where the current response is directly proportional to the applied potential, the differential resistance (dE/di) was obtained. This linear region is typically observed at low overpotentials, indicating a more kinetic-limited regime of electrochemical reactions.

To calculate ASR, the slope (S) of the linear region was determined. The ASR was then computed using the formula (ASR=1/S). ASR represents the resistance normalized to the electrode area.

Two separate sets of cells were examined for the same experiment to assess and emphasize the reproducibility of the experiment. All electrochemical characterizations were conducted at a temperature of 27° C. within an argon-filled glove box.

Linear sweep voltammetry (LSV) studies were carried out using a Pine modulated speed rotator with Biologic potentiostats. Rotating disk electrode (RDE, diameter: 5 mm), Pt wire electrode, and Ag/Ag⁺ electrode were used as the working, counter, and reference electrodes, respectively. Before testing, the samples were purged with argon (purity: 99.999%) for 10 min. LSV dates were collected at different rotation rates ranging from 100 to 1600 rpm. The diffusion coefficient (Do) of electroactive materials was calculated from the Lévich plot using Eq. 1. The kinetic rate constant is calculated by Eq. 2.

A biphasic system comprising FEC/LiClO₄ (1.5 M) as the catholyte and BMP-TFSI/LiTFSI (1.0 M) as the anolyte was utilized to assemble membrane-free static and flow batteries. To prepare the electrolyte solution, LiClO₄ (1.5 M) salt was added to FEC and LiTFSI (1 M) salt was added to BMP-TFSI, each in separate glass vials within an argon-filled glove box. Homogeneous mixing was achieved through physical stirring, resulting in clear solutions of FEC/LiClO₄ (1.5 M) and BMP-TFSI/LiTFSI (1.0 M). These prepared electrolyte solvents were then used to construct the biphasic battery system. The charge/discharge performances of the Li∥Tri-TEMPO (0.1 M, 0.2 M, and 0.5 M), Li∥C3-PTZ (0.5 M), and Li∥CP (0.5 M) batteries were evaluated in the voltage ranges of 2.6-4.0, 2.8-3.8, and 3.3-4.3 V, respectively. The membrane-free batteries were tested in a cylindrical tube. For the static analyses, 0.25 mL of the catholyte and 0.25 mL of the anolyte were used. For the flow analyses, 0.6 mL of the catholyte and 0.6 mL of the anolyte were used; the catholyte was circulated through the cell at a flow rate of 1 mL/min using a peristaltic pump. The rate performances of the static and flow batteries were tested at current densities of 1, 1.5, and 2 mA/cm2 and 1.5, 2.0, and 2.5 mA/cm², respectively. Three charge/discharge cycles were performed for each current density. The self-discharging performance of the 0.5 M Li∥Tri-TEMPO membrane-free flow battery was tested by recording the OCV over time using a fully charged battery. The electrochemical measurements were conducted within an argon-filled glove box, ensuring a controlled environment with minimal oxidative reactions. The water content in the glove box was maintained below 1 ppm, while the oxygen level was kept below 2 ppm.

Measurement of capacity utilization and retention. The capacity utilization was determined by the ratio of the operational battery capacity (C_{b}) to the theoretical capacity (Cₜ) at a particular state of charge (SOC). The SOC was defined based on the duration of battery charge or discharge cycles.

$$Capacity utilization ( \% ) = [ {C}_{b} ( charge or discharge ) 1 {C}_{t} \} \times 100$$

Solubility Test. A solution of FEC/LiClO₄ (1.5 M) was used for the solubility measurements under an inert argon atmosphere at a temperature of 27° C. The solution was gradually added to a vial containing known amounts of the organic compounds used as the catholytes (Tri-TEMPO, C3-PTZ, and CP). Once a clear solution was obtained, the volume (50 μL) of the electrolyte was determined using an analytical pipette (P20). The solubilities of the organic compounds were calculated from the ratio of the molar amount to the electrolyte volume. These processes were repeated twice, and the average values are presented.

### Part I

Liquid/liquid biphasic batteries without a membrane could be promising models of redox flow batteries. However, such batteries inherently undergo self-discharge at the liquid/liquid interface, resulting in a low Coulombic efficiency and poor capacity retention. Herein, we report a triphasic system comprising all-nonaqueous electrolytes to overcome the challenges in biphasic systems. By incorporation of a third electrolyte layer to separate the anolyte and catholyte, the system effectively impeded the self-discharge event without compromising the Coulombic efficiency and capacity retention. Li metal anode and phenothiazine derivative C18-PTZ (0.5 M) cathode have been used to construct the electrochemical cell. Moreover, we have designed two all-nonaqueous triphasic models either stacking the phases vertically or physically separating two phases sidewise along with a common interfacial layer at the top. Interestingly, both designs showed high capacity retention under static (~98%, 31 days, 100 cycles) and flow (~99%, 39 days, 100 cycles) conditions. Moreover, all batteries exhibited an average Coulombic efficiency of nearly 100%.

Global energy and climate challenges require the transition from fossil fuels to renewable energy resources, including but not limited to solar, wind, and hydroelectric power, driving the utilization of large-scale energy storage devices. Redox flow batteries (RFBs) could be promising energy storage devices due to their unique properties, including high scalability, decoupled energy and power, and high safety. In the conventional RFB configuration, redox-active materials are dissolved in solvents to form a catholyte and anolyte, which are stored separately in external tanks. Depending on the electrolyte used, RFBs can be classified as either aqueous RFBs (ARFBs) or nonaqueous RFBs (NRFBs). Although ARFBs are safer and more cost-effective, they typically have a narrow voltage window (<1.6 V) due to the low thermodynamic stability of water. In contrast, NRFBs have a higher electrochemical window (~5.5 V), but they are associated with other challenges such as low ionic conductivity, high flammability, and the high cost of organic electrolytes. Additionally, NRFBs face the significant challenge of redoxmer crossover due to the lack of appropriate membranes in nonaqueous media, ultimately impacting the overall battery performance. To optimize RFB performance, it is crucial to develop membranes with high ionic conductivity, molecular selectivity, stability, and low cost.

An alternative strategy to address the aforementioned issues is the fabrication of RFBs without a membrane separator. This approach, demonstrated by our group and several other researchers, involves utilizing immiscible aqueous/nonaqueous electrolytes. This biphasic system consists of two immiscible electrolytes with different densities and a suitable partition coefficient, forming two phases with a common interface. This interface functions as a separator between the anolyte and the catholyte. However, membrane-free batteries with nonaqueous/nonaqueous electrolytes are rarely reported because of challenges in designing and selecting suitable solvents and redox-active materials. Although membrane-free biphasic batteries are promising, they face significant challenges that limit their practical application. These challenges include capacity loss due to the mixing of the anolyte and catholyte at the interface, self-discharge induced by interfacial ion migration during the solvation-desolvation process (rate of solvent diffusion), and low capacity utilization owing to poor mass transfer under static conditions. Additionally, compared with membrane-based RFBs, membrane-free batteries exhibit an unstable liquid/liquid interface that can significantly disrupt the thermodynamic balance under flow conditions. Active material crossover by convective mass transport under flow conditions further exacerbates capacity loss.

This study presents a new strategy by introducing a third layer as an ion-selective membrane to facilitate the separation of the anolyte and catholyte, alleviate self-discharge, and achieve a high Coulombic efficiency. The introduction of an interfacial electrolyte layer in the liquid/liquid triphasic system not only effectively separates the anolyte and catholyte but also facilitates convenient electrolyte flow (anolyte or catholyte) without disturbing the thermodynamic balance of the electrolyte phases even at high flow rates. This new approach enables the triphasic system to overcome the limitations of biphasic membrane-free batteries, resulting in improved capacity utilization and performance under flow conditions. The triphasic all-nonaqueous strategy is implemented using two distinct cell designs (see FIG. 67(A)). Three nonaqueous electrolytes, tetraethylene glycol dimethyl ether (TEGDME), nonafluoro-1, 1,2,2-tetrahydrohexyl-trimethoxysilane (NFTTS), and fluoroethylene carbonate (FEC), are used in the membrane-free batteries with Li metal and a phenothiazine derivative as the anode and cathode materials, respectively, resulting in a cell voltage of 3.52 V. The cycling performances of triphasic membrane-free batteries based on both designs are evaluated under static and flow conditions. All batteries exhibited outstanding cycling performances with capacity retentions under static conditions (~98%, 31 days, 100 cycles) and flow conditions (~99%, 39 days, 100 cycles). Furthermore, all of the batteries demonstrated an average Coulombic efficiency of nearly 100% under both static and flow conditions.

This study introduces three new triphasic configurations based on all nonaqueous electrolyte systems, utilizing various electrolyte solvents and salts. These configurations exhibit versatility beyond specific redox-active cathode materials. The combinations of electrolyte solvents and salts offer opportunities to explore a wide range of redox-active cathode and anode materials with varying solubilities, paving the way for high-performance membrane-free redox flow batteries. In addition, it effectively addresses issues in conventional RFBs, such as membrane limitations and high costs. Furthermore, it tackles challenges related to self-discharge, low Coulombic efficiency, and crossover of redox materials during electrolyte flow in biphasic membrane-free batteries, demonstrating its broad applicability and improved performance across diverse battery chemistries.

Design of the Nonaqueous Triphasic System. Designing an all-nonaqueous triphasic system with appropriate catholyte and anolyte materials is a significant challenge because of the complex interplay between the solubility of the active material and crossover. To successfully fabricate a high-performance membrane-free redox flow battery using a nonaqueous triphasic (three-layer) system, two primary requirements must be met. First, the three nonaqueous electrolytes must possess immiscibility, high ionic conductivity, and a wide electrochemical stability window. Second, the redox-active cathode material should exhibit high solubility in the catholyte layer and minimal solubility in the intermediate electrolyte layer or the anolyte during both the charging and discharging processes to prevent battery crossover-induced self-discharge. In this study, three triphasic systems were developed, each based on an all-nonaqueous electrolyte: propylene carbonate/NFTTS/1-Butyl-1-methylpyrrolidinium bis(trifluoromethylsulfonyl)imide, benzotrifluoride/1-ethyl-3-methylimidazolium tetrafluoroborate/NFTTS, and TEGDME/NFTTS/FEC. However, only TEGDME/NFTTS/FEC was studied for battery analysis due to its relatively lower cost compared with the remaining two systems. Three nonaqueous electrolytes, TEGDME, NFTTS, and FEC, were selected based on their desirable properties, including mutual immiscibility, high ionic conductivity, and key compatibility with Li metal anodes in lithium-ion batteries. The triphasic systems Design-I and -II were fabricated using the selected electrolytes (TEGDME, NFTTS, and FEC with lithium bis-(trifluoromethanesulfonyl)imide (LiTFSI)), as shown in FIG. 67(A). Before fabricating the triphasic systems, individual electrolyte solutions were prepared for TEGDME, NFTTS, and FEC containing LiTFSI with specific quantities (FIGS. 85 and 86). The as-prepared electrolyte solutions exhibited gravimetric densities in the order of FEC/LiTFSI>NFTTS/LiTFSI>TEGDME/LiTFSI. Consequently, in the Design-I triphasic system, the electrolyte solutions were arranged as follows: FEC was the bottom layer, NFTTS was the middle layer, and TEGDME was the top layer (FIGS. 67(A) and 88(A)). The FEC, TEGDME, and NFTTS layers functioned as the catholyte, anolyte, and ion-exchange layers, respectively. Moreover, the NFTTS layer served as the separator, preventing direct contact between the FEC and TEGDME layers while facilitating the desired electrochemical processes.

Utilizing the inherent gravimetric density differences between the as-prepared electrolyte solutions, a Design-II triphasic system was developed using a glass vial with two compartments separated by a common divider (FIGS. 67(A) and 88(B)). Both compartments were filled with the FEC electrolyte solution, and the NFTTS electrolyte solution was added on top of each FEC-containing compartment. In this design, one side of the divider used the FEC electrolyte as the catholyte, whereas the other side used the FEC electrolyte as the anolyte. The strategic positioning of the NFTTS electrolyte as an interfacial layer enabled efficient ion transport and suppressed the crossover of redox species, ensuring the appropriate functionality of the triphasic system while preserving the integrity of the electrochemical processes involved. The triphasic systems constructed in this study according to Design-I and Design-II were thoroughly evaluated for their long-term charge/discharge performances.

Selection of the Anode and Cathode Materials. Achieving a high capacity for RFBs requires the selection of redox-active materials with a high potential. In this study, Li metal was selected as the anode because of its low electrochemical potential (−3.04 V vs a standard hydrogen electrode), high energy density, and theoretical capacity (~3,860 mAh/g). Graphite felt (GF) was selected as the cathode owing to its chemical inertness in nonaqueous electrolytes, high electrical conductivity, highly porous structure, and high specific surface area. To increase the Coulombic efficiency and suppress crossover, the solubility of the catholyte compounds in the catholyte solvent should be high and the solubility in the separating and anolyte electrolytes should be minimal. The solubility properties of several redox-active catholyte compounds, including derivatives of phenothiazine, cyclopropenium, 2,2,6,6-tetramethylpiperidinyloxy (TEMPO), anthraquinone (AQ), and ferrocene, were evaluated in the three supporting electrolytes of the triphasic system (FIG. 87). The phenothiazine derivative C18-PTZ (FIG. 67(B)) exhibited high solubility in FEC and poor solubility in TEGDME and NFTTS (see the Supporting Information for details about the solubility tests). The solubility of C18-PTZ in FEC/LiTFSI (1.2 M) was determined to be 0.5 M. To investigate the confinement of C18-PTZ within the FEC layer, a crossover study was conducted using the triphasic system based on Design-I over a 10-day period under static conditions. The system was evaluated for the potential crossover of 0.5 M C18-PTZ dissolved in the FEC phase. Notably, no significant crossover was observed throughout the 10-day period, as confirmed by ultraviolet-visible spectroscopy (FIG. 89(A)) and cyclic voltammetry (CV) (FIG. 89(B)). These results demonstrate the effective confinement of C18-PTZ within the FEC layer. Based on these favorable results, C18-PTZ was selected as the cathode material for subsequent investigations.

Electrochemical Characterization. CV was used to determine the redox potentials and evaluate the electrochemical stability of C18-PTZ in the FEC electrolyte. A well-defined redox couple (0.35 V vs Ag/Ag⁺) was observed in FEC/LiTFSI (0.1 M). The almost identical voltammograms obtained after 500 cycles demonstrated the high electrochemical stability of C18-PTZ in the FEC/LiTFSI electrolyte (FIG. 67(E)). The peak potential separation of C18-PTZ at a scan rate of 50 mV/s was 68 mV, which is indicative of a one-electron redox process as per the Nernst equation. Moreover, the ratios of the cathodic peak current (ipc) and anodic peak current (ipa) at scan rates ranging from 50 to 250 mV/s were approximately 1 (FIGS. 67(D) and 67(E)), indicating high stability under different scan rates. Furthermore, the anodic and cathodic peak currents had a linear relationship with the square root of the scan rate (v^{1/2}, FIG. 90), indicating that the redox process is diffusion-controlled.

The diffusion coefficient D derived from the slopes of the linearly fitted Lévich plots was 6.23×10-6 cm²/s (FIG. 68(B)). The electrochemical kinetic rate constants of the charge-transfer reactions of C18-PTZ were obtained using the Kouteck-Lévich equation (Equation 1). The linear correlations between i⁻¹ and ω^{-1/2} for C18-PTZ at different overpotentials (η=10, 20, 30, 40, 50, 60, 70, 80, 90, and 100 mV) were used to estimate the iₖ values (FIG. 68(C)), which were obtained from the reciprocal of the Y-axis intercepts and plotted against the overpotential, as shown in FIG. 68(D). The kinetic rate constants (k₀) of C18-PTZ were calculated to be 3.51×10⁻³ cm s⁻¹ using Equation 1. The diffusion coefficients and rate constants of C18-PTZ are comparable to those of redox-active organic materials used in aqueous flow batteries.

Charge/Discharge Performance. The charge/discharge performances of the nonaqueous triphasic systems (Design-I and -II) using C18-PTZ (0.5 M) in FEC (Design-I and -II) as the catholyte and Li metal in TEGDME (Design-I) and FEC (Design-II) as the anolyte were studied under both static and flow conditions. Schematics of the triphasic cell systems are shown in FIGS. 67(A) and 91.

Under Static Conditions. Two triphasic cells based on Design-I and -II were assembled by pairing Li metal as the anode and C18-PTZ (0.5 M) as the cathode. To evaluate the battery cycling performances of the cells, they were subjected to charging and discharging within the voltage range of 4.0-2.6 V, as the cutoff limits. All charge/discharge experiments were performed in a glovebox filled with an inert Ar atmosphere under normal conditions (27° C.). To evaluate the long-term cycling performances of the cells, they were operated for 100 charge/discharge cycles at a current density of 0.75 mA/cm². For the Design-I and -II cells, the operation durations were 28 and 33 days, respectively. Both Li∥C18-PTZ (0.5 M) triphasic cells exhibited good cycling performances. The capacity retentions of Design-I and -II were 97.25% (99.98% per cycle, 99.94% per day, FIG. 69(A)) and 98.72% (99.98% per cycle, 99.95% per day, FIG. 69(B)), respectively. The theoretical capacity utilization of the battery cells based on Design-I and -II were measured to be 52.2% and 58.6%, respectively. These results demonstrate that the combination of redox materials (Li and C18-PTZ), supporting electrolyte solvents (FEC and TEGDME), and electrolyte salt (LiTFSI) is not only compatible but also stable under real battery operating conditions. Additionally, both static batteries demonstrated high Coulombic efficiencies (approximately 100% for both cells) and energy efficiencies (74% for Design-I and 82% for Design-II), exceeding those of reported membrane-free batteries (80-96%). The CV results of the pre- and postcycling electrolytes for both triphasic static cells showed negligible changes in peak current densities (FIGS. 69(C) and 69(D)), suggesting that C18-PTZ remained confined within the catholyte during extended cycling. Thus, the battery cycling performance and post cycling analysis confirmed the importance of the intermediate electrolyte layer (NFTTS) as an ion-exchange separator in the triphasic static system.

To investigate the self-discharge of the static membrane-free batteries, the open-circuit voltage (OCV) of the completely charged cells was monitored for 100 h. The OCV exhibited no significant voltage drop for either battery for more than 100 h. The per-hour voltage loss was 0.45 mV/h for Design-I and 0.53 mV/h for Design-II (FIG. 92). Thus, the intermediate layer effectively eliminates self-discharge originating from the migration of the redox species from the catholyte to the anolyte. Moreover, these results demonstrate the high Coulombic efficiency and high capacity retentions of both batteries.

In addition, the effect of various charge/discharge current densities on the performance of the Li∥C18-PTZ (0.5 M) static cells was investigated. The cells (Design-I and -II) were subjected to cycling at current densities of 0.5, 0.75, and 1.0 mA/cm², respectively, and the average Coulombic efficiency, voltage efficiency, and energy efficiency values were determined at each current density over three cycles (FIG. 3G,H). The static cells of Design-I and -II exhibited an increase in overpotential with an increasing applied current density. The increase in the overpotential at higher current densities can be attributed to limited mass diffusion. Furthermore, both static cells (FIGS. 69(G) and 69(H)) showed Coulombic efficiencies close to 100%, which is higher than the performances of previously reported membrane-free systems (FIG. 100). When the applied current density was increased from 0.5 to 1.0 mA/cm², the energy efficiency values of the batteries decreased from 84% to 64% (Design-I) and 89% to 73% (Design-II). This is caused by the overpotential increase, owing to mass transport losses. Notably, both the batteries regained their original efficiencies when cycled back at 0.5 mA/cm², thus confirming their improved charge-rate performances. In addition, the polarization of batteries based on Design-I and -II under static conditions was investigated at different states of charge (SOCs). The peak power densities of the batteries under static conditions were 27 mW/cm² (Design-I) (FIG. 93(A)) and 30 mW/cm² (Design-II) (FIG. 93(B)) at 100% SOC. Correspondingly, the area-specific resistance (ASR) for both the electrolyte and the entire battery under static conditions (Design-I and Design-II) was also investigated. The ASR of both the electrolyte and the entire battery decreased with increasing SOC. Moreover, the electrolyte contributed more than 60% (Design-I) (FIG. 93(C)) and 53% (Design-II) (FIG. 93(D)) of the resistance compared with that of the entire battery.

To study the cycling stability of the Li anode, we investigated the battery performance (Design-I and Design-II) utilizing a limited amount of Li metal anode (0.9 equiv of the catholyte material) to further assess the efficacy of our developed triphasic electrolyte system. Both batteries underwent 50 charge/discharge cycles (approximately 17 days), with continuous monitoring of their capacity over time. The results indicate that both batteries exhibited capacity retention of 99.17% for Design-I (FIGS. 94(A) and 94(B)) and 98.12% for Design-II (FIGS. 94(C) and 94(D)) and Coulombic efficiencies of nearly 100%. CV analysis of pre- and postcycled catholytes and anolytes of batteries based on Design-I (FIG. 95(A)) and Design-II (FIG. 95(B)) suggest negligible crossover of active materials. Moreover, the digital images of pre- and postcycled Li metal anodes of batteries based on Design-I and Design-II (FIG. 96) show no signs of dendrite formation. Therefore, the notable capacity retention observed in both batteries demonstrates the good state of health of the Li metal anode and highlights the better efficacy of the developed triphasic electrolyte system.

Under Flow Conditions. While the static triphasic membrane-free batteries demonstrated a notable charge/discharge performance with a Coulombic efficiency of nearly 100% and improved capacity retention, the limited mass-transfer conditions resulted in low capacity utilization. In addition, the independent scaling of energy and power is challenging under static conditions. To evaluate the efficacy of the triphasic system under flow conditions and enable the independent scaling of power and energy, membrane-free triphasic flow cells based on Design-I and -II were evaluated for long-term charge-discharge cycling using a flowing catholyte. The flow conditions were optimized by evaluating the charge/discharge performance of Li∥C18-PTZ (0.5 M) flow cells with Design-I (FIG. 97(A) and Design-II (FIG. 97(B)) at various catholyte flow rates (0.5 to 2.0 mL/min) at a current density of 1 mA/cm2. Consequently, an optimal flow rate of 1.0 mL/min was selected to perform long-duration cycling. At this flow rate, the flow cells of Design-I and -II showed improved capacity retentions of 98.65% (99.985% per cycle, 99.953% per day) and 99.47% (99.994% per cycle, 99.972% per day), respectively (FIGS. 70(A) and 70(B)). Design-I (FIG. 70(A)) exhibited a Coulombic efficiency of −100%, voltage efficiency of ~84%, and energy efficiency of ~83%, whereas Design-II exhibited a Coulombic efficiency of ~100%, voltage efficiency of ~88%, and energy efficiency of ~87% (FIG. 70(B)). No obvious change in the CV current densities of the postcycled batteries was observed, confirming the high stability of the redox-active materials, with no crossover of the active material to the interfacial layer (FIGS. 70(C) and 70(D)). Both designs exhibited improved performance in terms of efficiency and retention compared with those reported previously (FIG. 100).

The OCV of the completely charged cells was observed for 100 h to evaluate the effect of electrolyte flow on the self-discharge of the cells (FIGS. 98(A) and 98(B)). Over the investigated period, minimal decay in the OCV values (0.57 mV/h for Design-I and 0.49 mV/h for Design-II) was observed, which confirmed the absence of self-discharge in the cells. Thus, replacing the biphasic interface with an electrolyte layer can eliminate the interfacial self-discharge and crossover of active materials under convective mass transport by using electrolyte-flowing conditions. The charge rate performances of the Li∥C18-PTZ (0.5 M) flow cells based on Design-I and -II were evaluated at current densities of 0.8, 1.0, and 1.2 mA/cm², and the corresponding cycling profiles, as well as the Coulombic efficiency, voltage efficiency, and energy efficiency values were measured for an average of three cycles. Similar to the static cells, the flow cells exhibited an increase in overpotential with increasing applied current density (FIGS. 70(E) and 70(F)). This increase in overpotential is attributed to the induced transport losses that occur at higher current densities. The Coulombic efficiency of the cells remained at 100% for all current densities; however, the voltage efficiency and energy efficiency values decayed with an increasing current density. The increase in the overpotential and the corresponding reduction in voltage efficiency at higher current densities may be attributed to mass transport limitations (FIGS. 70(G) and 70(H)). Both cells regained their original performance when cycled back at 0.8 mA/cm². Furthermore, the triphasic cells under flow conditions exhibited improved capacity utilization compared to the static cells (80% for Design-I and 84% for Design-II under flow conditions at 1 mA/cm² compared to 42% for Design-I and 48% for Design-II under static conditions at 0.75 mA/cm²), indicating that the flow of electrolytes significantly reduced the mass transport limitations of the static battery. As a result of the enhanced mass transport, the triphasic batteries exhibited higher peak power densities under flow conditions compared to those under static conditions. Specifically, Design-I achieved a peak power density of 39 mW/cm² (FIG. 99(A)), while Design-II reached an even higher peak power density of 46 mW/cm² (FIG. 99(B)). The ASR results for both the electrolyte and the entire battery under flow conditions indicated that the electrolyte resistance accounted for over 58% (Design-I) (FIG. 99(C)) and 47% (Design-II) (FIG. 99(D)) of the entire battery. Thus, the ASR of the electrolyte and the entire battery is significantly reduced under flow conditions, allowing for higher current densities without compromising the performance. The relatively low power densities compared to those of conventional aqueous membrane-based redox flow batteries can be attributed to the reduced ionic conductivity of nonaqueous solvents and increased mass transfer resistance from the triphasic interface.

In summary, to overcome the challenges associated with the biphasic electrolyte approach, a triphasic liquid-liquid system with two new strategic designs (Design-I and -II) was proposed. In contrast to biphasic systems, the newly developed triphasic system features an additional electrolyte layer to separate the anolyte and catholyte, eliminating self-discharge and providing high Coulombic efficiency and capacity retention. The intermediate layer enabled an improved cycling performance and the flow of the electrolyte to achieve decoupled energy and power. The triphasic batteries based on the two novel designs were assembled using Li metal as the anode and a phenothiazine derivative C18-PTZ (0.5 M) as the cathode. The cycling performances of the triphasic membrane-free batteries based on Design-I and Design-II were evaluated under static and catholyte flow conditions. Static batteries based on Design-I and -II yielded outstanding cycling performance with high capacity retentions of 97.25% and 98.72%, respectively, and Coulombic efficiencies close to 100%. However, under static conditions, the capacity utilization of the batteries was lower owing to limited mass transport. To enhance capacity utilization and enable the decoupled scaling of energy and power, flow conditions were introduced for both designs of the triphasic system by using an optimized flow rate of 1 mL/min. Flow batteries based on these designs exhibit a significantly higher capacity utilization than static batteries. Moreover, Design-I and -II flow batteries achieved improved capacity retentions of 98.65% and 99.47%, respectively, with Coulombic efficiencies close to 100%. The peak power densities of the Design-I and -II batteries under static conditions were 27 and 30 mW/cm², respectively, whereas those under flow conditions increased to 39 and 46 mW/cm², respectively. The improved power densities of the flow batteries were attributed to the lowered electrolyte resistance resulting from enhanced mass transport compared with static batteries. Therefore, the outstanding performance of the nonaqueous triphasic system provides a novel strategy for developing membrane-free, nonaqueous batteries with high voltage, high Coulombic efficiency (close to 100%), improved capacity utilization, and high capacity retention.

General Methods. Materials. Lithium perchlorate (LiClO4, 98%), lithium bis(trifluoromethanesulfonyl)imide (LiTFSI, 99.94%), lithium hexafluorophosphate (LiPF6, 99.99%), fluoroethylene carbonate (FEC, 99%), benzotrifluoride (BTF, 99.8%), and tetraethylene glycol dimethyl ether (TEGDME, 98%) were purchased from Fisher Scientific and used without further purification. Nonafluoro-1,1,2,2-tetrahydrohexyl-trimethoxysilane (NFTTS, 97%), 1-ethyl-3-methyl imidazolium tetrafluoroborate (EMIBF₄, 97%), and 1-butyl-1-methylpyrrolidinium bis(trifluoromethyl sulfonyl)imide (BMPTFSI, 98%) were purchased from TCI Chemicals. Tetrabutylammonium hexafluorophosphate (TBAPF6, 99.0%) was recrystallized in anhydrous ethanol and dried under vacuum at 60° C. for 24 h.

Physicochemical characterizations. The UV-visible absorption spectra were collected on a UV-visible spectrophotometer (Agilent Technologies, Cary 8454 UV-Vis). To perform UV-visible measurements, dilute samples with concentrations below 5 mM were prepared. To achieve this, highly concentrated samples were diluted in an appropriate electrolyte solvent before conducting the UV-visible measurements. A blank sample containing no redox materials was prepared to measure the UV-visible spectrum. The ¹H and ¹⁹F NMR spectra were recorded on a Bruker AV400 spectrometer (400 MHz). The chemical shifts were reported in ppm. To measure the concentration of LiTFSI in TEGDME and NFTTS layers of the biphasic system, a sample of 10 μL volume was collected from each layer and mixed with 400 μL of CDCl₃ for preparing the NMR samples. ¹H NMR spectra were first recorded using these samples, and 50 μL of TBAPF₆, as an internal standard, was then added to those samples before performing ¹⁹F NMR.

Electrochemical characterization. For the cyclic voltammetry (CV) measurements, C18-PTZ (5 mM) solutions were prepared in FEC/LiTFSI (0.1 M) electrolyte. A glassy carbon disk (CHI Instrument, 3 mm) was used as the working electrode and was polished with aqueous Al₂O₃(Pine Research Instrumentation, Inc., 5 mm) before the measurements. A piece of Pt wire (Pine Research Instrumentation, Inc., thickness 0.5 mm, purity 99.99%) was used as the counter electrode while an Ag/Ag⁺ (MTI Corp) electrode was used as the reference electrode. The CV measurements were performed using a Bio-Logic potentiostat. The charge/discharge performances were evaluated using Land and Bio-Logic potentiostats.

The area-specific resistance (ASR) of static and flow cells was assessed through the utilization of the linear sweep voltammetry (LSV) method. To determine ASR, LSV experiments were carried out on batteries containing various redox materials. The outcome of these experiments was depicted in the form of polarization curves, plotting the current (i) against the applied potential (V). By closely examining the polarization curves, it was possible to identify a linear region where the current response exhibited a direct proportionality to the applied potential. This analysis allowed the calculation of the differential resistance (dE/di). Typically, this linear behavior was observed at low overpotentials, which signifies a kinetic-limited regime of electrochemical reactions. In the assessment of ASR, the slope (S) of the linear region within the polarization curve was extracted. By utilizing the formula (ASR=1/S), the area-specific resistance was calculated, representing the resistance normalized to the electrode area. To ensure the reliability and reproducibility of the experiment, two distinct sets of cells were subjected to the same electrochemical characterizations. These characterizations were carried out at a temperature of 27° C., with the entire process conducted within an argon-filled glove box to maintain controlled atmospheric conditions.

The LSV investigations were conducted using a Pine modulated speed rotator paired with Biologic potentiostats. In this setup, a rotating disk electrode (RDE) with a diameter of 5 mm served as the working electrode, while a Pt wire electrode and an Ag/Ag⁺ electrode were utilized as the counter and reference electrodes, respectively. To ensure consistent and controlled conditions, the samples underwent a purging process with 99.999% pure argon for 20 minutes before the testing commenced. LSV data was collected at various rotation rates, ranging from 100 to 1600 rpm. The diffusion coefficient (D) of electroactive materials was calculated from the Lévich plot using Equation 1. The kinetic rate constant is calculated by Equation 2.

The charge/discharge performance of the Li∥C18-PTZ batteries (both static and flow) was evaluated using Land and Bio-Logic potentiostats. The assessments were carried out over the long term (100 cycles), employing a charge cutoff voltage of 4.0 V and a discharge cutoff voltage of 2.6 V, with a constant current density of 0.75 mA/cm² (static batteries) and 1 mA/cm² (flow batteries). For static battery studies, 0.2 mL of catholyte and 0.2 mL of anolyte were utilized. In contrast, flow battery studies involved 0.5 mL of catholyte and 0.5 mL of anolyte, with the catholyte circulated through the cell at a flow rate of 1 mL/min using a peristaltic pump. To analyze the rate performance, both static and flow batteries were subjected to different current densities: 0.5, 0.75, and 1.0 mA/cm² for static batteries, and 0.8, 1.0, and 1.2 mA/cm² for flow batteries. Three charge/discharge cycles were recorded for each current density. Furthermore, the self-discharge performance of the flow battery was evaluated by monitoring the open circuit voltage (OCV) over time on a fully charged battery. The electrochemical measurements were conducted within an argon-filled glove box, ensuring a controlled environment with minimal oxidative reactions. The water content in the glove box was maintained below 1 ppm, while the oxygen level was kept below 2 ppm.

Measurement of capacity utilization and retention. The capacity utilization of the battery was calculated as the ratio of the operational battery capacity (C_{b}) to its theoretical capacity (Cₜ) at a specific state of charge (SOC). The SOC was defined based on the duration of battery charge or discharge cycles.

$$Capacity utilization ( \% ) = [ {C}_{b} ( charge or discharge ) / {C}_{t} ] \times 100 \%$$

On the other hand, capacity retention was determined by normalizing the discharge capacity during cycling. Here, Cᵢ represents the discharge capacity obtained in the first cycle, while C_{f} represents the discharge capacity obtained in subsequent cycles.

$$Capacity retention ( \% ) = [ Cf / Ci ] \times 100 \%$$

Solubility Test. To determine the solubility of C18-PTZ, a solution of FEC/LiTFSI (1.5 M) was employed. The solution was incrementally added to a vial containing known quantities of C18-PTZ. The addition continued until a clear solution was achieved, at which point the volume of the electrolyte was measured using an analytical pipette. Subsequently, the solubility of the organic compounds was calculated by finding the ratio of the molar amount of C18-PTZ to the volume of the electrolyte. This entire process was repeated twice to ensure accuracy, and the averaged values of the solubility were reported as the final result.

Details for electrolyte preparation. In this study, seven nonaqueous electrolytes, including propylene carbonate (PC), nonafluoro-1,1,2,2-tetrahydrohexyl-trimethoxysilane (NFTTS), 1-Butyl-1-methylpyrrolidinium bis(trifluoromethyl sulfonyl)imide (BMPTFSI), benzotrifluoride (BTF), 1-ethyl-3-methylimidazolium tetrafluoroborate (EMIBF4), tetraethylene glycol dimethyl ether (TEGDME), and fluoroethylene carbonate (FEC), were selected to construct an all-nonaqueous triphasic system. All these nonaqueous electrolytes allow for a wide electrochemical window of up to ~5V, and exhibit high compatibility with lithium metal anode and redox-active materials. Details for fabricating the triphasic systems are given below. In all cases, Li⁺ ion serves as an interfacial charge carrier during charging/discharging for the triphasic system.

PC/NFTTS/BMPTFSI: PC is intrinsically immiscible with NFTTS, and NFTTS is intrinsically immiscible with BMPTFSI. Therefore, the PC/NFTTS/BMPTFSI triphasic system was developed with PC (0.5 M LiClO4) on top, NFTTS (0.5 M LiTFSI) in the middle, and BMPTFSI (0.5 M LiTFSI) at the bottom.

BTF/EMIBF4/NFTTS: BTF is inherently immiscible with EMIBF4, whereas EMIBF4 is intrinsically immiscible with NFTTS. Therefore, this all-nonaqueous triphasic system was prepared with BTF (0.5 M LiPF₆) on top, EMIBF4 (0.5 LiTFSI) in the middle, and NFTTS (0.5 M LiPF₆) at the bottom.

TEGDME/NFTTS/FEC: The preparation of TEGDME, NFTTS, and FEC electrolytes with LiTFSI is a critical step in the construction of triphasic systems. Several essential criteria must be satisfied to ensure the construction of a stable triphasic system. First, gravimetric density differences are required between the solvents to allow self-stratification to form the three layers. Second, mutual immiscibility is crucial; the top layer should be immiscible with the middle layer and the middle layer should be immiscible with the bottom layer. Third, the redox-active catholyte compound should remain confined within the catholyte phase without crossover to the middle or anolyte layer.

For Design-I, because the gravimetric densities of the solvents followed the sequence TEGDME<NFTTS<FEC, TEGDME was used as the anolyte for the top layer, NFTTS as the ion-exchange layer in the middle, and FEC as the catholyte in the bottom layer. Notably, NFTTS (middle layer) is intrinsically immiscible in FEC (bottom layer), whereas TEGDME (top layer) is miscible in NFTTS (middle layer). This property poses a challenge in constructing a stable triphasic system with the desired immiscibility between the layers. Therefore, to fulfill the second criterion mentioned earlier, a salt-out strategy using LiTFSI was used to achieve immiscibility between TEGDME and NFTTS, as shown in FIG. 85. After varying the LiTFSI concentration in both solvents, the two phases separated significantly to form two stable layers. The solubility difference of LiTFSI in TEGDME and NFTTS plays a pivotal role in the formation of a liquid/liquid biphasic system. To determine the LiTFSI concentrations in each layer, we conducted ¹H and ¹⁹F NMR analyses on the TEGDME and NFTTS phases, and found that the concentration of LiTFSI in TEGDME and NFTTS is 1 M and 0.14 M, respectively. Subsequently, the bottom phase was studied using different LiTFSI concentrations to obtain a stable triphasic system. FEC/LiTFSI (0.5 M) and FEC/LiTFSI (1.5 M) were studied using TEGDME and FEC (FIG. 86). Both systems were allowed to stand to evaluate their triphasic stability. The system containing FEC/LiTFSI (0.5 M) became unstable after 1 h. This instability is attributed to the inherent tendency of FEC with a low LiTFSI concentration (<1 M), which results in the extraction of LiTFSI from the top layers, causing miscibility of the top two layers. In contrast, the system containing FEC/LiTFSI (1.5 M) remained stable for 20 h. Thus, the Design-I triphasic system (FIG. 88(A)) based on FEC/LiTFSI (1.5 M) was selected for subsequent battery studies.

In addition, the salt-out strategy with FEC/LiTFSI (1.5 M) was used to construct Design-II, which comprised a glass vial with two compartments separated by a common divider (FIG. 67(A)). Both compartments were filled with the FEC electrolyte solution: one contained C18-PTZ as the catholyte, and the other contained Li metal as the anolyte. The NFTTS electrolyte solution was added to each FEC compartment to form a triphasic system (FIG. 88(B)).

What is claimed is:

1. A biphasic membrane-free battery comprising:
a housing structure housing:
a catholyte phase;
an anolyte phase, the catholyte phase contacting the anolyte phase along an interface;
a cathode present in the catholyte phase; and
an anode present in the anolyte phase.

2. The biphasic membrane-free battery of claim 1, wherein the anolyte phase comprises a solvent selected from the group consisting of ethyl-3-methylimidazolium bis(trifluoromethylsulfonyl)imide (EMI-TFSI), N-propyl-N-methylpyrrolidinium bis(trifluoromethanesulfonyl)imide (PMP-TFSI), 1-ethyl-3-methyl imidazolium tetrafluoroborate (EMI-BF4), 1-butyl-1-methylpyrrolidinium bis(trifluoromethylsulfonyl)imide (BMP-TFSI), nonafluoro-1,1,2,2-tetrahydrohexyl-trimethoxysilane (NFTTS), and combinations thereof.

3. The biphasic membrane-free battery of claim 1, wherein the catholyte phase comprises a solvent selected from the group consisting of tetrahydrofuran (THF), tetraethylene glycol dimethyl ether (TEGDME), fluoroethylene carbonate (FEC), diethylene carbonate (DEC), propylene carbonate (PC), benzotrifluoride (BTF), and combinations thereof.

4. The biphasic membrane-free battery of claim 1, wherein the anode comprises lithium metal.

5. The biphasic membrane-free battery of claim 1, wherein the cathode comprises a material selected from the group consisting of 2,4,6-tri-(1-cyclohex-yloxy-4-imino-2,2,6,6-tetramethylpiperidine)-1,3,5-triazine (Tri-TEMPO), N-propyl phenothiazine (C3-PTZ), tris(dialkylamino)cyclo-propenium (CP), and combinations thereof.

6. The biphasic membrane-free battery of claim 1, wherein the catholyte phase is configured to be static during operation of the biphasic membrane-free battery.

7. The biphasic membrane-free battery of claim 1, wherein the anolyte phase is configured to be static during operation of the biphasic membrane-free battery.

8. The biphasic membrane-free battery of claim 1, wherein the catholyte phase is configured to flow into the biphasic membrane-free battery and out of the biphasic membrane-free battery during operation of the biphasic membrane-free battery.

9. The biphasic membrane-free battery of claim 1, wherein the anolyte phase is configured to flow into the biphasic membrane-free battery and out of the biphasic membrane-free battery during operation of the biphasic membrane-free battery.

10. The biphasic membrane-free battery of claim 1, wherein the cathode comprises graphite felt (GF).

11. A triphasic membrane-free battery comprising:
a housing structure housing:
a catholyte phase;
an electrolyte phase;
an anolyte phase, the catholyte phase contacting the electrolyte phase along a first interface and the electrolyte phase contacting the anolyte phase along a second interface;
a cathode present in the catholyte phase; and
an anode present in the anolyte phase.

12. The triphasic membrane-free battery of claim 11, wherein the anolyte phase comprises a solvent selected from the group consisting of ethyl-3-methylimidazolium bis(trifluoromethylsulfonyl)imide (EMI-TFSI), N-propyl-N-methylpyrrolidinium bis(trifluoromethanesulfonyl)imide (PMP-TFSI), 1-ethyl-3-methyl imidazolium tetrafluoroborate (EMI-BF4), 1-butyl-1-methylpyrrolidinium bis(trifluoromethylsulfonyl)imide (BMP-TFSI), nonafluoro-1,1,2,2-tetrahydrohexyl-trimethoxysilane (NFTTS), tetraethylene glycol dimethyl ether (TEGDME), fluoroethylene carbonate (FEC), and combinations thereof.

13. The triphasic membrane-free battery of claim 11, wherein the catholyte phase is a solvent selected from the group consisting of tetrahydrofuran (THF), tetraethylene glycol dimethyl ether (TEGDME), fluoroethylene carbonate (FEC), diethylene carbonate (DEC), propylene carbonate (PC), benzotrifluoride (BTF), nonafluoro-1,1,2,2-tetrahydrohexyl-trimethoxysilane (NFTTS), and combinations thereof.

14. The triphasic membrane-free battery of claim 11, wherein the anode comprises lithium metal.

15. The triphasic membrane-free battery of claim 11, wherein the cathode comprises a material selected from the group consisting of 2,4,6-tri-(1-cyclohex-yloxy-4-imino-2,2,6,6-tetramethylpiperidine)-1,3,5-triazine (Tri-TEMPO), N-propyl phenothiazine (C3-PTZ), tris(dialkylamino)cyclo-propenium (CP), graphite felt (GP), phenothiazine derivative (C18-PTZ), and combinations thereof.

16. The triphasic membrane-free battery of claim 11, wherein the catholyte phase is configured to be static during operation of the triphasic membrane-free battery.

17. The triphasic membrane-free battery of claim 11, wherein the anolyte phase is configured to be static during operation of the triphasic membrane-free battery.

18. The triphasic membrane-free battery of claim 11, wherein the catholyte phase is configured to flow into the triphasic membrane-free battery and out of the triphasic membrane-free battery during operation of the triphasic membrane-free battery.

19. The triphasic membrane-free battery of claim 11, wherein the anolyte phase is configured to flow into the triphasic membrane-free battery and out of the triphasic membrane-free battery during operation of the triphasic membrane-free battery.

20. The triphasic membrane-free battery of claim 11, wherein the electrolyte phase comprises a material selected from the group consisting of tetraethylene glycol dimethyl ether (TEGDME), nonafluoro-1,1,2,2-tetrahydrohexyl-trimethoxysilane (NFTTS), fluoroethylene carbonate (FEC), and combinations thereof.
